(19) United States
(12) Patent Application Publication
(10) Pub. No.: US 2026/0370821 A1
(43) Pub. Date: Nov. 19, 2026

(54) INFORMATION PROCESSING DEVICE AND METHOD

(71) Applicant: Sony Group Corporation, Tokyo (JP)

(72) Inventors: Mitsuru KATSUMATA, Tokyo (JP); Mitsuhiro HIRABAYASHI, Tokyo (JP); Ryohei TAKAHASHI, Tokyo (JP)

(73) Assignee: Sony Group Corporation, Tokyo (JP)

(21) Appl. No.: 19/139,407

(22) PCT Filed: Dec. 27, 2023
(86) PCT No.: PCT/JP2023/046913

§ 371 Date: Jun. 16, 2025

Related U.S. Application Data
(60) Provisional application No. 63/435,640, filed on Dec. 28, 2022.
(60) Provisional application No. 63/456,055, filed on Mar. 31, 2023.

(51) Int. Cl. H04N 19/119; H04N 19/127; H04N 19/70

(52) U.S. Cl. CPC H04N 19/119; H04N 19/127; H04N 19/70

(57) ABSTRACT

The present disclosure relates to an information processing device and a method capable of suppressing an increase in the number of decoder instances necessary for decoding video components constituting 3D data.

Each bitstream of a plurality of video components of 3D data and merge information for merging the plurality of bitstreams are acquired, the plurality of bitstreams is merged on the basis of the merge information, the merged bitstream is decoded to generate decoded data, the decoded data is divided into the plurality of video components on the basis of the merge information, and the 3D data is reconstructed using the plurality of video components obtained by the division. The present disclosure can be applied to, for example, an information processing device, an information processing method, and the like.

### TECHNICAL FIELD

The present disclosure relates to an information processing device and method, and more particularly, to an information processing device and a method capable of suppressing an increase in the number of decoder instances necessary for decoding video components constituting 3D data.

### BACKGROUND ART

Conventionally, a 2D codec that encodes and decodes a two-dimensional image has a technique of merging (integrating) and decoding a plurality of encoded data into one (see, for example, Non-Patent Document 1 and Non-Patent Document 2). On the other hand, a 3D codec that encodes and decodes three-dimensional data has a method of encoding and decoding a video component included in 3D data using a 2D codec (see, for example, Non-Patent Document 3 to Non-Patent Document 5). Meanwhile, for distribution of the 3D codec, there is also a method of using moving picture experts group dynamic adaptive streaming over hypertext transfer protocol (HTTP) (MPEG-DASH) or scene description, for example (see, for example, Non-Patent Document 6 to Non-Patent Document 8).

### CITATION LIST

### Non-Patent Document

Non-Patent Document 1: “Information technology—Coding of audio-visual objects—Part 15: Carriage of network abstraction layer (NAL) unit structured video in the ISO base media file format”, ISO/IEC 14496-15:2021 (E), WG03N0234_20296_14496-15 FDIS v4, 2022 October
Non-Patent Document 2: “Information technology—Coding of audio-visual objects—Part 12: ISO base media file format, TECHNICAL CORRIGENDUM 1”, ISO/IEC 14496-12:2015/Cor.1, WG03N0233_20295-1_14496-12-7th, 2016 Jun. 3
Non-Patent Document 3: “Information technology—Coded representation of immersive media—Part 10: Carriage of visual volumetric video-based coding data”, ISO/IEC 23090-10:2021 (E), WG03N00241_-_Text_of_ISOIEC_FDIS_23090-10_Carriage_of_Visual_Volumetric_Video-based_Coding_Data, 2022 May
Non-Patent Document 4: Khaled Mammou, Jungsun Kim, Alexis Tourapis, Dimitri Podborski, “[V-CG] Apple's Dynamic Mesh Coding CfP Response”, ISO/IEC JTC 1/SC 29/WG 7 m59281, April 2022
Non-Patent Document 5: “Information technology—Coded representation of immersive media—Part 12: MPEG Immersive video”, ISO/IEC 23090-12:2021 (E), WG04N00111 ISO IEC 23090-12 FDIS, 135th MPEG meeting, October 2021, online
Non-Patent Document 6: “Information technology—Dynamic adaptive streaming over HTTP (DASH)—Part 1: Media presentation description and segment formats”, ISO 23009-1:2021(X), ISO-IEC-23009-1-5th-edition-FDIS, 2021 Jun. 24
Non-Patent Document 7: Saurabh Bhatia, Patrick Cozzi, Alexey Knyazev, Tony Parisi, “Khronos glTF2.0”, https://github.com/KhronosGroup/glTF/tree/master/specification/2.0, Jun. 9, 2017
Non-Patent Document 8: “Information technology—Coded representation of immersive media—Part 14: Scene Description”, ISO/IEC DIS 23090-14:2021(E), [2]WG03_N00485_23090-14, 137th MPEG meeting, January 2022, online

### SUMMARY OF THE INVENTION

### Problems to be Solved by the Invention

However, in the 3D codec, there is no method of merging and decoding a plurality of encoded data into one as in the 2D codec. Therefore, in a case where the 3D data has a plurality of video components, the 3D codec has decoded the bitstream of each video component using the 2D codec. Therefore, a decoder instance is required for each video component, and the number of decoder instances required for decoding may increase.

The present disclosure has been made in view of such a situation, and an object thereof is to suppress an increase in the number of decoder instances necessary for decoding video components constituting 3D data.

### Solutions to Problems

An information processing device according to one aspect of the present technology is an information processing device including: a 3D data acquisition unit that acquires each bitstream of a plurality of video components of 3D data and merge information for merging a plurality of the bitstreams; a merge processing unit that merges the plurality of bitstreams on the basis of the merge information; a decoding unit that decodes a merged bitstream and generates decoded data; a division unit that divides the decoded data into the plurality of video components on the basis of the merge information; and a reconstruction unit that reconstructs the 3D data using the plurality of video components obtained by division.

An information processing method according to one aspect of the present technology is an information processing method including: acquiring each bitstream of a plurality of video components of 3D data and merge information for merging a plurality of the bitstreams; merging the plurality of bitstreams on the basis of the merge information; decoding a merged bitstream to generate decoded data; dividing the decoded data into the plurality of video components on the basis of the merge information; and reconstructing the 3D data using the plurality of video components obtained by division.

In the information processing device and the method according to one aspect of the present technology, each bitstream of a plurality of video components of 3D data and merge information for merging the plurality of bitstreams are acquired, the plurality of bitstreams is merged on the basis of the merge information, the merged bitstream is decoded to generate decoded data, the decoded data is divided into the plurality of video components on the basis of the merge information, and the 3D data is reconstructed using the plurality of video components obtained by division.

### BRIEF DESCRIPTION OF DRAWINGS

FIG. 1 is a diagram illustrating an example of a main track configuration of VVC data.

FIG. 2 is a diagram illustrating an example of a subpicture order sample group.

FIG. 3 is a diagram illustrating an example of a subpicture ID sample group.

FIG. 4 is a diagram illustrating an example of a main track configuration of HEVC data.

FIG. 5 is a diagram illustrating an example of a rectangular region group.

FIG. 6 is a diagram illustrating an example of a main track configuration of V-PCC data.

FIG. 7 is a diagram illustrating a description example of an MPD in the case of a multi-track structure.

FIG. 8 is a diagram for explaining a mesh.

FIG. 9 is a diagram for explaining V-DMC.

FIG. 10 is a diagram illustrating a configuration example of a V-DMC bitstream.

FIG. 11 is a diagram illustrating a main configuration example of a glTF 2.0.

FIG. 12 is a diagram illustrating an example of a glTF object and a reference relationship.

FIG. 13 is a diagram illustrating a description example of a scene description.

FIG. 14 is a diagram for explaining a method of accessing binary data.

FIG. 15 is a diagram illustrating a description example of a scene description.

FIG. 16 is a diagram for explaining a relationship between a buffer object, a buffer view object, and an accessor object.

FIG. 17 is a diagram illustrating description examples of a buffer object, a buffer view object, and an accessor object.

FIG. 18 is a diagram for explaining a configuration example of an object of a scene description.

FIG. 19 is a diagram illustrating a description example of a scene description.

FIG. 20 is a diagram for explaining an object extension method.

FIG. 21 is a diagram for explaining a configuration of a client process.

FIG. 22 is a diagram illustrating a configuration example of an extension for handling timed metadata.

FIG. 23 is a diagram illustrating a description example of a scene description.

FIG. 24 is a diagram illustrating a description example of a scene description.

FIG. 25 is a diagram illustrating a configuration example of an extension for handling timed metadata.

FIG. 26 is a diagram illustrating a main configuration example of a client.

FIG. 27 is a flowchart for explaining an example of a flow of a client process.

FIG. 28 is a diagram for explaining a definition of MPEG media.

FIG. 29 is a diagram for explaining a definition of MPEG media.

FIG. 30 is a diagram for explaining a definition of MPEG media.

FIG. 31 is a diagram for explaining a definition of MPEG media.

FIG. 32 is a diagram for explaining a definition of MPEG media.

FIG. 33 is a diagram illustrating an example of an MAF API.

FIG. 34 is a diagram illustrating an example of an MAF API.

FIG. 35 is a diagram illustrating an example of an MAF API.

FIG. 36 is a diagram illustrating an example of an MAF API.

FIG. 37 is a diagram illustrating an example of an MAF API.

FIG. 38 is a diagram illustrating an example of an MAF API.

FIG. 39 is a diagram illustrating an example of a method of decoding a video component of 3D data.

FIG. 40 is a diagram illustrating an example of a method of decoding a video component of 3D data.

FIG. 41 is a diagram illustrating an example of a method of decoding a video component of 3D data.

FIG. 42 is a diagram illustrating an example of a method of decoding a video component of 3D data.

FIG. 43 is a diagram illustrating an example of a method of decoding a video component of 3D data.

FIG. 44 is a diagram illustrating an example of a state of merging video components.

FIG. 45 is a diagram illustrating an example of a state of merging using information of a file.

FIG. 46 is a diagram illustrating an example of reference information between tracks.

FIG. 47 is a diagram illustrating an example of a state of merging using information of a file.

FIG. 48 is a diagram illustrating an example of reference information between tracks.

FIG. 49 is a block diagram illustrating a main configuration example of a file generation device.

FIG. 50 is a flowchart illustrating an example of a flow of file generation processing.

FIG. 51 is a block diagram illustrating a main configuration example of a reproduction device.

FIG. 52 is a flowchart illustrating an example of a flow of reproduction processing.

FIG. 53 is a flowchart illustrating an example of a flow of reproduction processing.

FIG. 54 is a diagram illustrating an example of reference information between tracks.

FIG. 55 is a flowchart illustrating an example of a flow of reproduction processing.

FIG. 56 is a diagram illustrating an example of an MPD.

FIG. 57 is a diagram illustrating an example of a state of merging using information of an MPD.

FIG. 58 is a block diagram illustrating a main configuration example of a file generation device.

FIG. 59 is a flowchart illustrating an example of a flow of file generation processing.

FIG. 60 is a block diagram illustrating a main configuration example of a reproduction device.

FIG. 61 is a flowchart illustrating an example of a flow of reproduction processing.

FIG. 62 is a flowchart illustrating an example of a flow of reproduction processing.

FIG. 63 is a diagram illustrating an example of an MPD.

FIG. 64 is a flowchart illustrating an example of a flow of reproduction processing.

FIG. 65 is a diagram illustrating an example of an MPD.

FIG. 66 is a diagram illustrating an example of an MPD.

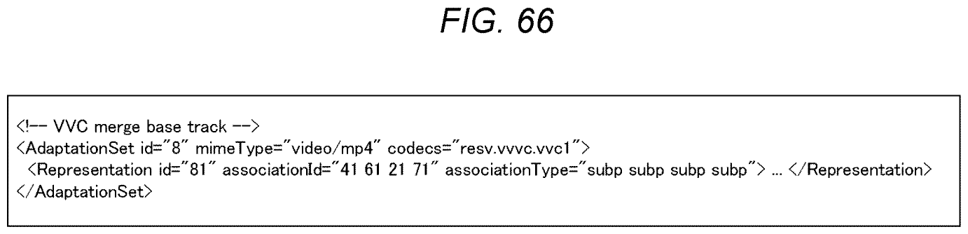

FIG. 67 is a diagram illustrating an example of a distribution file.

FIG. 68 is a diagram illustrating a description example of information regarding a distribution file in an MPD.

FIG. 69 is a flowchart illustrating an example of a flow of file generation processing.

FIG. 70 is a flowchart illustrating an example of a flow of reproduction processing.

FIG. 71 is a diagram illustrating an example of an MPD.

FIG. 72 is a diagram illustrating an example of an MPD.

FIG. 73 is a diagram illustrating an example of an outline of processing executed by an edge server.

FIG. 74 is a diagram illustrating an example of an outline of processing executed by a client.

FIG. 75 is a diagram illustrating an example of information for division into video components.

FIG. 76 is a block diagram illustrating a main configuration example of the edge server.

FIG. 77 is a flowchart illustrating an example of a flow of edge server processing.

FIG. 78 is a flowchart illustrating an example of a flow of reproduction processing.

FIG. 79 is a diagram illustrating a configuration example of a scene description.

FIG. 80 is a diagram illustrating an extension example of MPEG_media.

FIG. 81 is a block diagram illustrating a main configuration example of a file generation device.

FIG. 82 is a flowchart illustrating an example of a flow of file generation processing.

FIG. 83 is a block diagram illustrating a main configuration example of a reproduction device.

FIG. 84 is a flowchart illustrating an example of a flow of reproduction processing.

FIG. 85 is a diagram illustrating an example of an extension parameter of MPEG_meda.

FIG. 86 is a diagram illustrating an extension example of MPEG_media.

FIG. 87 is a diagram illustrating an extension example of MPEG_media.

FIG. 88 is a diagram illustrating an extension example of MPEG_media.

FIG. 89 is a diagram illustrating an example of an extension parameter of MPEG_meda.

FIG. 90 is a diagram illustrating an extension example of MPEG_media.

FIG. 91 is a flowchart illustrating an example of a flow of file generation processing.

FIG. 92 is a flowchart illustrating an example of a flow of reproduction processing.

FIG. 93 is a diagram illustrating an example of a state of merging objects in a scene.

FIG. 94 is a diagram illustrating an extension example of MPEG_media.

FIG. 95 is a flowchart illustrating an example of a flow of file generation processing.

FIG. 96 is a diagram illustrating an example of an outline of reproduction processing.

FIG. 97 is a flowchart illustrating an example of a flow of reproduction processing.

FIG. 98 is a flowchart illustrating an example of a flow of MAF initialization processing.

FIG. 99 is a diagram illustrating an example of an extension parameter of MPEG_meda.

FIG. 100 is a diagram illustrating an extension example of MPEG_media.

FIG. 101 is a diagram illustrating an extension example of MPEG_media.

FIG. 102 is a diagram illustrating an extension example of MPEG_media.

FIG. 103 is a diagram illustrating an example of an extension parameter of MPEG_meda.

FIG. 104 is a diagram illustrating an extension example of MPEG_media.

FIG. 105 is a diagram illustrating an example of an extension parameter of MPEG_meda.

FIG. 106 is a diagram illustrating an extension example of MPEG_media.

FIG. 107 is a diagram illustrating an example of an extension parameter of MPEG_meda.

FIG. 108 is a diagram illustrating an extension example of MPEG_media.

FIG. 109 is a diagram illustrating an example of an extension parameter of MPEG_meda.

FIG. 110 is a diagram illustrating an extension example of MPEG_media.

FIG. 111 is a diagram illustrating an example of an MPD.

FIG. 112 is a diagram illustrating an example of an MPD.

FIG. 113 is a diagram illustrating an example of an MPD.

FIG. 114 is a diagram illustrating an example of an MPD.

FIG. 115 is a diagram illustrating an example of MediaInfo.

FIG. 116 is a diagram illustrating an example of MediaInfo.

FIG. 117 is a diagram illustrating an example of MediaInfo.

FIG. 118 is a diagram illustrating an example of MediaInfo.

FIG. 119 is a diagram illustrating an example of MediaInfo.

FIG. 120 is a diagram illustrating an example of an interface pipeline.

FIG. 121 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. Documents and the Like Supporting Technical Content and Technical Terms
2. Reproduction Processing of 3D Data
3. Merging of 3D Data
4. Supplementary Note

### 1. DOCUMENTS AND THE LIKE SUPPORTING TECHNICAL CONTENT AND TECHNICAL TERMS

The scope disclosed in the present technology includes, in addition to the contents disclosed in the embodiments, contents described in following Non-Patent Documents and the like known at the time of filing, the contents of other documents referred to in following Non-Patent Documents and the like.
Non-Patent Document 1: (As described above)
Non-Patent Document 2: (As described above)
Non-Patent Document 3: (As described above)
Non-Patent Document 4: (As described above)
Non-Patent Document 5: (As described above)
Non-Patent Document 6: (As described above)
Non-Patent Document 7: (As described above)
Non-Patent Document 8: (As described above)

That is, the contents described in the above-described Non-Patent Documents, the contents of other documents referred to in the above-described Non-Patent Documents, and the like are also basis for determining the support requirement. For example, even in a case where syntax and terms such as the glTF 2.0 and its extension described in Non-Patent Documents described above are not directly defined in the present disclosure, they are within the scope of the present disclosure and satisfy the support requirements of the claims. Furthermore, for example, technical terms such as parsing (Parsing), syntax (Syntax), and semantics (Semantics) are similarly within the scope of the present disclosure and satisfy the support requirements of the claims even in a case where not directly defined in the present disclosure.

### 2. REPRODUCTION PROCESSING OF 3D DATA

### <2D Codec>

Conventionally, as a 2D codec that encodes and decodes a two-dimensional image, there have been, for example, Versatile Video Coding (WVC) described in Non-Patent Document 1, High Efficiency Video Coding (HEVC) described in Non-Patent Document 1, and the like. Then, these codecs have a technique of merging (integrating) a plurality of encoded data into one and decoding the data.

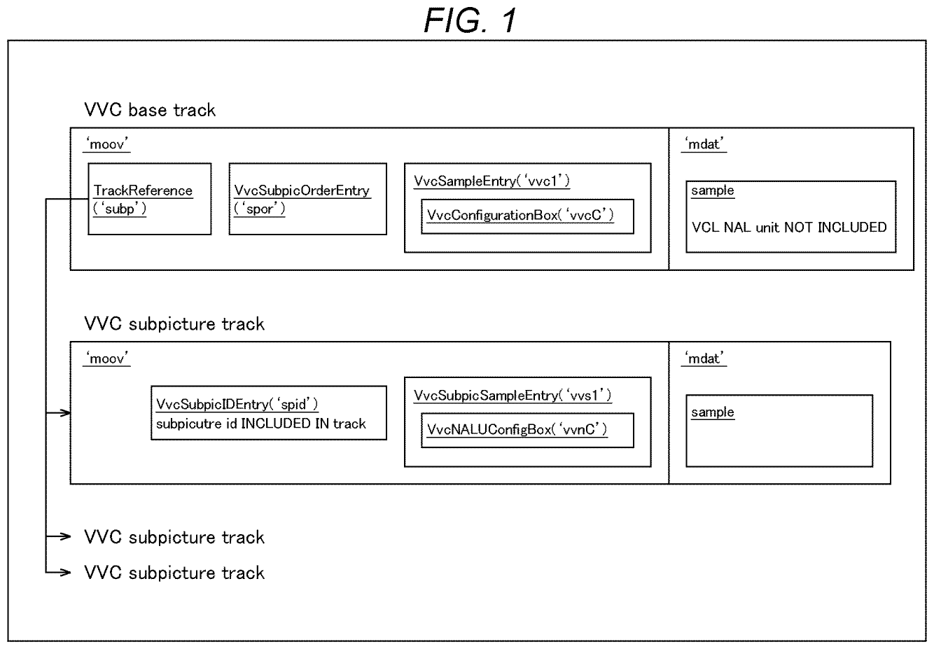

In the case of WVC, as in the example illustrated in FIG. 1, an image can be divided into subpictures, and bitstreams of the respective subpictures can be stored in different tracks (VVC subpicture tracks). That is, a track can be formed for each subpicture. In the example of FIG. 1, three tracks are formed. Then, the bitstreams of these subpictures can be merged and decoded as one bitstream.

As illustrated in FIG. 1, a VVC base track is formed in addition to the VVC subpicture track. The VVC base track is a track that stores information for merging tracks of a plurality of subpictures (also referred to as a VVC merge base track). The client (reproduction device) can merge the bitstreams of the respective subpictures stored in the respective VVC subpicture tracks on the basis of the information stored in the VVC base tracks and decode the merged bitstreams as one bitstream. Note that, in a case where a combination of other subpictures is merged, the WVC base track having a parameter set of the combination of the subpictures is required.

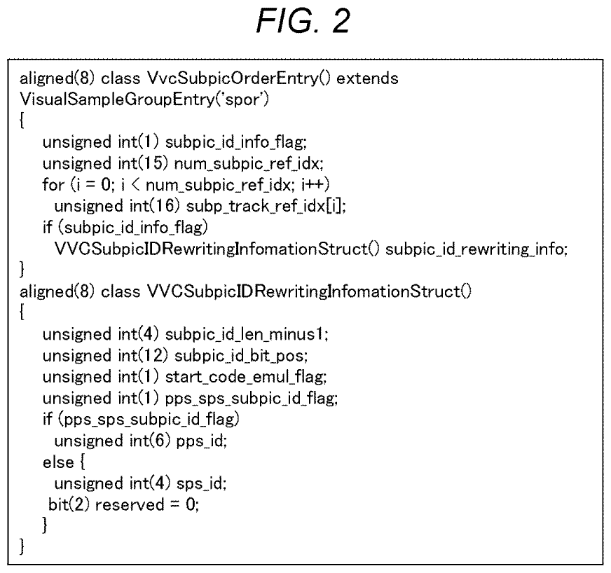

FIG. 2 illustrates an example of syntax of VvcSubpicOrderEntry (‘spor’) stored in the VVC base track. Information regarding merging of subpictures is stored in VvcSubpicOrderEntry. For example, information such as the number of subpictures (num_subpic_ref_idx), the decoding order of the subpictures (subp_track_ref_idx[i]), and rewriting information of subpicture IDs (VVCSubpicIDRewritingInfomationStruct( ) subpic_id_rewriting_info) is stored. The rewriting information of the subpicture ID is information for realizing pictures of different combinations of subpictures in the same subpicture layout. The client merges the subpictures on the basis of such information.

Furthermore, as illustrated in FIG. 1, which VVC subpicture track the WVC base track manages merging is indicated by a track reference (TrackReference (‘subp’)) in the WVC base track. That is, the track reference is access information (reference information) indicating a reference relationship from the VVC base track to the VVC subpicture track or the group of WC subpicture tracks.

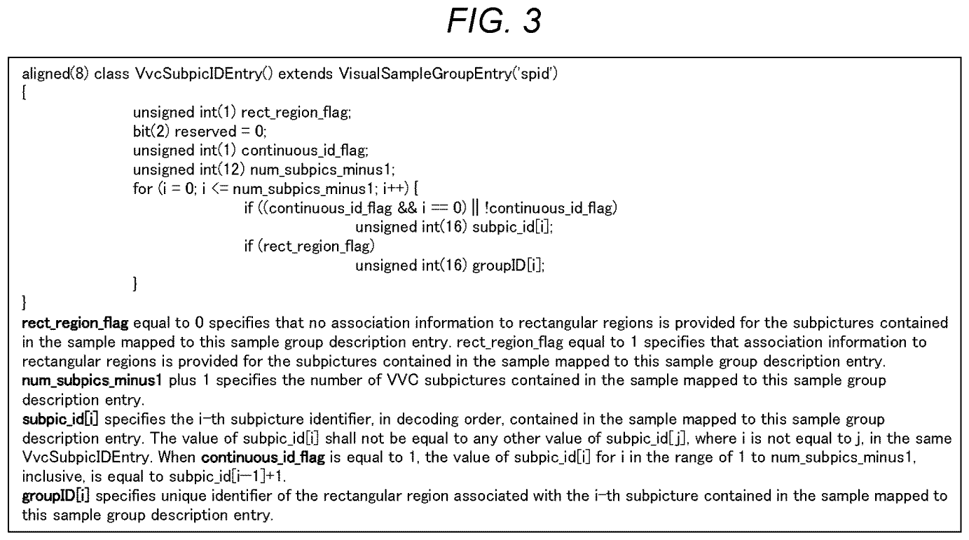

FIG. 3 illustrates an example of the subpicture ID sample group stored in the VVC subpicture track. As illustrated in FIG. 3, subpic_id, which is an identifier of a subpicture included in a sample, is indicated in decoding order.

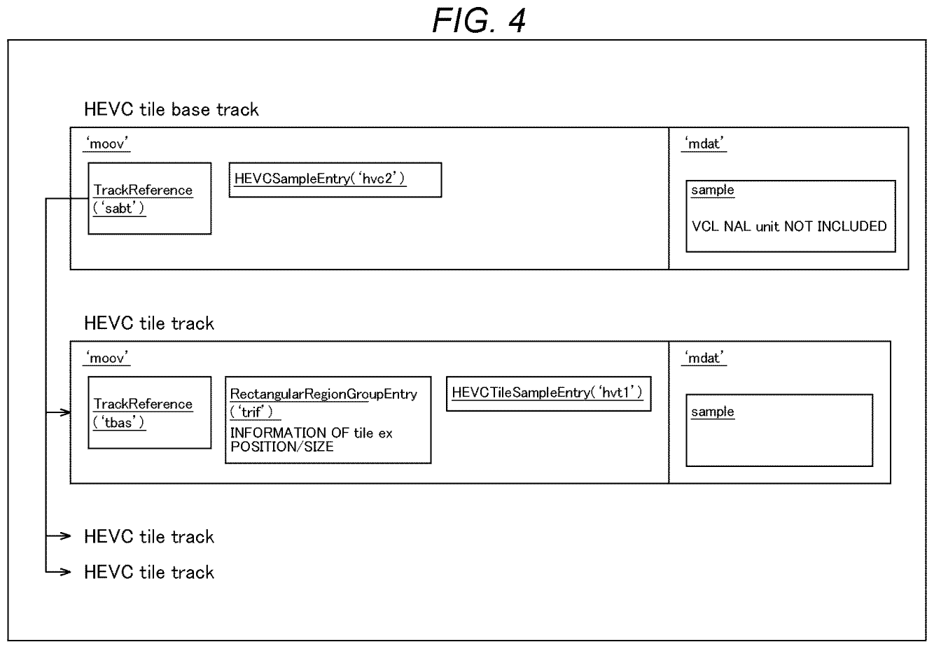

The case of HEVC is basically similar to the case of VVC. For example, in the case of HEVC, as illustrated in FIG. 4, an image can be divided into tiles, and bitstreams of each tile can be stored in different tracks (HEVC tile tracks). That is, a track can be formed for each tile. In the example of FIG. 4, three tracks are formed. Then, the bitstreams of these tiles can be merged and decoded as one bitstream.

As illustrated in FIG. 4, an HEVC tile base track is formed instead of the VVC base track. The HEVC tile base track is a track that stores information for merging tracks of a plurality of tiles. On the basis of the information stored in the HEVC tile base track, the client (reproduction device) can merge the bitstream of each tile stored in each HEVC tile track to decode as one bitstream.

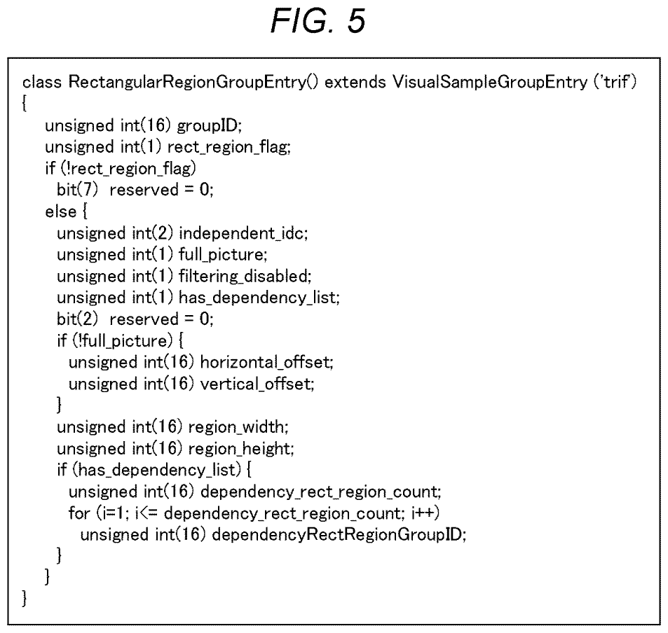

In the case of HEVC, a rectangular region group (‘trif’) stored in HEVC tile track is referred to and used for merging. FIG. 5 illustrates an example of syntax of the rectangular region group (‘trif’). As illustrated in FIG. 5, information on the rectangular region is stored in the rectangular region group (‘trif’). For example, information such as an ID (groupID), position information (horizontal offset, vertical offset), size information (region width, region height), and dependency (dependency_rect_region_count, dependencyRectRegionGroupID) with other rectangular regions is stored in the rectangular region group (‘trif’). The client merges tiles on the basis of such information.

Furthermore, as illustrated in FIG. 4, the HEVC tile base track and the HEVC tile track are managed by TrackReference (‘sabt’) and TrackReference (‘tbas’). The TrackReference (‘sabt’) is stored in the HEVC tile base track and is access information (reference information) indicating a reference relationship from the HEVC tile base track to the HEVC tile track. The TrackReference (‘tbas’) is stored in the HEVC tile track and is access information (reference information) indicating a reference relationship from the HEVC tile track to the HEVC tile base track.

### <3D Codec>

For these 2D codecs, there has been a 3D codec that encodes and decodes three-dimensional data. For example, as the 3D codec, there are Video-based Point Cloud Compression (V-PCC) described in Non-Patent Document 3, Video-based Dynamic Mesh Coding (V-DMC) described in Non-Patent Document 4, MPEG Immersive Video (MIV) described in Non-Patent Document 5, and the like.

### <V-PCC>

The V-PCC is an encoding method of a point cloud which is 3D data. The point cloud is a set of points simultaneously having position information (geometry) and attribute information (attribute) in a three-dimensional space, and the set of points expresses a three-dimensional structure and the like of an object existing in the three-dimensional space. The attribute information may include, for example, color, reflection, and the like.

In the V-PCC, a point cloud is segmented to form a region, and each region is plane-projected and encoded by a moving image codec. That is, in the V-PCC, geometry and attributes are encoded by the 2D codec. Moreover, in the V-PCC, an occupancy map is generated, and the occupancy map is also encoded in the 2D codec. The occupancy map is map information indicating the presence or absence of the projection image (patch) for each N×N pixel of the geometry or the attribute projected on the two-dimensional region.

For example, the occupancy map indicates a region (N×N pixels) in which a patch is present by a value “1”, and indicates a region (N×N pixels) in which no patch is present by a value “O” in the geometry video frame or the attribute video frame. A decoder can grasp whether or not a patch is present in the region by referring to this occupancy map, so that an influence of noise and the like caused by encoding and decoding can be suppressed, and 3D data can be restored more precisely. For example, even when the depth value changes due to encoding and decoding, the decoder can ignore the depth value of the region where no patch exists by referring to the occupancy map. That is, the decoder can be prevented from performing the process as the position information about the 3D data by referring to the occupancy map.

A method of storing a V-PCC bitstream (also referred to as a V3C bitstream) configured by coded data of a point cloud encoded by the V-PCC in the international organization for standardization base media file format (ISOBMFF) has been studied. As this storage method, two types of a single track structure and a multi-track structure are specified.

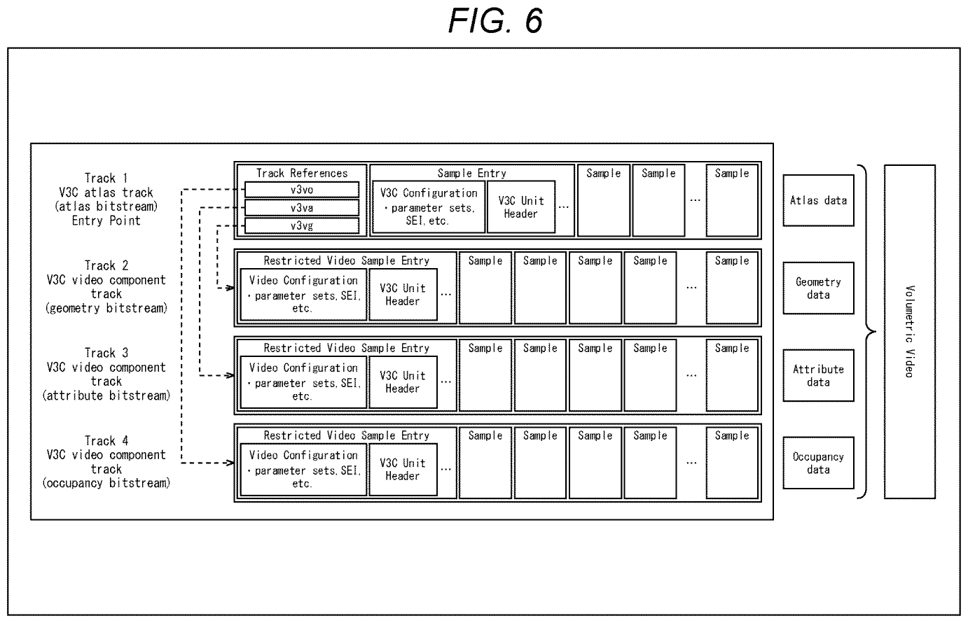

The single track structure is a method of storing a V3C bitstream into one track. The multi-track structure is a method of storing the geometry video sub-bitstream, the attribute video sub-bitstream, the occupancy video sub-bitstream, and the atlas sub-bitstream in separate tracks (track) respectively. Since each video sub-bitstream is a conventional 2D video stream, the video sub-bitstream can be stored (managed) in a similar manner to that of a case of 2D. FIG. 6 illustrates a configuration example of a file in a case where the multi-track structure is applied. As illustrated in FIG. 6, in the case of the multi-track structure, one track (V3C atlas track) stores track reference (Track References) that are information for accessing another track (also referred to as a V3C video component track) storing the V3C bitstream. That is, each V3C video component track is associated with the V3C atlas track by this track reference.

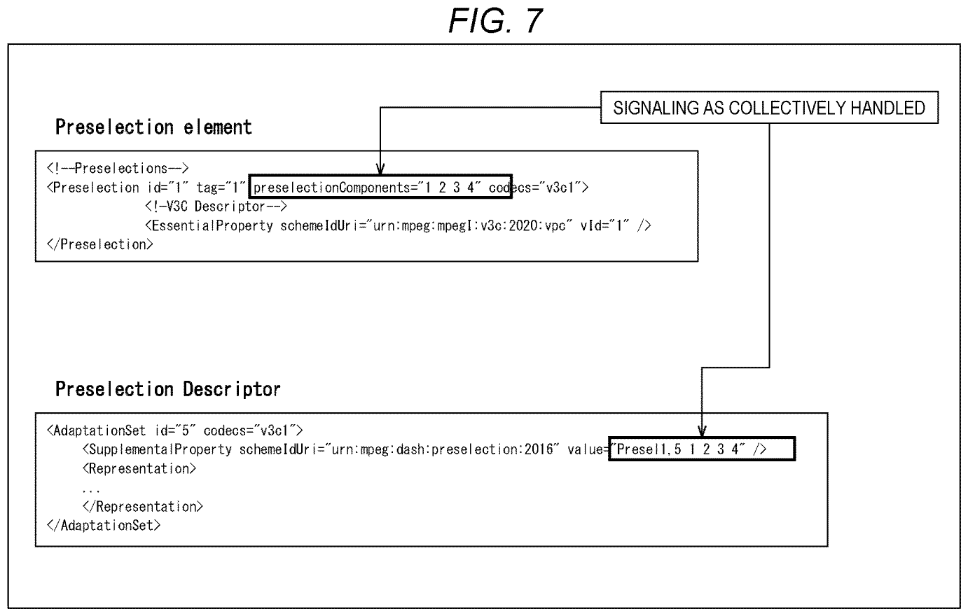

Note that, in a case where moving picture experts group dynamic adaptive streaming over hypertext transfer protocol (HTTP) (MPEG-DASH) is applied to distribute 3D object content, a preselection element or a preselection descriptor may be stored in media presentation description (MPD) that is a control file for controlling the distribution, as information for putting together an adaptation set (AdaptationSet) constituting the V-PCC. FIG. 7 illustrates a description example thereof. That is, in this case, the respective bitstreams constituting the V3C bitstream are associated with each other by these pieces of information about the MPD.

### <V-DMC>

The V-DMC is an encoding method of mesh (3D data). The mesh represents the three-dimensional shape of the object surface by forming polygons with vertices and connections (also referred to as edges).

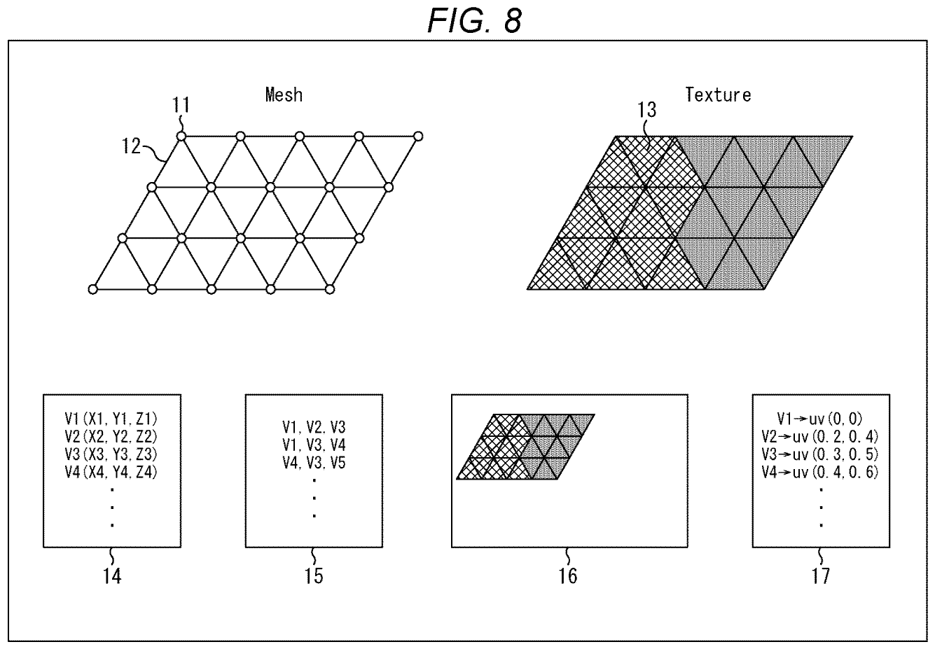

As illustrated in the upper left part of FIG. 8, in the mesh, vertices 11 and connections 12 connecting the vertices 11 form polygonal planes (polygons). In the following description, it is assumed that the polygon has a triangular shape. The surface of the object having the three-dimensional structure, that is, the three-dimensional shape of the object is expressed by the polygon (also referred to as a face). Note that a texture 13 can be attached (applied) to each face of the mesh.

The mesh data includes, for example, information as illustrated in the lower part of FIG. 8. Vertex information 14 illustrated first from the left in the lower part of FIG. 8 is information indicating a three-dimensional position (three-dimensional coordinates (X, Y, Z)) of each vertex 11 constituting the mesh. Connection information 15 illustrated second from the left in the lower part of FIG. 8 is information indicating each connection (edge) 12 constituting the mesh. A texture image 16 illustrated third from the left in the lower part of FIG. 8 is map information of the texture 13 attached to each face. A UV map 17 illustrated fourth from the left in the lower part of FIG. 8 is information indicating a correspondence relationship between the vertex 11 and the texture 13. In the UV map 17, coordinates (UV coordinates) of each vertex 11 in the texture image 16 are shown.

In the V-DMC, a mesh to be encoded (referred to as an original mesh in the present specification) is expressed by a base mesh having lower definition (that is, it is coarse) than the original mesh and a displacement vector of a division point obtained by subdividing the base mesh, and the base mesh and the displacement vector are encoded.

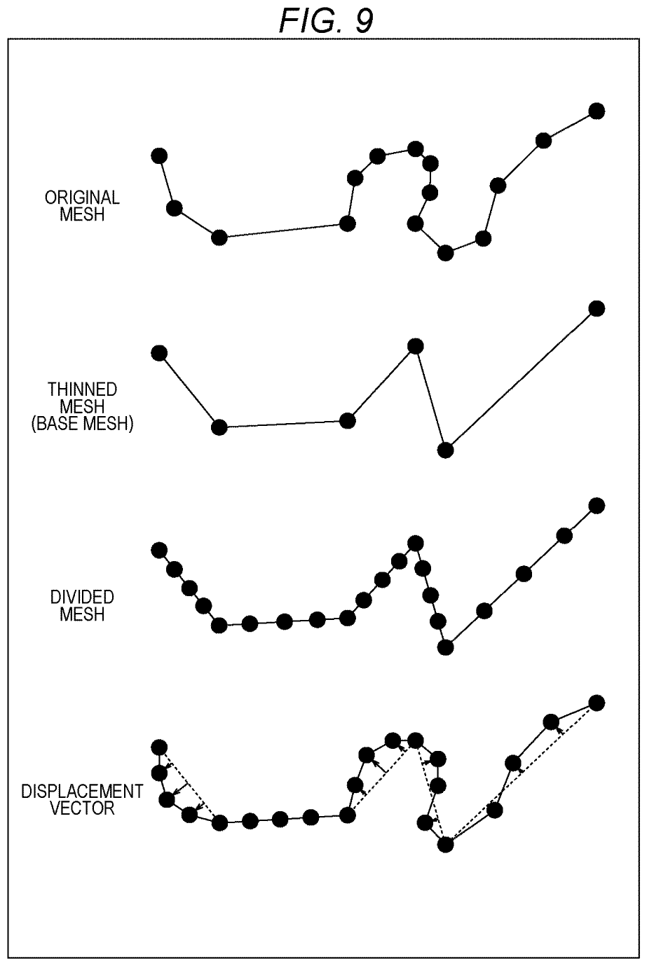

For example, it is assumed that there is an original mesh as illustrated in the uppermost part of FIG. 9. The original mesh is a mesh constituted by vertices representing a three-dimensional structure of an object and connections, and is an encoding target. For example, the original mesh is generated (by camera capture) from a captured image of an object in real space. In FIG. 9, a black dot indicates a vertex, and a line connecting the black dots indicates a connection (edge). As described above, the mesh originally forms a polygon with vertices and edges, but here, for convenience of description, the mesh is described as a vertex group connected linearly (in series).

By simplifying the original mesh, a coarse (low definition) mesh as shown in the second row from the top in FIG. 9 is formed. This is used as a base mesh. As a method of simplification, there is a method of decimating some vertices. That is, the base mesh is a mesh that is generated by decimating (that is, the original mesh is simplified) the vertices from the original mesh and has lower definition than the original mesh.

By subdividing each polygon of this base mesh, vertices and edges are added as shown in the third row from the top in FIG. 9. The degree of subdivision is arbitrary. That is, the number of vertices and the number of edges to be added are arbitrary. For example, by this subdivision, it is also possible to add the number of vertices obtained by thinning out the original mesh. That is, the number of vertices can be made the same as that of the original mesh by the subdivision. In the present specification, this added vertex is also referred to as a division point. This subdivision can also be repeated recursively. For example, in the case of a technique called midpoint, the process of adding a vertex to the midpoint of an edge (subdivision) is recursively repeated. That is, by recursively repeating the subdivision, the number of vertices increases, and the definition of the mesh is improved. By doing so, for example, subdivision can be performed up to an arbitrary definition (that is, the definition of the subdivided mesh is controlled). In other words, the subdivided mesh can be hierarchized according to its definition. That is, it can also be said that the vertex (division point) and the edge obtained by subdivision processing and the subdivision processing are hierarchized.

However, the connection of the base mesh is updated when the vertices of the original mesh are decimated. The division points resulting from the subdivision are thus formed on this updated connection (edge). Therefore, the shape of the subdivided base mesh is different from the shape of the original mesh. More specifically, as illustrated in the lowermost part of FIG. 9, the position of the division point (on the dotted line) is different from that of the original mesh.

That is, by moving the positions of the vertexes (vertexes or division points of the base mesh) of the subdivided base mesh so as to be close to the vertex positions of the original mesh, the difference in shape between the subdivided base mesh and the original mesh can be reduced. In the present specification, such movement of vertexes of the subdivided base mesh (vertexes or division points of the base mesh) is also referred to as displacement. Furthermore, a vector indicating the movement amount and the movement direction of the displacement is also referred to as a displacement vector. Ideally, by displacing each vertex of the subdivided base mesh, the shape of the subdivided base mesh can match the shape of the original mesh. That is, the original mesh can be expressed as a base mesh and a displacement vector.

In the V-DMC, such a base mesh and displacement vectors are encoded instead of the original mesh (geometry). As described above, by encoding the base mesh and the displacement vector, encoding can be performed in a state where the number of polygons (that is, the number of vertices or the number of edges) is reduced as compared with the case of encoding the original mesh, and thus, in general, the amount of code can be reduced with respect to equivalent quality. That is, the encoding efficiency can be improved.

More specifically, in the V-DMC, a base mesh, a displacement vector, a texture (attribute), and atlas information are encoded, respectively. The atlas information is information necessary for reconstructing the mesh, and includes, for example, information indicating a correspondence between the base mesh, the displacement vector, and the texture. For example, it may include information for associating a mesh patch and an attribute patch, such as the UV map 17 of FIG. 8. Among these pieces of information, a displacement vector and a texture are projected onto a two-dimensional region and encoded as a moving image. That is, in the V-DMC, the displacement vector and the texture are encoded by the 2D codec.

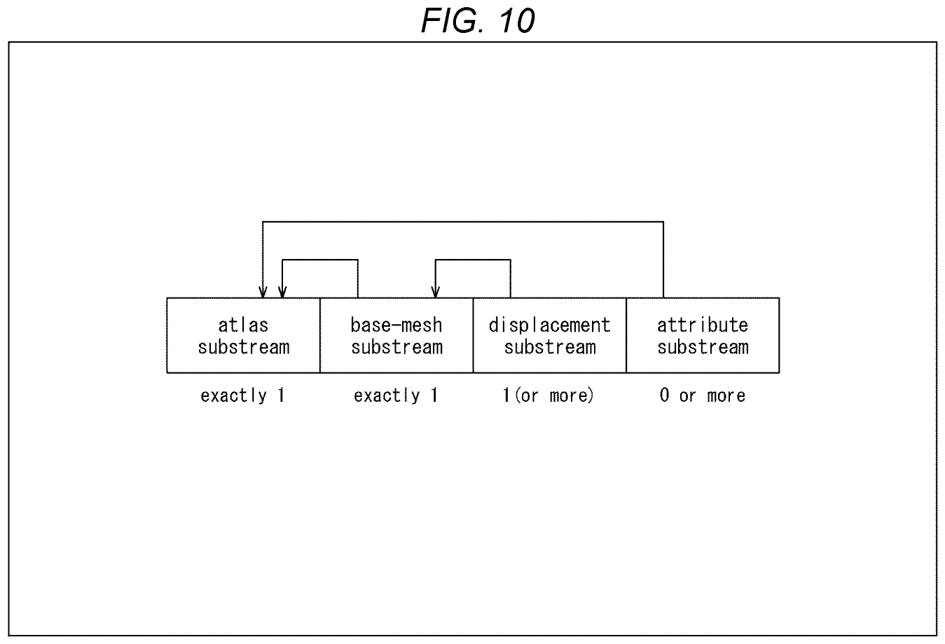

By such encoding, as illustrated in FIG. 10, a stream of the base mesh, a stream of the displacement vector, a stream of the texture, and a stream of the atlas information are set as sub-streams, and one bitstream (V-DMC bitstream) is generated. At the time of decoding, each sub-stream is independently decoded.

Then, the decoded base mesh is subdivided, and a displacement vector is applied to each vertex of the subdivided base mesh and displaced, so that the mesh is restored (generated). In the present specification, this restored mesh is also referred to as a restoration mesh. Ideally, a restoration mesh equivalent to the original mesh can be generated. Note that the shape of the polygon (face) may be a polygon, but in the following description, it is assumed that the polygon has a triangular shape. Therefore, in the following description, a polygon (face) is also referred to as a triangle. Then, the texture is applied to the restoration mesh on the basis of the atlas information.

### <MIV>

The MIV is a framework in which data reduction such as viewpoint thinning-out and pixel pruning is performed on a multi-viewpoint video including a large number of textures and depths, and then encoding and transmission are performed. The MIV is, for example, an encoding method for encoding 6DoF video (video whose position can be slightly changed with respect to video whose direction is only free at a specific position called 3DoF+) in a limited position and direction. In the MIV, similarly to the V-PCC, the geometry, the attribute, and the occupancy map of the 3D data are encoded by the 2D codec.

### <Distribution of 3D Data>

Meanwhile, for distribution of 3D data, for example, there is a method of using moving picture experts group dynamic adaptive streaming over hypertext transfer protocol (HTTP) (MPEG-DASH) described in Non-Patent Document 6 or scene descriptions described in Non-Patent Documents 7 and 8. In the MPEG-DASH, distribution of data is controlled using a control file called media presentation description (MPD).

<gltf2.0>

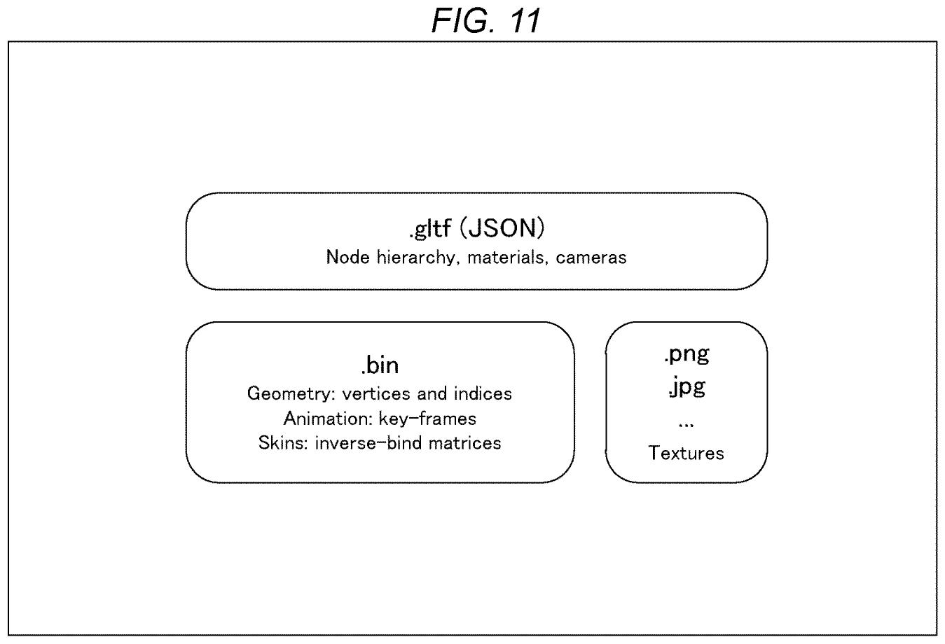

There is the GL Transmission Format (glTF) (registered trademark) 2.0 that is a format for disposing a 3D (three-dimensional) object in a three-dimensional space. For example, as illustrated in FIG. 11, the glTF 2.0 includes a JSON format file (.glTF), a binary file (.bin), and an image file (.png, .jpg, and the like). The binary file stores binary data such as geometry and animation. The image file stores data such as texture.

The JSON format file is a scene description file (scene description file) described in JSON (JavaScript (registered trademark) Object Notation). The scene description is metadata describing (a description of) a scene of the 3D content. The description of the scene description defines what kind of scene the scene is. The scene description file is a file that stores such a scene description. In the present disclosure, the scene description file is also referred to as a scene description file.

The description of the JSON format file includes a list of pairs of a key (KEY) and a value (VALUE). An example of the format will be described below.
“KEY”:“VALUE”

The key includes a character string. The value includes a numerical value, a character string, a true/false value, an array, an object, null, and the like.

Furthermore, a plurality of pairs of a key and a value (“KEY”:“VALUE”) can be put together using { } (braces). The object put together in braces is also referred to as a JSON object. An example of the format will be described below.
“user”:{“id”:1, “name”:“tanaka”}

In this example, a JSON object in which a pair of “id”:1 and a pair of “name”:“tanaka” are put together is defined as a value corresponding to a key (user).

Furthermore, zero or more values can be disposed using [ ] (square brackets). This array is also referred to as a JSON array. For example, a JSON object can be applied as an element of this JSON array. An example of the format will be described below.
test”:[“hoge”, “fuga”, “bar”]
“users”:[{“id”:1, “name”: “tanaka”}, {“id”:2, “name”:“yamada”}, {“id”:3, “name”: “sato”}]

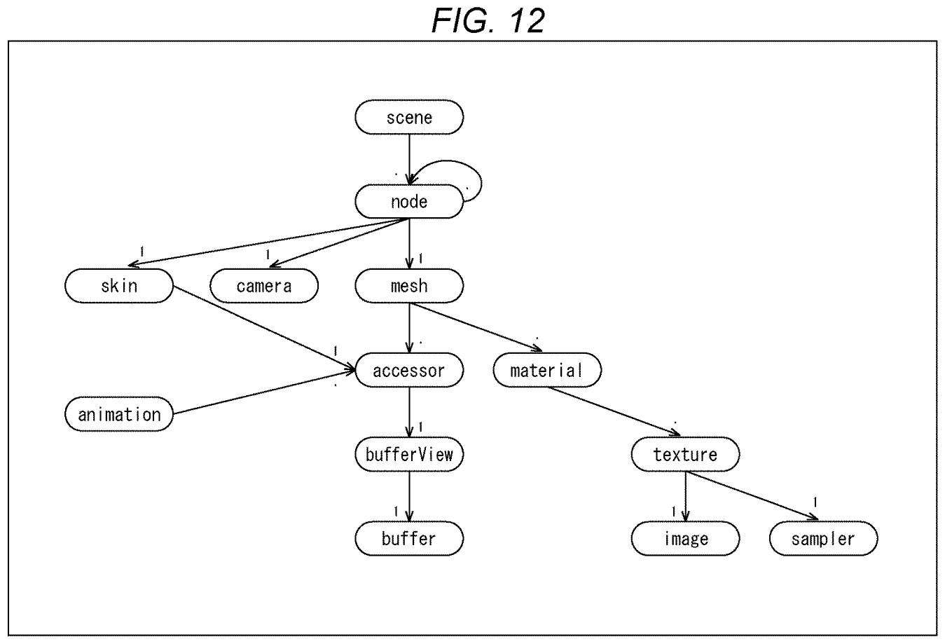

FIG. 12 illustrates glTF objects (glTF object) that can be described at the top of the JSON format file and a reference relationship that they have. Long circles in the tree structure illustrated in FIG. 12 indicate objects, and arrows between the objects indicate reference relationships. As illustrated in FIG. 12, objects such as “scene”, “node”, “mesh”, “camera”, “skin”, “material”, and “texture” are described at the top of the JSON format file.

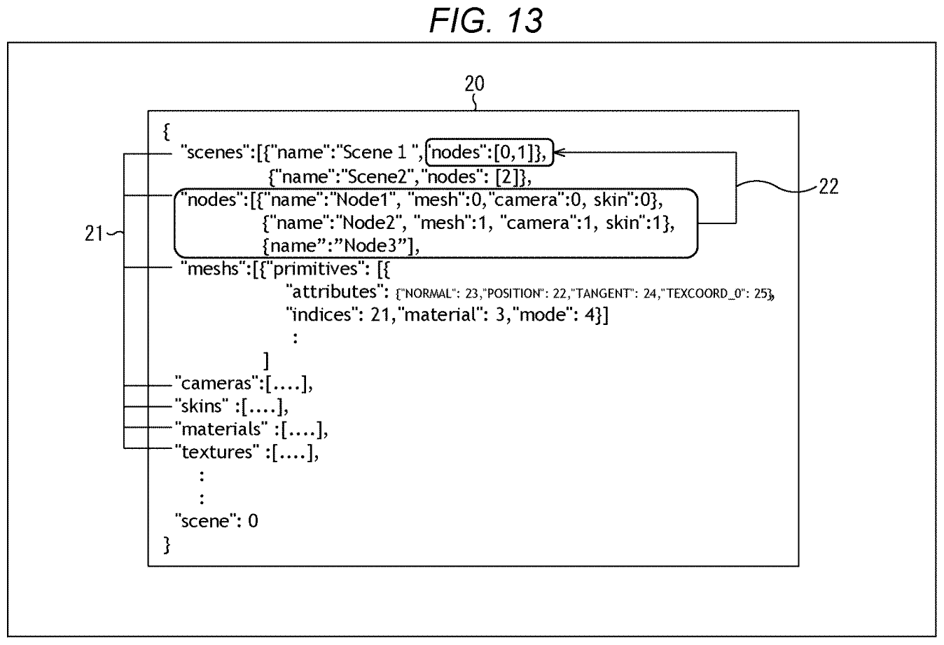

A description example of such a JSON format file (scene description) is illustrated in FIG. 13. A JSON format file 20 of FIG. 13 illustrates a description example of part of the top. In the JSON format file 20, all the used top-level objects 21 are described at the top. The top-level object 21 is the glTF object illustrated in FIG. 12. Furthermore, in the JSON format file 20, a reference relationship between objects (object) is indicated as indicated by an arrow 22. More specifically, the reference relationship is indicated by designating an index (index) of an element of the array of the object to be referred to with the property (property) of the superior object.

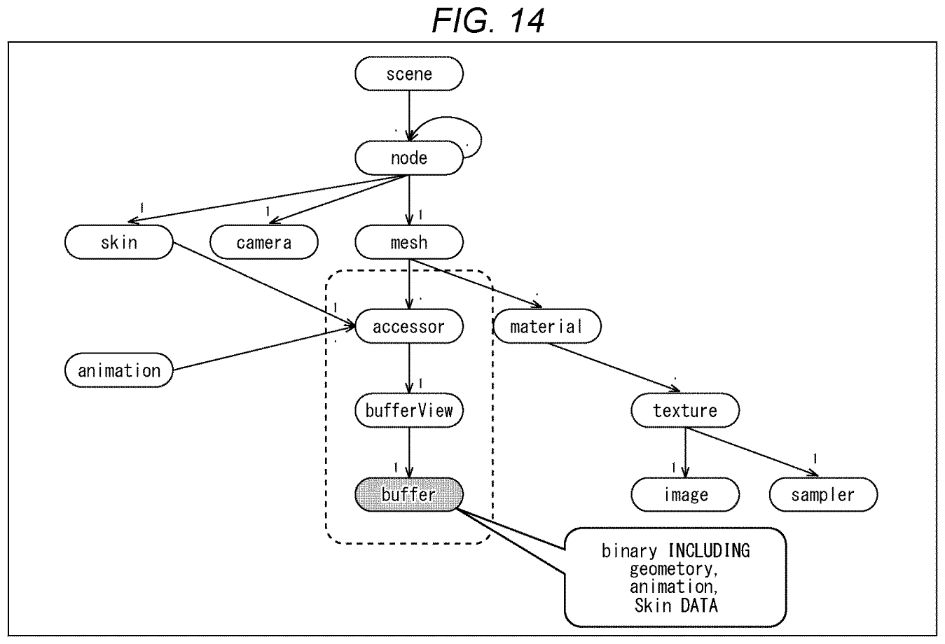

FIG. 14 is a diagram for explaining a method of accessing binary data. As illustrated in FIG. 14, the binary data is stored in the buffer object (buffer object). That is, information (for example, a uniform resource identifier (URI) and the like) for accessing the binary data in the buffer object is indicated. In the JSON format file, as illustrated in FIG. 14, it is possible to access the buffer object via an accessor object (accessor object) and a buffer view object (bufferView object), for example, from objects such as a mesh (mesh), a camera (camera), and a skin (skin).

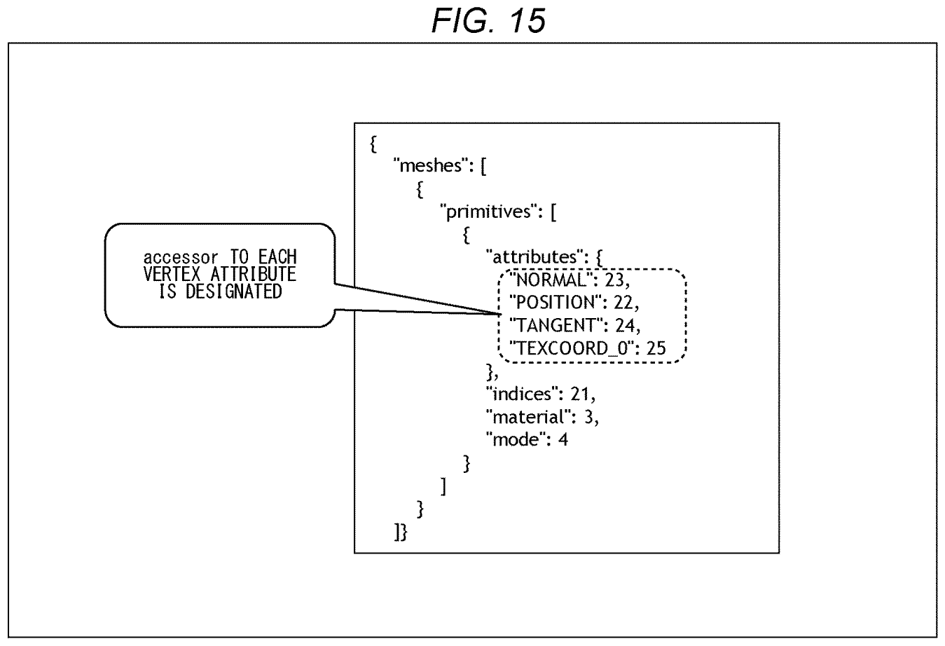

That is, in an object such as the mesh (mesh), the camera (camera), or the skin (skin), an accessor object to be referred to is designated. FIG. 15 illustrates a description example of the mesh object (mesh) in the JSON format file. For example, as illustrated in FIG. 15, in the mesh object, attributes (attribute) of vertices such as NORMAL, POSITION, TANGENT, and TEXCORD_0 are defined as keys, and an accessor object to be referred to is designated as a value for each attribute.

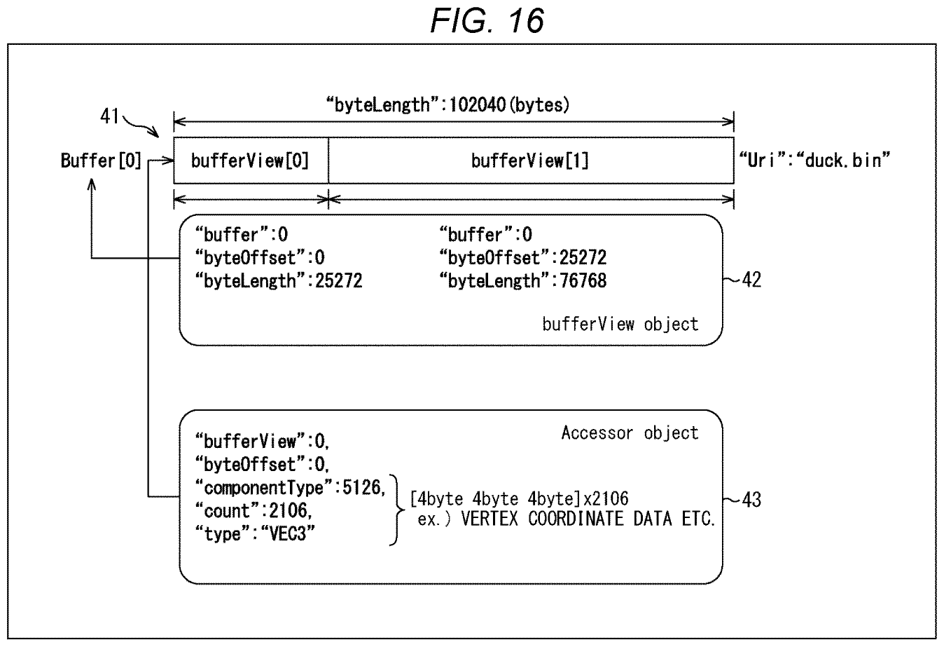

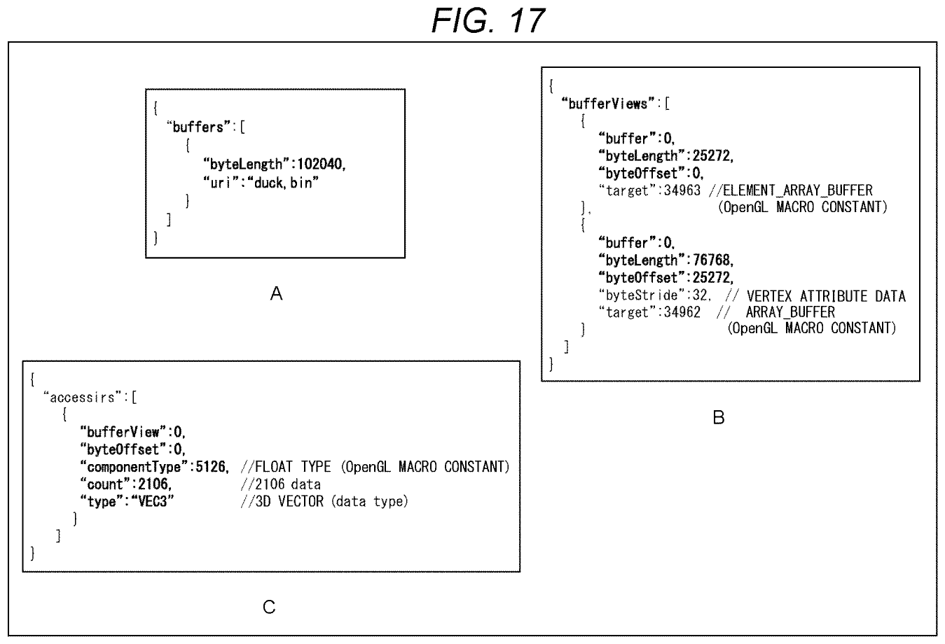

A relationship between the buffer object, the buffer view object, and the accessor object is illustrated in FIG. 16. Furthermore, a description example of these objects in the JSON format file is illustrated in FIG. 17.

In FIG. 16, a buffer object 41 is an object that stores information (such as URI) for accessing binary data that is actual data, and information indicating a data length (for example, byte length) of the binary data. A of FIG. 17 illustrates a description example of the buffer object 41. ““bytelength”:102040” illustrated in A of FIG. 17 indicates that the byte length of the buffer object 41 is 102040 bytes (bytes) as illustrated in FIG. 16. Furthermore, ““uri”:“duck.bin”” illustrated in A of FIG. 17 indicates that the URI of the buffer object 41 is “duck.bin” as illustrated in FIG. 16.

In FIG. 16, a buffer view object 42 is an object that stores information related to a subset (subset) region of binary data designated in the buffer object 41 (that is, information related to a partial region of the buffer object 41). B of FIG. 17 illustrates a description example of the buffer view object 42. As illustrated in B of FIG. 16 or 17, the buffer view object 42 stores, for example, information such as identification information about the buffer object 41 to which the buffer view object 42 belongs, an offset (for example, a byte offset) indicating a position of the buffer view object 42 in the buffer object 41, and a length (for example, a byte length) indicating a data length (for example, a byte length) of the buffer view object 42.

As illustrated in B of FIG. 17, in a case where there is a plurality of buffer view objects, information is described for each buffer view object (that is, for each subset region). For example, information such as ““buffer”:0”, ““bytelength”:25272”, and ““byteOffset”:0” illustrated on the upper side in B of FIG. 17 is information about the first buffer view object 42 (bufferView[0]) illustrated in the buffer object 41 in FIG. 16. Furthermore, the information such as ““buffer”:0”, ““bytelength”:76768”, and ““byteOffset”:25272” illustrated on the lower side in B of FIG. 17 is information about the second buffer view object 42 (bufferView[1]) illustrated in the buffer object 41 in FIG. 16.

““Buffer”:0” of the first buffer view object 42 (bufferView[0]) illustrated in B of FIG. 17 indicates that the identification information about the buffer object 41 to which the buffer view object 42 (bufferView[0]) belongs is “0” (Buffer [0]) as illustrated in FIG. 16. Furthermore, ““bytelength”:25272” indicates that the byte length of the buffer view object 42 (bufferView[0]) is 25272 bytes. Moreover, ““byteOffset”:0” indicates that the byte offset of the buffer view object 42 (bufferView[0]) is 0 bytes.

““Buffer”:0” of the second buffer view object 42 (bufferView[1]) illustrated in B of FIG. 17 indicates that the identification information about the buffer object 41 to which the buffer view object 42 (bufferView[0]) belongs is “0” (Buffer [0]) as illustrated in FIG. 6. Furthermore, ““bytelength”:76768” indicates that the byte length of the buffer view object 42 (bufferView[0]) is 76768 bytes. Moreover, ““byteOffset”:25272” indicates that the byte offset of the buffer view object 42 (bufferView[0]) is 25272 bytes.

In FIG. 16, an accessor object 43 is an object that stores information related to a method of interpreting data of the buffer view object 42. C of FIG. 17 illustrates a description example of the accessor object 43. As illustrated in C of FIG. 16 or 17, the accessor object 43 stores, for example, information such as identification information about the buffer view object 42 to which the accessor object 43 belongs, an offset (for example, byte offset) indicating a position of the buffer view object 42 in the buffer object 41, a component type of the buffer view object 42, the number of pieces of data stored in the buffer view object 42, a type of data stored in the buffer view object 42, and the like. These pieces of information are described for each buffer view object.

In the example in C of FIG. 17, information such as ““bufferView”:0”, ““byteOffset”:0”, ““componentType”:5126”, ““count”:2106”, and ““Type”:“VEC3”” is illustrated. ““bufferView”:0” indicates that the identification information about the buffer view object 42 to which the accessor object 43 belongs is “0” (bufferView[0]), as illustrated in FIG. 16. Furthermore, ““byteOffset”:0” indicates that the byte offset of the buffer view object 42 (bufferView[0]) is 0 bytes. Moreover, ““componentType”:5126” indicates that the component type is a FLOAT type (OpenGL macro constant). Furthermore, ““count”:2106” indicates that the number of pieces of data stored in the buffer view object 42 (bufferView[0]) is 2106. Moreover, ““Type”: “VEC3”” indicates that (the type of) the data stored in the buffer view object 42 (bufferView[0]) is a three-dimensional vector.

All accesses to data other than the image (image) are defined by reference to the accessor object 43 (by designating an accessor index).

Next, a method of designating a 3D object of a point cloud in a scene description (JSON format file) conforming to such a glTF 2.0 will be described. A point cloud is a 3D content expressing a three-dimensional structure (three-dimensional shaped object) as a set of a large number of points. The data of the point cloud includes position information (also referred to as a geometry) and attribute information (also referred to as an attribute) of each point. The attribute can include any information. For example, color information, reflectance information, normal line information, and the like regarding each point may be included in the attributes. As described above, the point cloud has a relatively simple data structure and can express any three-dimensional structure with a sufficient granularity by using a sufficiently large number of points.

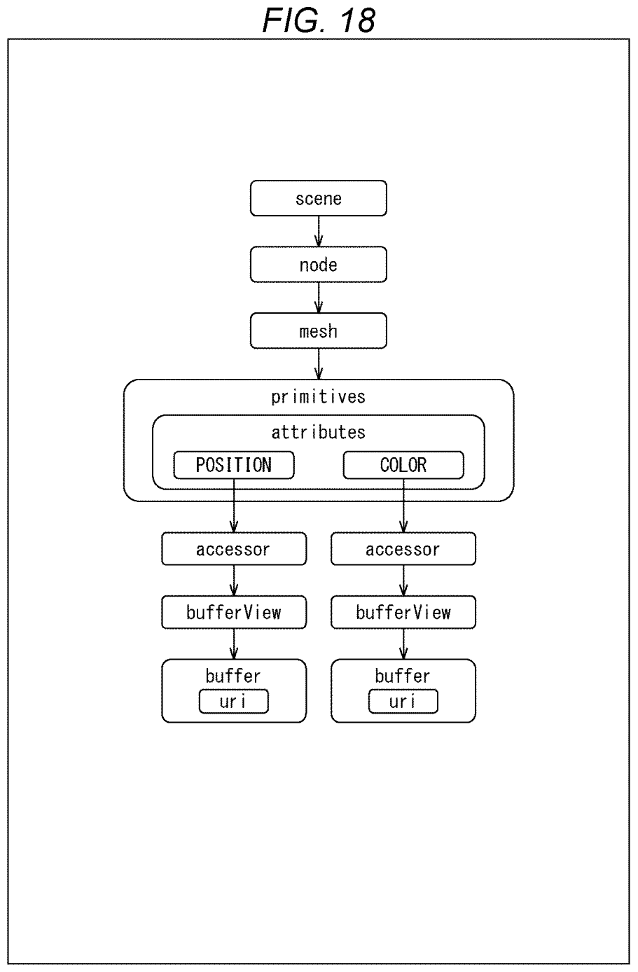

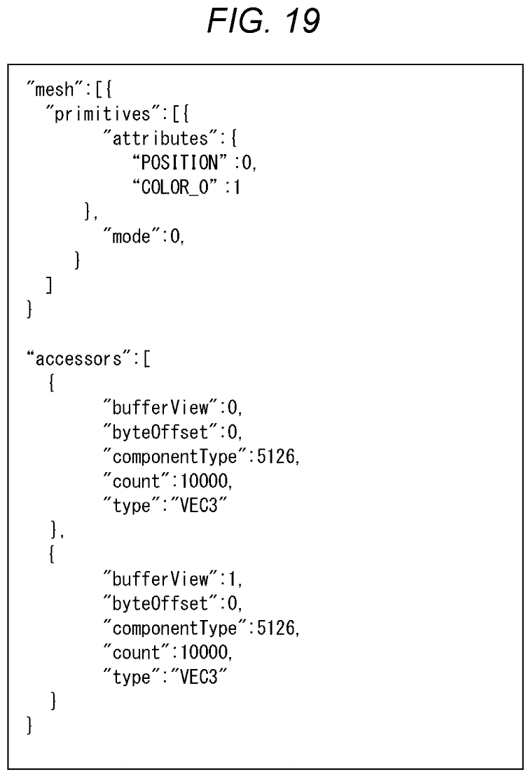

In a case where the point cloud does not change in the time direction (also referred to as static), the mesh.primitives object of the glTF 2.0 is used to designate the 3D object. FIG. 18 is a diagram illustrating a configuration example of an object in a scene description in a case where a point cloud is static. FIG. 19 is a diagram illustrating a description example of the scene description.

As illustrated in FIG. 19, the mode of the primitives object is designated to 0 indicating that data (data) is treated as a point (point) of a point cloud. As illustrated in FIGS. 18 and 19, in the position property (POSITION property) of the attributes object in mesh.primitives, an accessor (accessor) to a buffer (buffer) that stores position information about a point (Point) is designated. Similarly, in the color property (COLOR property) of the attributes object, an accessor (accessor) to a buffer (buffer) that stores color information about a point (Point) is designated. There may be one buffer (buffer) and one buffer view (bufferView) (data (data) may be stored in one file (file)).

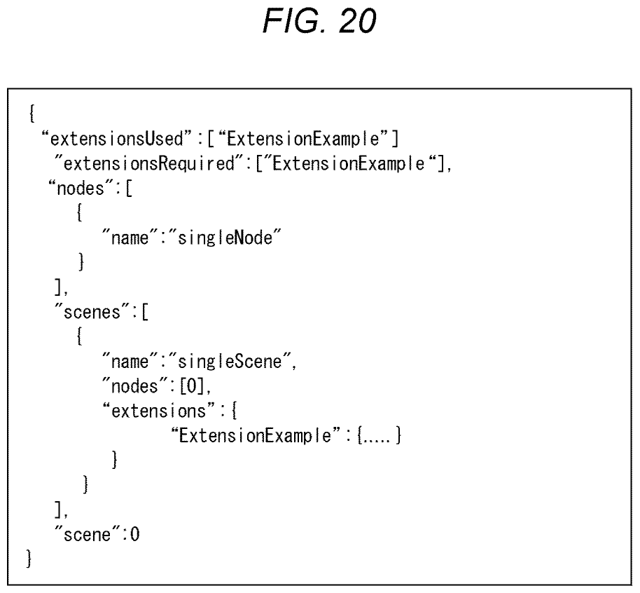

Next, an extension of an object of such a scene description will be described. Each object of glTF 2.0 may store a newly defined object in an extension object (extension object). FIG. 20 illustrates a description example in a case where a newly defined object (ExtensionExample) is specified. As illustrated in FIG. 20, in a case where a newly defined extension is used, the extension object name (in the example of FIG. 20, ExtensionExample) is described in “extensionUsed” and “extensionRequired”. Therefore, it is indicated that the extension is an extension that is used or is an extension required for loading.

### <Client Process>

Next, processing of the client device in the MPEG-I Scene Description will be described. The client device acquires a scene description, acquires data of a 3D object on the basis of the scene description, and generates a display image using the scene description and the data of the 3D object.

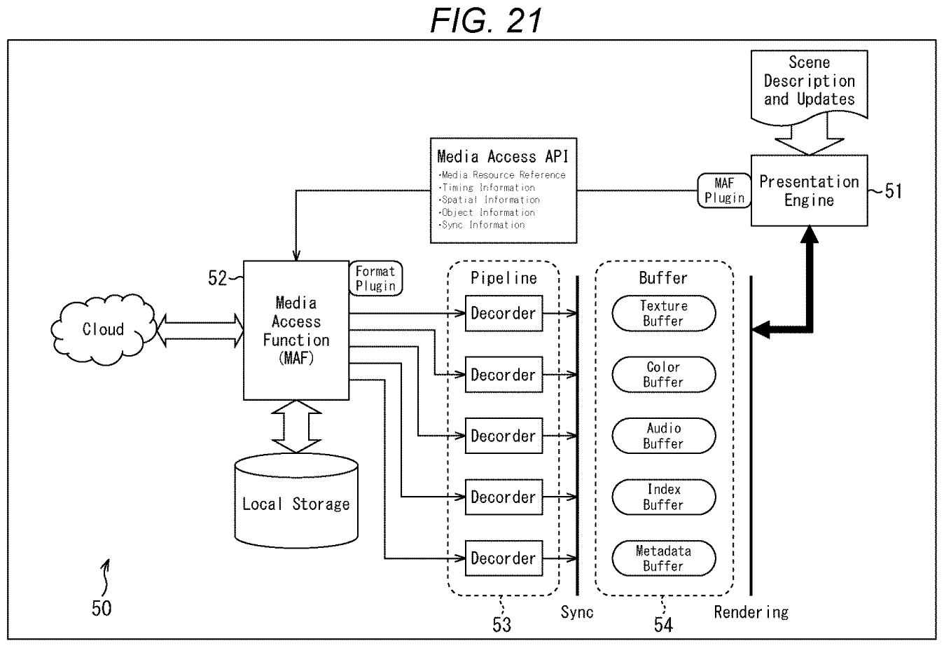

In the client device, a presentation engine, a media access function, and the like performs a process. For example, as illustrated in FIG. 21, a presentation engine (Presentation Engine) 51 of a client device 50 acquires an initial value of a scene description and information (hereinafter, also referred to as update information) for updating the scene description, and generates the scene description at the processing target time. Then, the presentation engine 51 parses the scene description and identifies a medium (moving image, audio, and the like) to be reproduced. Then, the presentation engine 51 requests a media access function (Media Access Function) 52 to acquire the medium via a media access API (Media Access API (Application Program Interface)). Furthermore, the presentation engine 51 also performs setting of a pipeline process, designation of a buffer, and the like.

The media access function 52 acquires various pieces of data of media requested by the presentation engine 51 from a cloud (Cloud), a local storage (Local Storage), and the like. The media access function 52 supplies the acquired various pieces of data (coded data) of the media to a pipeline (Pipeline) 53.

The pipeline 53 decodes various pieces of data (coded data) of the supplied media by a pipeline process, and supplies a decoding result to a buffer (Buffer) 54. The buffer 54 holds various pieces of data of the supplied medium.

The presentation engine 51 performs rendering (Rendering) and the like using various pieces of data of media held in the buffer 54.

### <Application of Timed Media>

In recent years, for example, in the MPEG-I Scene Description, it has been studied to extend the glTF 2.0 and to apply timed media (Timed media) as 3D object content. The timed media is media data that changes in the time axis direction like a moving image in a two-dimensional image.

The glTF was applicable only to still image data as media data (3D object content). That is, the glTF does not correspond to media data of a moving image. In the case of moving the 3D object, animation (a method of switching a still image along a time axis) has been applied.

In the MPEG-I Scene Description, it has been studied to apply the glTF 2.0, apply a JSON format file as a scene description, and further extend the glTF so that timed media (for example, video data) can be handled as media data. In order to handle timed media, for example, the following extension is performed.

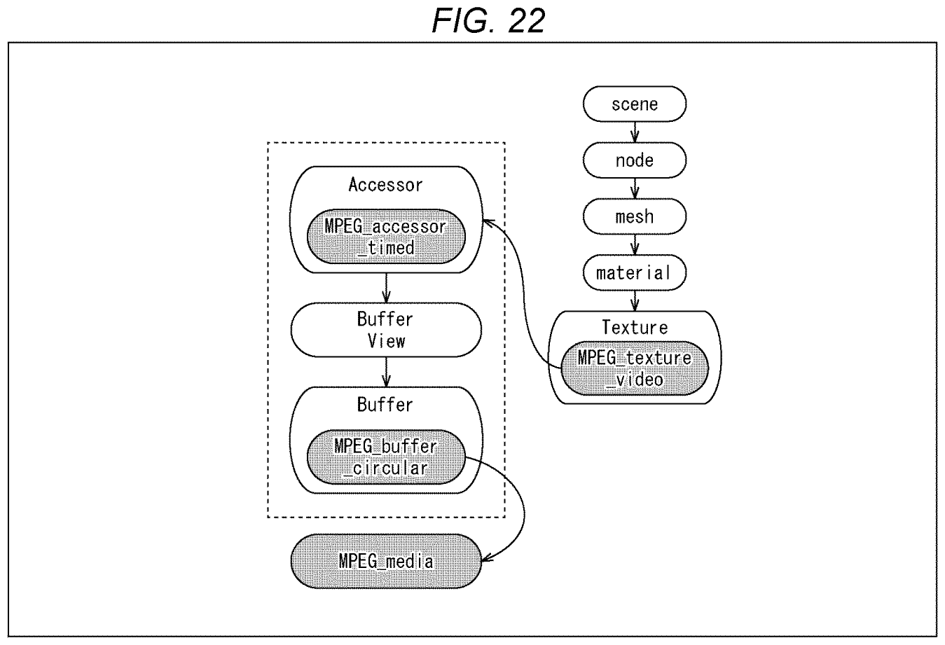

FIG. 22 is a diagram for explaining the extension for handling timed media. In the example of FIG. 22, the MPEG media object (MPEG_media) is an extension of glTF, and is an object that designates attributes of MPEG media such as video data, for example, uri, track, startTime, and the like.

Furthermore, as illustrated in FIG. 22, an MPEG texture video object (MPEG texture video) is provided as an extension object (extensions) of the texture object (texture). In the MPEG texture video object, information about an accessor corresponding to a buffer object to be accessed is stored. That is, the MPEG texture video object is an object that designates an index of an accessor (accessor) corresponding to a buffer (buffer) in which texture media (texture media) designated by the MPEG media object (MPEG_media) are decoded and stored.

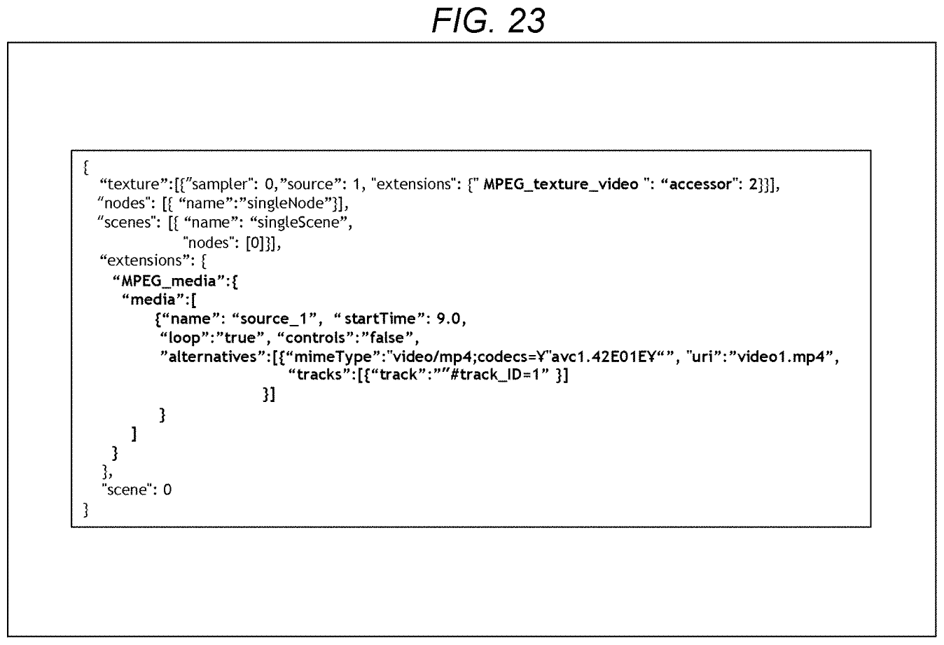

FIG. 23 is a diagram illustrating a description example of an MPEG_media object (MPEG_media) and an MPEG texture video object (MPEG texture video) in a scene description for describing an extension for handling timed media. In the example of FIG. 23, in the second row from the top, an MPEG texture video object (MPEG texture video) is set as an extension object (extensions) of a texture object (texture) as described below. Then, an index of an accessor (“2” in this example) is designated as the value of the MPEG video texture object.
“texture”:[{“sampler”:0, “source”:1, “extensions”:{“MPEG texture video”:“accessor”:2}}],

Furthermore, in the case of the example of FIG. 23, in the seventh to sixteenth rows from the top, an MPEG media object (MPEG_media) is set as an extension object (extensions) of the glTF as described below. Then, as the value of the MPEG media object, for example, various pieces of information related to the MPEG media object such as encoding and URI of the MPEG media object are stored.
“MPEG_media”:{
“media”:[
   {“name”:“source_1”, “startTime”:9.0,
   “loop”:“true”, “controls”:“false”,
   “alternatives”:[{“mimeType”:“video/mp4; codecs=¥“avc 1.42E01E¥””, “uri”:“video1.mp4”,
      “tracks”: [{“track”:““#track_ID=1”}]
      }]
   }
]
}

Furthermore, each frame data is decoded and sequentially stored in a buffer, but its position and the like fluctuate. Therefore, the scene description has a mechanism to store the fluctuating information so that the renderer (renderer) can read the data. For example, as illustrated in FIG. 22, an MPEG buffer circular object (MPEG_buffer_circular) is provided as an extension object (extensions) of the buffer object (buffer). Information for dynamically storing data in the buffer object is stored in the MPEG_buffer_circular object. For example, information such as access information to MPEG media and information indicating the number of frames is stored in the MPEG_buffer_circular object.

Furthermore, as illustrated in FIG. 22, an MPEG accessor timed object (MPEG accessor timed) is provided as an extension object (extensions) of the accessor object (accessor). In this case, since the media data is a moving image, the buffer view object (bufferView) referred to in the time direction may change (the position may vary). Therefore, information indicating the buffer view object to be referred to is stored in the MPEG accessor timed object. For example, the MPEG accessor timed object stores information indicating a reference to a buffer view object (bufferView) in which a timed accessor information header (timedAccessor information header) is described. Note that the timed accessor information header is, for example, header information that stores information in the dynamically changing accessor object and the buffer view object.

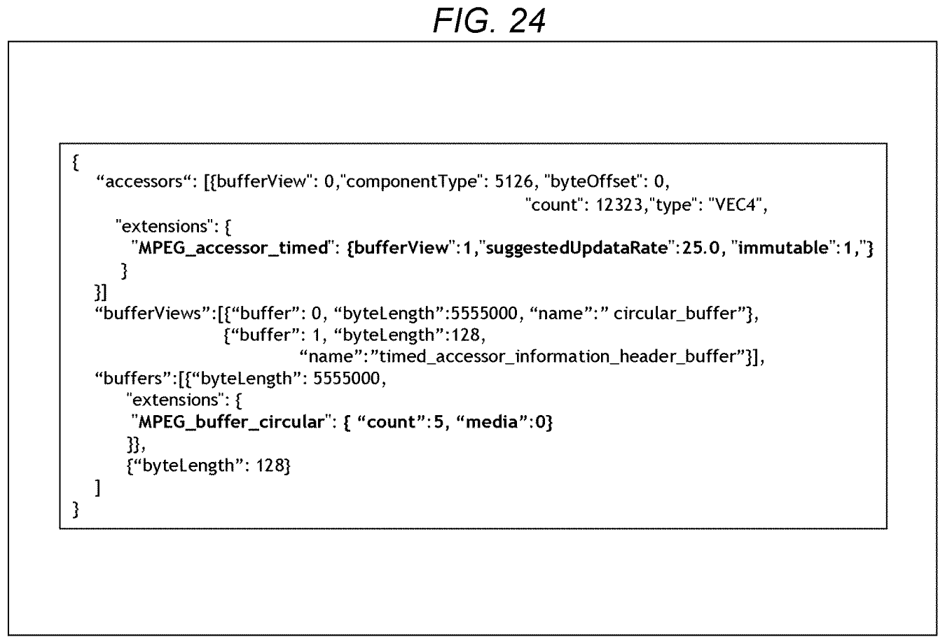

FIG. 24 is a diagram illustrating a description example of an MPEG_buffer_circular object (MPEG_buffer_circular) and an MPEG accessor timed object (MPEG_accessor_timed) in a scene description for describing an extension for handling timed media. In the case of the example of FIG. 24, in the fifth row from the top, an MPEG_accessor_timed object (MPEG_accessor_timed) is set as an extension object (extensions) of the accessor object (accessors) as described below. Then, parameters such as an index (“1” in this example) of the buffer view object, a suggested update rate (suggestedUpdataRate), and immutable information (immutable) and values thereof are designated as values of the MPEG_accessor_timed object.
“MPEG_accessor_timed”: {“bufferView”:1, “suggestedUpdateRate”:25.0, “immutable”:1,”}

Furthermore, in the case of the example of FIG. 24, in the thirteenth row from the top, an MPEG buffer circular object (MPEG_buffer_circular) is set as the extension objects (extensions) of the buffer object (buffer) as described below. Then, parameters such as a buffer frame count (count), access information (media) to MPEG media as the values of the MPEG_buffer_circular object and values thereof are designated.
“MPEG_buffer_circular”:{“count”:5, “media”:0}

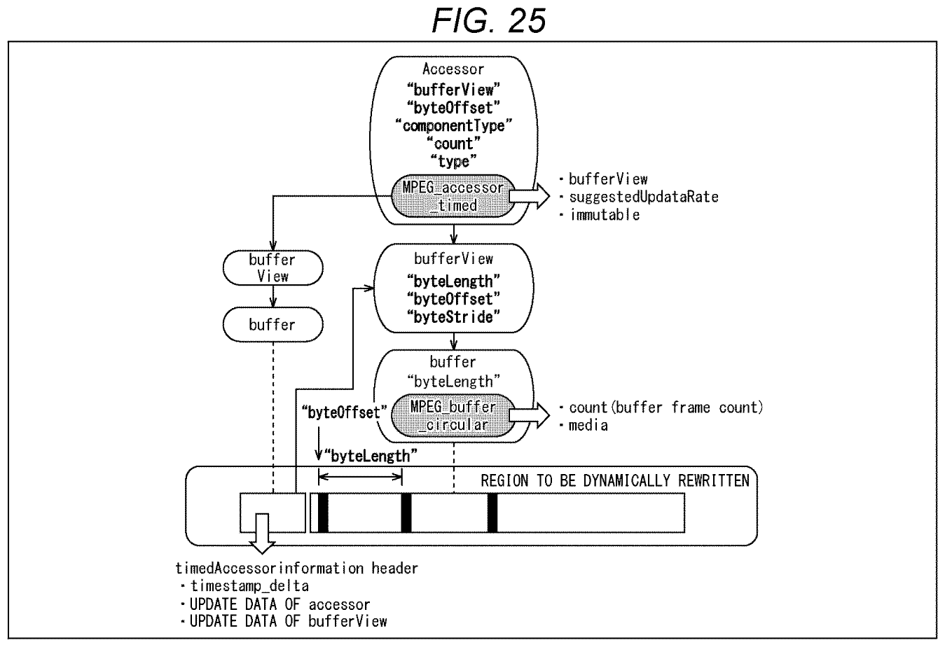

FIG. 25 is a diagram for explaining extension for handling timed media. FIG. 25 illustrates an example of a relationship between an MPEG_accessor_timed object or an MPEG_buffer_circular object, and the accessor object, the buffer view object, and the buffer object.

As described above, the MPEG_buffer_circular object of the buffer object stores information necessary for storing data that changes with time in the buffer region indicated by the buffer object, such as a buffer frame count (count), and access information (media) to MPEG media.

As described above, the MPEG_accessor_timed object of the accessor object stores information related to the buffer view object to be referred to, such as a buffer view object index (bufferView), a suggested update rate (suggestedUpdateRate), and immutable information (immutable). Furthermore, the MPEG_accessor_timed object stores information related to a buffer view object in which the timed accessor information header to be referred to is stored. The timed accessor information header can store a timestamp delta (timestamp_delta), update data for the accessor object, update data for the buffer view object, and the like.

<Client Process in a Case where MPEG Texture Video is Used>

The scene description is spatial arrangement information for disposing one or more 3D objects in a 3D space. The content of the scene description can be updated along the time axis. That is, the arrangement of the 3D objects can be updated with the lapse of time. A client process performed in the client device at this time will be described.

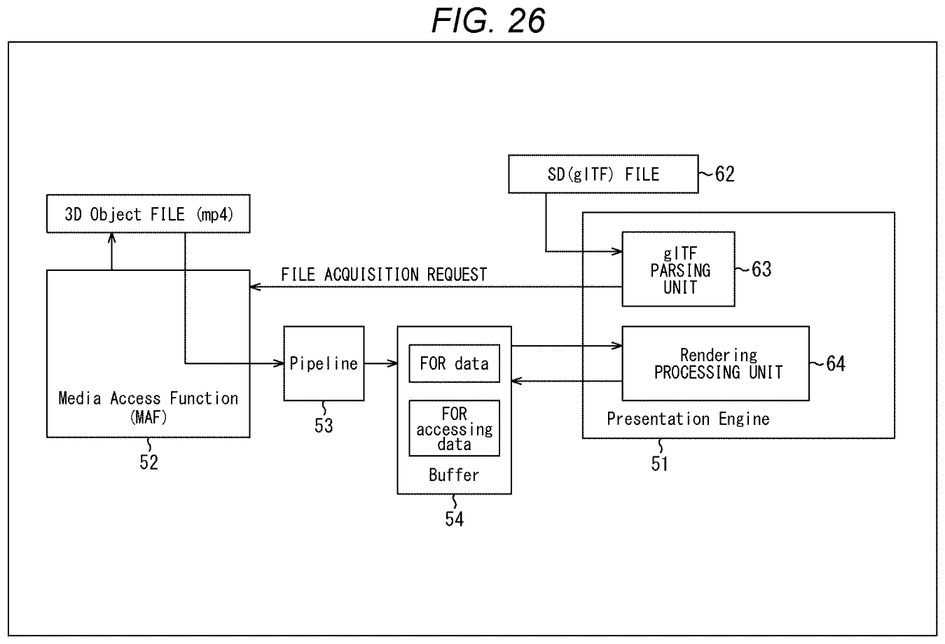

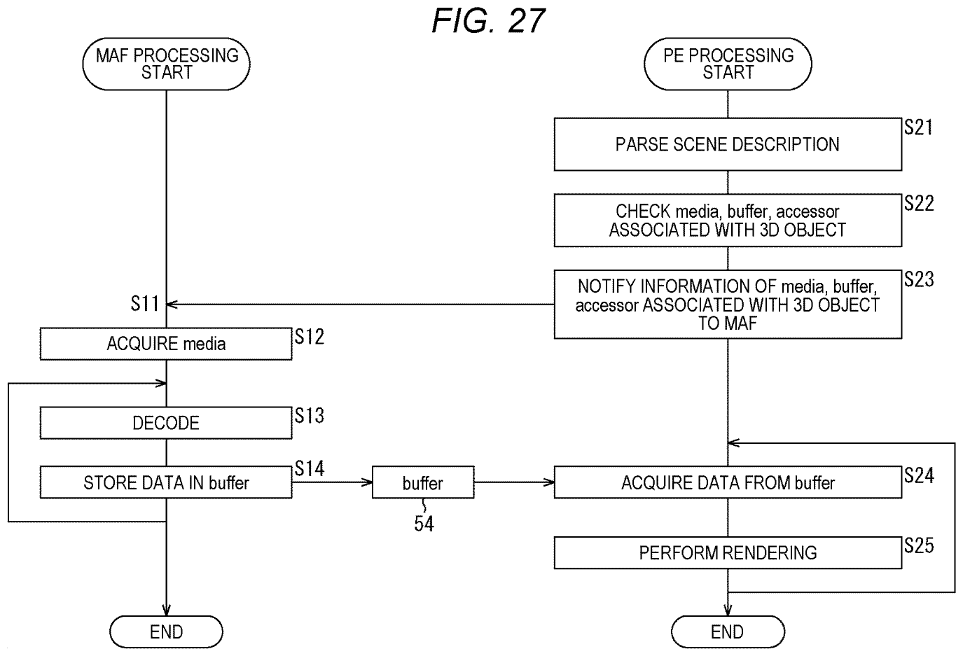

FIG. 26 is a main configuration example regarding the client process of the client device, and FIG. 27 is a flowchart illustrating an example of a flow of the client process. As illustrated in FIG. 26, the client device includes a presentation engine (PresentaionEngine (hereinafter, also referred to as PE)) 51, a media access function (MediaAccessFuncon (hereinafter, also referred to as MAF)) 52, a pipeline (Pipeline) 53, and a buffer (Buffer) 54. The presentation engine (PE) 51 includes a glTF parsing unit 63 and a rendering (Rendering) processing unit 64.

The presentation engine (PE) 51 causes the media access function 52 to acquire media, acquires data thereof via the buffer 54, and performs a process related to display and the like. Specifically, for example, the process is performed in the following flow.

When the client process is started, the glTF parsing unit 63 of the presentation engine (PE) 51 starts the PE process as in the example of FIG. 27, and in step S21, acquires an SD (glTF) file 62 that is a scene description file and parses (parse) the scene description.

In step S22, the glTF parsing unit 63 checks media (media) associated with the 3D object (texture), a buffer (buffer) that stores the media after processing, and an accessor (accessor). In step S23, the glTF parsing unit 63 notifies the media access function 52 of the information as a file acquisition request.

The media access function (MAF) 52 starts the MAF process as in the example of FIG. 27, and acquires the notification in step S11. In step S12, the media access function 52 acquires the media (3D object file (mp4)) on the basis of the notification.

In step S13, the media access function 52 decodes the acquired media (3D object file (mp4)). In step S14, the media access function 52 stores the data of the media obtained by the decoding in the buffer 54 on the basis of the notification from the presentation engine (PE 51).

In step S24, the rendering processing unit 64 of the presentation engine 51 reads (acquires) the data from the buffer 54 at an appropriate timing. In step S25, the rendering processing unit 64 performs rendering using the acquired data and generates a display image.

The media access function 52 repeats the processing of steps S13 and S14 to execute the processing for each time (each frame). Furthermore, the rendering processing unit 64 of the presentation engine 51 repeats the processing of steps S24 and S25 to execute the processing for each time (each frame). When the process ends for all the frames, the media access function 52 ends the MAF process, and the presentation engine 51 ends the PE process. That is, the client process ends.

### <Definition of MPEG Media>

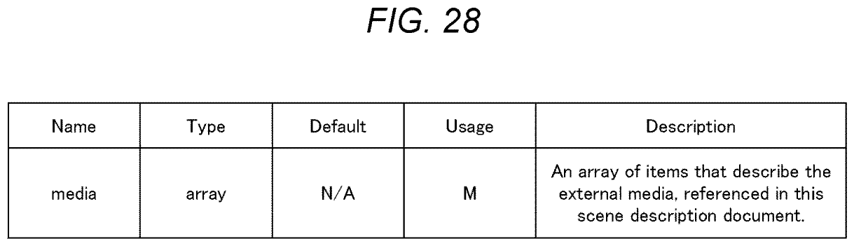

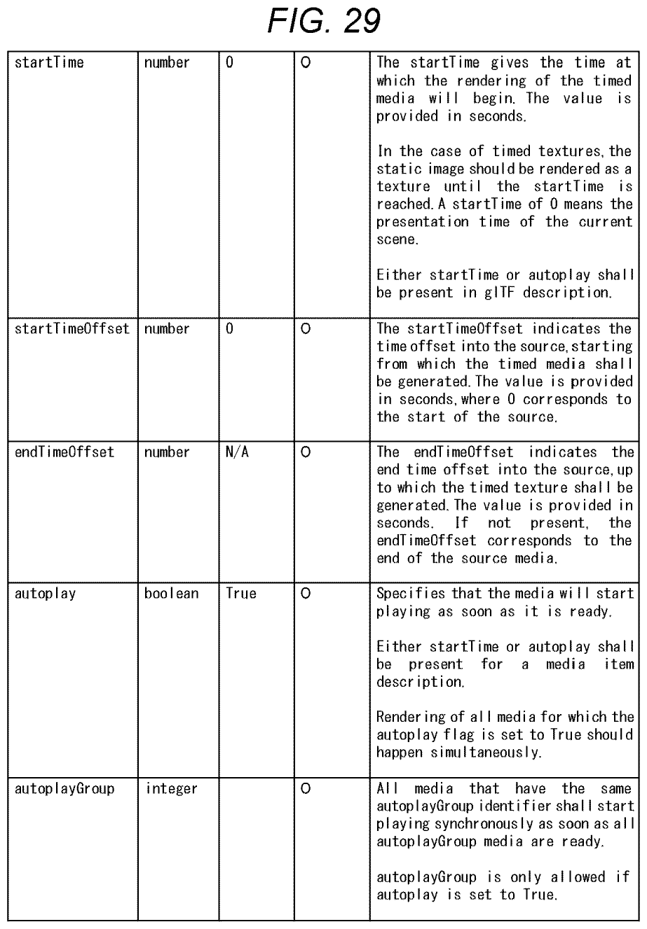

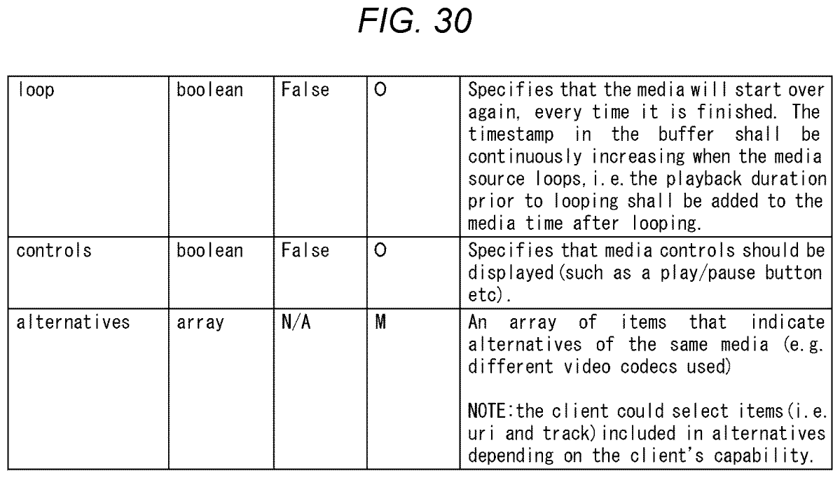

An extension of MPEG media (MPEG_media) is provided as an array of media items referenced in a scene description. At the top level of MPEG media, object media as illustrated in FIG. 28 is defined. Examples of definitions of items used in the array of media are illustrated in FIGS. 29 and 30. For example, startTime indicates a time at which rendering of timed media is started. The value is designated in seconds. In the case of time-limited textures, still images need to be rendered as textures until startTime is reached. In a case where startTime is “0”, it means the presentation time of the current scene. autoplay designates the start of reproducing as soon as the media is ready. autoplayGroup is a function that can designate autoplay in units of groups. Loop designates repetitive reproduction. controls designates display of a user interface related to media reproduction. alternatives indicates an alternative means of the same media (for example, a video codec and the like different from that used). Note that either startTime or autoplay needs to be present for the media item.

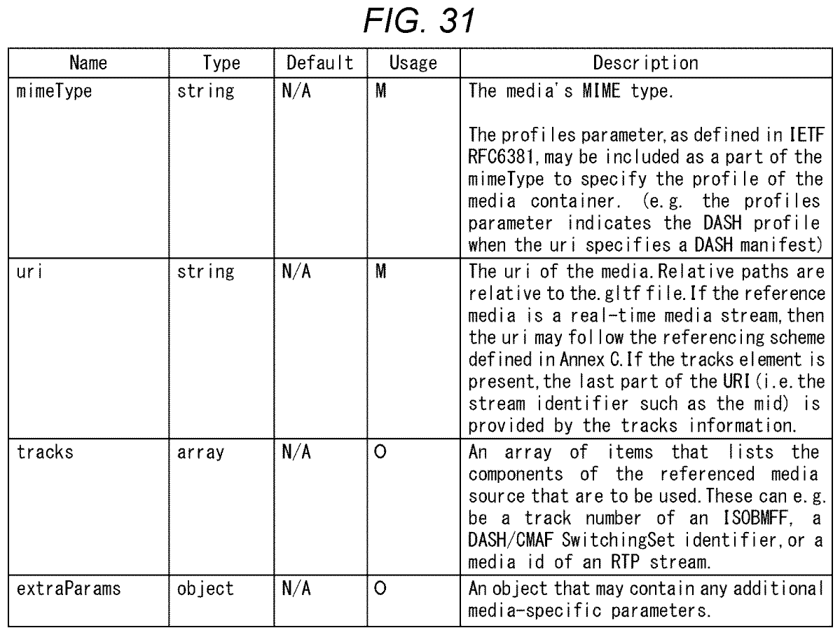

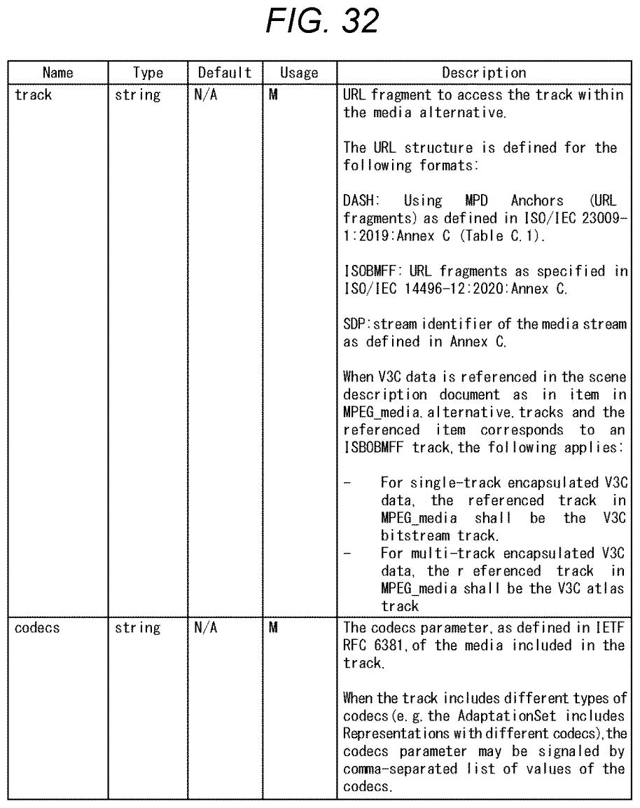

FIG. 31 illustrates an extension example of the alternatives array. In the alternatives array, items as defined in FIG. 20 are used. FIG. 32 illustrates an extension example of the tracks array. In the tracks array, items as defined in FIG. 32 are used.

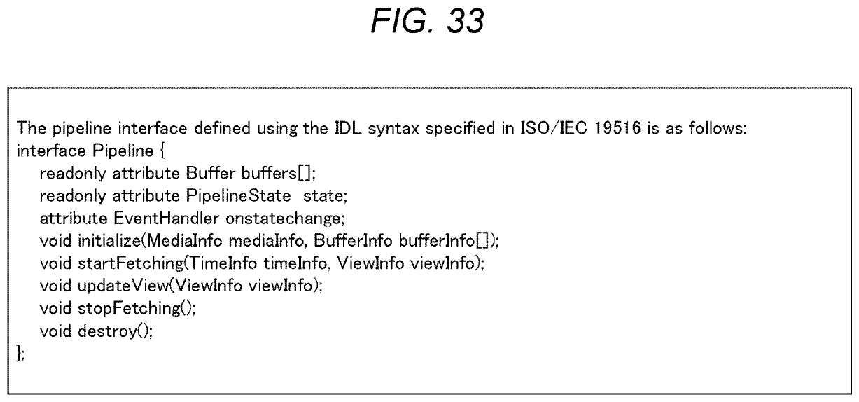

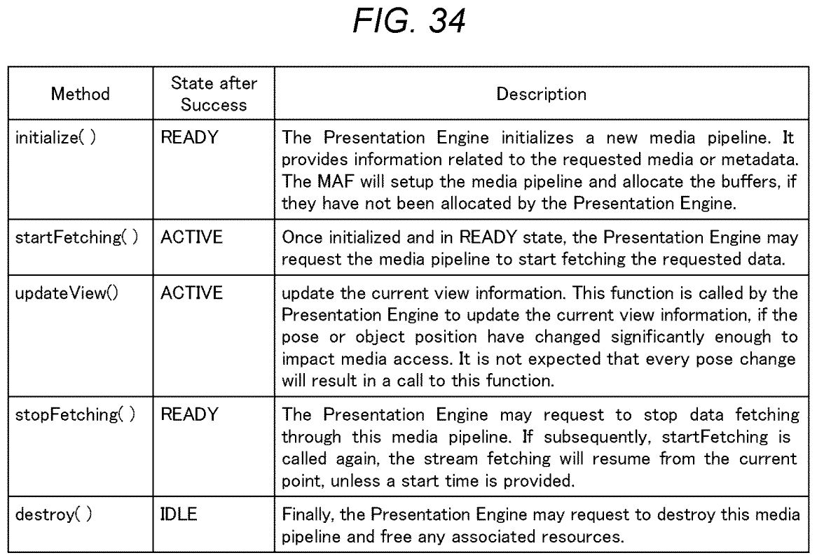

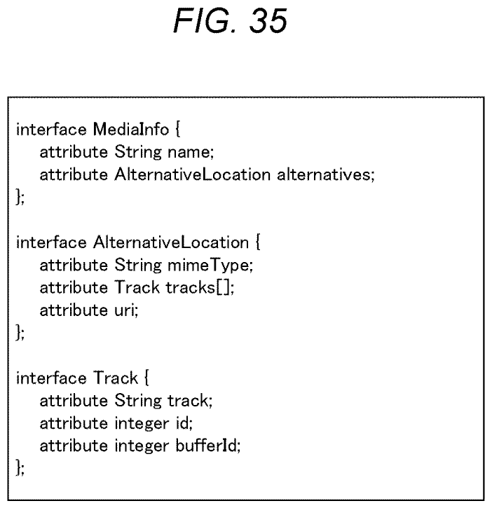

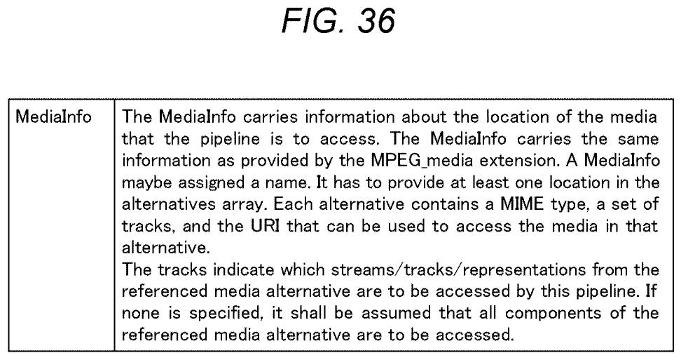

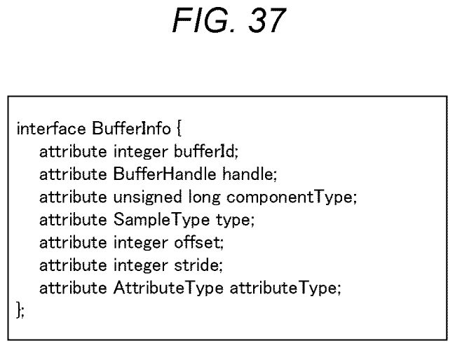

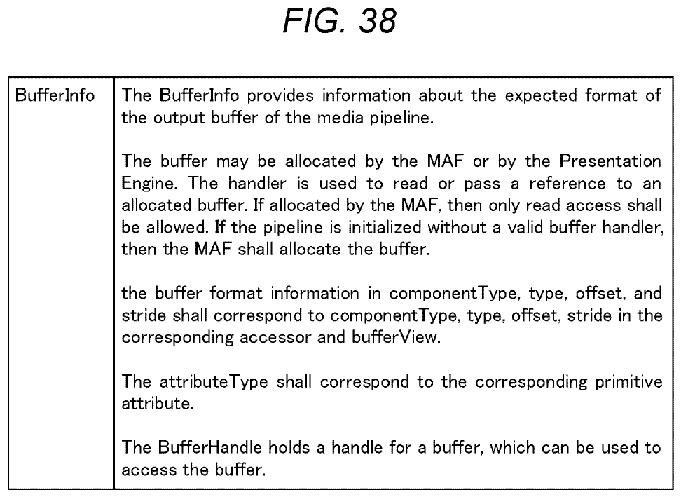

Furthermore, in the scene description, an application program interface (API) of a media access function (MAF) is defined. When initializing the MAF, the presentation engine (PE) passes initialization information such as media information and Buffer information to the MAF via the API. FIG. 33 illustrates an exemplary structure of a pipeline interface. An example of semantics of each parameter is illustrated in FIG. 34. FIG. 35 illustrates an exemplary structure of a MediaInfo interface. An example of semantics of MediaInfo is illustrated in FIG. 36. FIG. 37 illustrates an exemplary structure of a BufferInfo interface. An example of semantics of BufferInfo is illustrated in FIG. 38.

However, in the 3D codec, there is no method of merging and decoding a plurality of encoded data into one as in the 2D codec. Therefore, in a case where the 3D data has a plurality of video components, the 3D codec has decoded the bitstream of each video component using the 2D codec. Therefore, a decoder instance is required for each video component, and the number of decoder instances required for decoding may increase. That is, there is a possibility that the performance condition required for the decoder increases. That is, there is a possibility that the difficulty level of the decoding processing increases. That is, the cost (price) of the decoder may increase.

### 3. MERGING OF 3D DATA

### Method 1

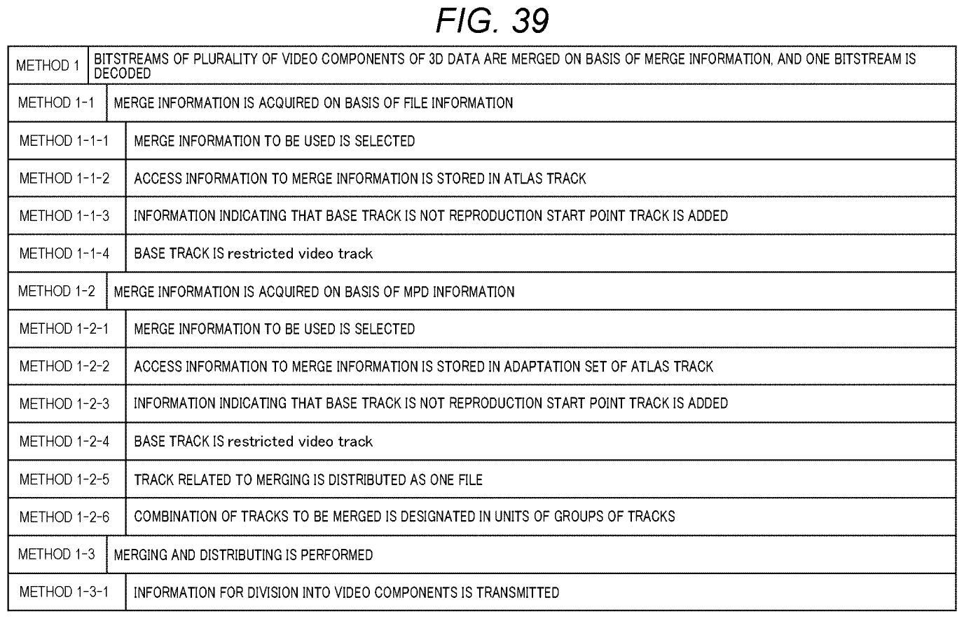

Therefore, by applying various methods as illustrated in FIGS. 39 to 43, it is possible to suppress an increase in the number of decoder instances necessary for decoding video components constituting 3D data.

For example, as shown at the top of the table in FIG. 39, bitstreams of a plurality of video components of 3D data are merged on the basis of merge information, and one bitstream is decoded (Method 1).

For example, a first information processing device includes a 3D data acquisition unit that acquires each bitstream of a plurality of video components of 3D data and merge information for merging the plurality of bitstreams, a merge processing unit that merges the plurality of bitstreams on the basis of the merge information, a decoding unit that decodes the merged bitstream and generates decoded data, a division unit that divides the decoded data into a plurality of video components on the basis of the merge information, and a reconstruction unit that reconstructs the 3D data using the plurality of video components obtained by the division.

For example, in the first information processing device, each bitstream of a plurality of video components of 3D data and merge information for merging the plurality of bitstreams are acquired, the plurality of bitstreams is merged on the basis of the merge information, the merged bitstream is decoded to generate decoded data, the decoded data is divided into a plurality of video components on the basis of the merge information, and the 3D data is reconstructed using the plurality of video components obtained by the division.

For example, a second information processing device includes an encoding unit that encodes 3D data having a plurality of video components, and a content file generation unit that generates a content file, stores each bitstream of the plurality of video components in the content file, generates merge information for merging the plurality of bitstreams, and stores the merge information in the content file.

For example, a second information processing method encodes 3D data having a plurality of video components to generate a content file, stores each bitstream of the plurality of video components in the content file, generates merge information for merging the plurality of bitstreams, and stores the merge information in the content file.

The 3D data to be processed may have a plurality of video components. For example, the content file may be one in which each video component of the 3D data is encoded by a 2D codec (codec for 2D video) and stored in different tracks (file to which multi-track structure is applied). Moreover, the content file may have an atlas track that stores atlas information for reconstructing the 3D data.

Here, the 3D codec may be any codec that encodes and decodes 3D data having a plurality of video components. For example, it may be V-PCC, V-DMC, MIV, or conforming to a standard other than these. Furthermore, a plurality of 3D codecs may be applied.

The 3D data may be, for example, data conforming to the V-PCC (also referred to as V-PCC data), data conforming to the V-DMC (also referred to as V-DMC data), or data conforming to MIV (also referred to as MIV data). Furthermore, the 3D data may be data conforming to another standard. Moreover, they may be mixed.

For example, the V-PCC data includes, as video components, an occupancy video, a geometry video, and an attribute video. The occupancy video is moving image data in which the occupancy map is a frame image. The geometry video is moving image data in which a two-dimensional region (also referred to as a geometry map) on which geometry is projected is used as a frame image. The attribute video is moving image data in which a two-dimensional region (also referred to as an attribute map) on which an attribute is projected is used as a frame image. That is, the V-PCC data including a video component of geometry, attribute, and occupancy may be used as 3D data to be encoded as the video component.

The V-DMC data includes, as video components, a geometry video (displacement video) and an attribute video. The geometry video (displacement video) is moving image data in which a two-dimensional region (also referred to as a displacement map) on which a displacement vector is projected is used as a frame image. The attribute video is moving image data in which a two-dimensional region (attribute map) on which an attribute such as texture is projected is used as a frame image. That is, the V-DMC data including the video component of the geometry (displacement vector) and the attribute may be used as 3D data to be encoded as the video component.

As in the case of the V-PCC data, the MIV data has, as video components, an occupancy video, a geometry video, and an attribute video. That is, the MIV data including a video component of geometry, attribute, and occupancy may be used as 3D data to be encoded as the video component.

Note that, in the following description, the V-PCC data will be used as an example of 3D data unless otherwise specified. The following description can also be applied to the V-DMC data, MIV data, and other 3D data as long as there is no contradiction.

The 2D codec may be of any type. For example, the 2D codec may be a codec for moving images. For example, the 2D codec may be one that can merge and decode bitstreams.

For example, the 2D codec may be VVC. That is, the encoding method of the video component may be an encoding method conforming to VVC. For example, the encoding unit of the second information processing device may encode the video component by an encoding method conforming to VVC.

Furthermore, the 2D codec may be HEVC. That is, the encoding method of the video component may be an encoding method conforming to HEVC. For example, the encoding unit of the second information processing device may encode the video component by an encoding method conforming to HEVC.

Note that the merge information may have any content. For example, information indicating a region in which each video component is arranged may be included in the merge information.

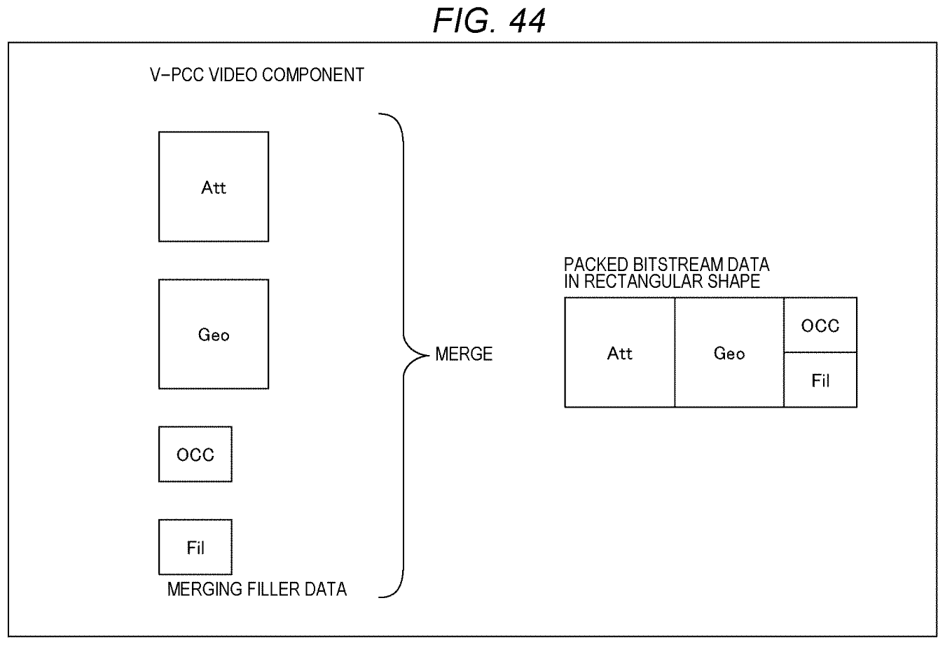

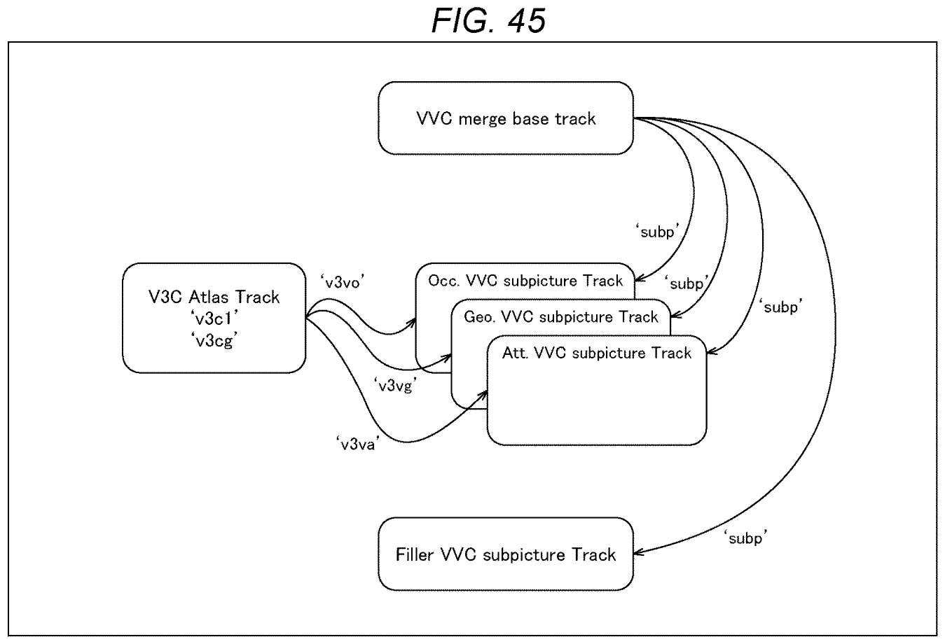

In a case where the 2D codec is VVC, each piece of data is generated as follows. For example, in the case of the V-PCC, each piece of data (video components such as attribute (Att), geometry (Geo), and occupancy (OCC), and atlas information (atlas)) of the V-PCC as illustrated in FIG. 44 is generated. An atlas track (V3C Atlas track) of FIG. 45 is generated from the bitstream of the atlas information.

Furthermore, as illustrated in FIG. 44, data of the video components before encoding is integrated (arranged side by side) to generate one picture (video data). At this time, in a case where the shape of the picture after the integration is not rectangular, filler data (Fil) may be used so as to be rectangular. Each video component (and filler data) is encoded to be a subpicture of the VVC, and a packed bitstream is generated. Merge information is generated from the packed bitstream, and a base track (VVC merge base track) in which the merge information is stored and a video component track (Occ. VVC subpicture track, Geo. VVC subpicture track, Att. VVC subpicture track) in which a bitstream of each video component is stored are generated (FIG. 45).

With such a configuration, it is possible to perform reconstruction as 3D data by using the atlas information (V3C Atlas track), and a packed bitstream is generated by merging the bitstreams of the video components using the merge information (VVC merge base track), and can be decoded as one bitstream.

That is, since the number of bitstreams to be decoded can be reduced by merging, it is possible to suppress an increase in the number of decoder instances necessary for decoding video components constituting 3D data. That is, it is possible to suppress an increase in performance conditions required for decoding. In other words, decoding can be performed more easily. In other words, decoding can be performed at a lower cost (cheaper).

### Method 1-1

In a case where Method 1 is applied, merge information may be acquired on the basis of file information as shown in the second row from the top of the table in FIG. 39 (Method 1-1). For example, a decoder may obtain a bitstream on the basis of information of a content file (for example, the MP4 file (ISOBMFF)) that stores a bitstream of 3D data (V-PCC).

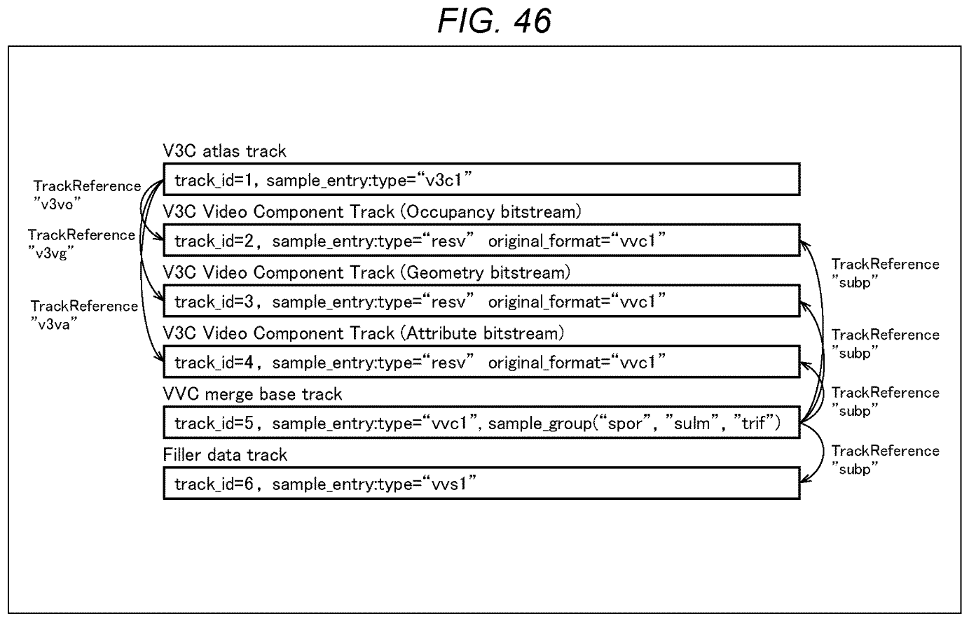

As illustrated in FIG. 45, in a case where the V-PCC bitstream is stored in a multi-track structure and the 2D codec is VVC, then the decoder obtains an atlas track (V3C atlas track). That is, the decoder acquires the track (V3C atlas track) of “sample_entry=‘v3c1’”. The decoder obtains a track (bitstream) of each component of the 3D data on the basis of the atlas track (V3C atlas track). At that time, the decoder acquires a track on the basis of a track reference (TrackReference) of the atlas track. As illustrated in FIG. 46, the atlas track (V3C atlas track) includes a track reference (“v3vo”) having an occupancy track (Occ. VVC subpicture track) as a reference destination, a track reference (“v3vg”) having a geometry track (Geo. VVC subpicture track) as a reference destination, and a track reference (“v3va”) having an attribute track (Att. VVC subpicture track) as a reference destination. The decoder acquires a bitstream of each video component according to these track references.

Then, the decoder acquires merge information (VVC merge base track) on the basis of the information of the file. In the case of the configuration as illustrated in FIG. 45, as illustrated in FIG. 46, the base track (VVC merge base track) includes a track reference (“subp”) having a track of each video component as a reference destination. The decoder identifies and acquires “sample entry=‘vvc1’” and a track having ‘subp’ in the track reference (tref) as a base track (VVC merge base track). As described above, the merge information (VVC merge base track) can be easily identified and acquired by using the information of the file.

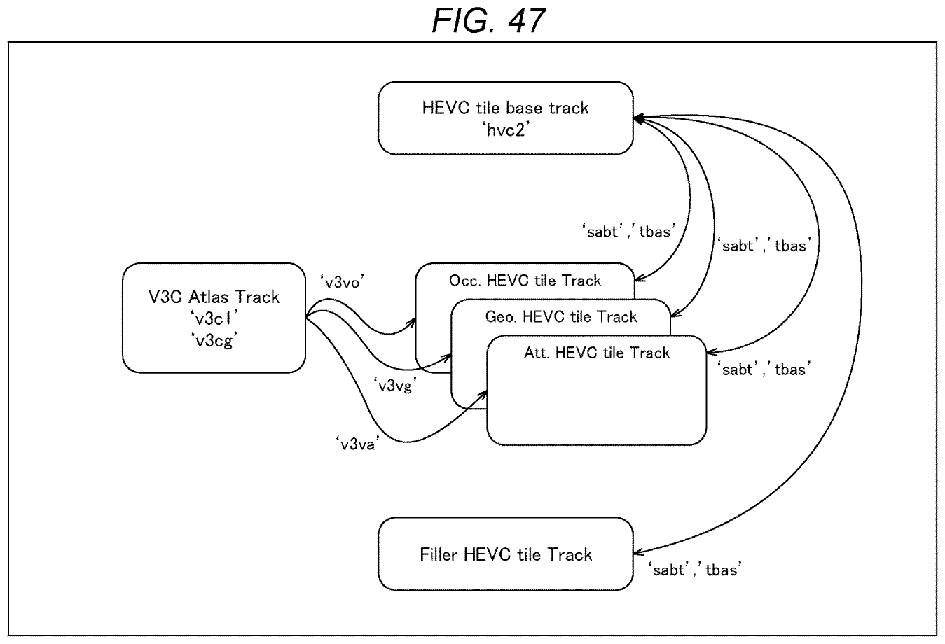

In a case where the 2D codec is HEVC, each piece of data is generated as follows. Also in the case of the HEVC, as in the case of VVC, each data (video components such as attribute (Att), geometry (Geo), and occupancy (OCC), and atlas information (atlas)) of the V-PCC as illustrated in FIG. 44 is generated, and the atlas track (V3C Atlas track) of FIG. 47 is generated from the bitstream of the atlas information. Furthermore, data of the video components before encoding is integrated (arranged side by side) to generate one picture. At this time, filler data (Fil) may be appropriately used so as to have a rectangular shape. Each video component (and filler data) is encoded to be a subpicture of the VVC, and a packed bitstream is generated. Merge information is generated from the packed bitstream, and a base track (HEVC tile base track) storing the merge information and a video component track (Occ. HEVC tile track, Geo. HEVC tile track, Att. HEVC tile track) storing a bitstream of each video component are generated (FIG. 47).

With such a configuration, it is possible to perform reconstruction as 3D data by using the atlas information (V3C Atlas track), and a packed bitstream is generated by merging the bitstreams of the video components using the merge information (HEVC tile base track), and can be decoded as one bitstream.

That is, since the number of bitstreams to be decoded can be reduced by merging, it is possible to suppress an increase in the number of decoder instances necessary for decoding video components constituting 3D data. That is, it is possible to suppress an increase in performance conditions required for decoding. In other words, decoding can be performed more easily. In other words, decoding can be performed at a lower cost (cheaper).

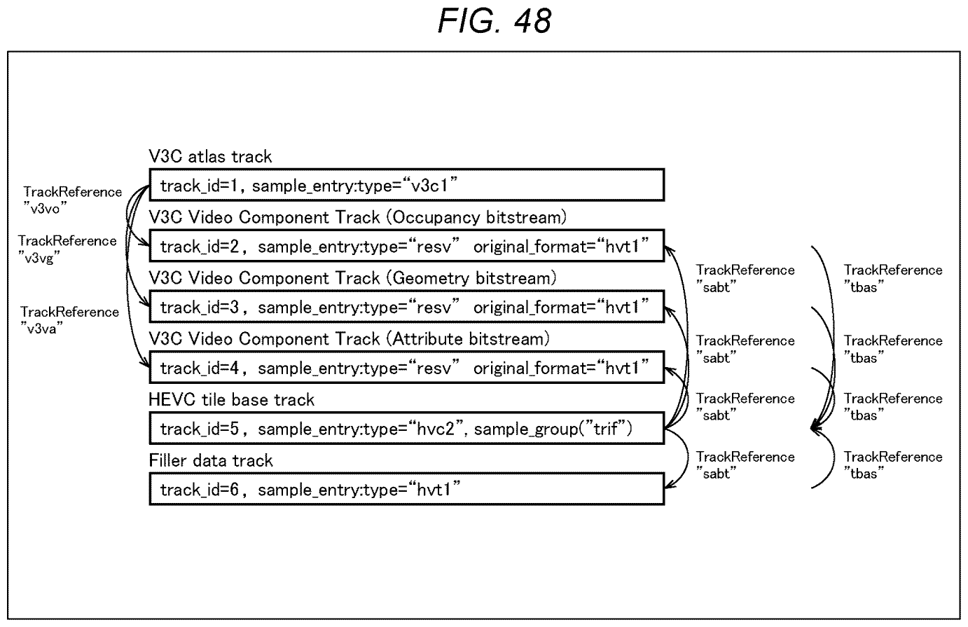

Similar to the case of the VVC, Method 1-1 may also be applied in the case of the HEVC. As illustrated in FIG. 47, in a case where the V-PCC bitstream is stored in a multi-track structure and the 2D codec is WVC, then the decoder obtains an atlas track (V3C atlas track). That is, the decoder acquires the track (V3C atlas track) of “sample_entry=‘v3c1’”. The decoder obtains a track (bitstream) of each component of the 3D data on the basis of the atlas track (V3C atlas track). At that time, the decoder acquires a track on the basis of a track reference (TrackReference) of the atlas track. As illustrated in FIG. 48, the atlas track (V3C atlas track) includes a track reference (“v3vo”) having an occupancy track (Occ. HEVC tile track) as a reference destination, a track reference (“v3vg”) having a geometry track (Geo. HEVC tile track) as a reference destination, and a track reference (“v3va”) having an attribute track (Att. HEVC tile track) as a reference destination. The decoder acquires a bitstream of each video component according to these track references.

Then, the decoder acquires merge information (HEVC tile base track) on the basis of the information of the file. In the case of the configuration as illustrated in FIG. 47, as illustrated in FIG. 48, the base track (HEVC tile base track) includes a track reference (“sabt”) having a track of each video component as a reference destination. Furthermore, the track of each video component has a track reference (“tbas”) with a base track (HEVC tile base track) as a reference destination. The decoder identifies and acquires, as a base track (HEVC tile base track), a track as a reference destination common to track references (‘tbas’) of tracks of all video components.

As described above, the merge information (HEVC tile base track) can be easily identified and acquired by using the information of the file.

### <File Generation Device>

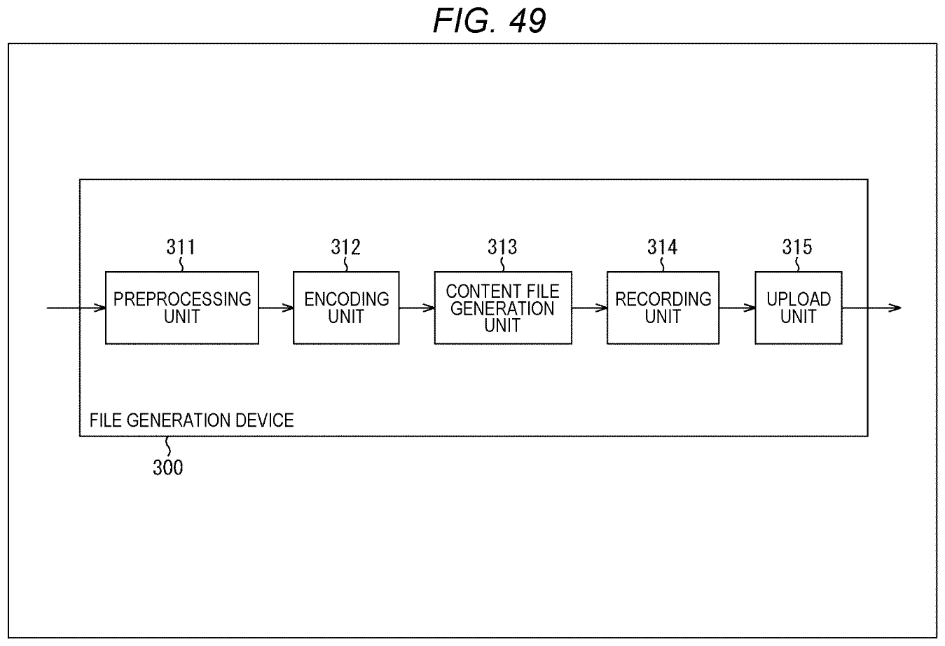

The present technology can be applied to any device. FIG. 49 is a block diagram illustrating an example of a configuration of a file generation device that is an aspect of the information processing device to which the present technology is applied. A file generation device 300 (second information processing device) illustrated in FIG. 49 is a device that applies the present technology to encode 3D data by an encoding method conforming to the V-PCC. For example, the file generation device 300 may apply Method 1 described above and encode 3D data having a plurality of video components. Furthermore, the file generation device 300 may apply Method 1 described above, generate a content file, store each bitstream of a plurality of video components in the content file, generate merge information for merging a plurality of bitstreams, and store the merge information in the content file.

Note that, in FIG. 49, main processing units, main data flows, and the like are illustrated, and those illustrated in FIG. 49 are not necessarily all. That is, in the file generation device 300, there may be a processing unit not illustrated as a block in FIG. 49, or there may be processing or a data flow not illustrated as an arrow and the like in FIG. 49.

As illustrated in FIG. 49, the file generation device 300 (second information processing device) includes a preprocessing unit 311, an encoding unit 312, a content file generation unit 313, a recording unit 314, and an upload unit 315.

The preprocessing unit 311 performs processing related to preprocessing on the 3D data supplied to the file generation device 300. For example, the preprocessing unit 311 may acquire the 3D data supplied to the file generation device 300. For example, the preprocessing unit 311 may acquire V-PCC data (geometry, attribute, occupancy map, atlas information, and the like) as the 3D data. The preprocessing unit 311 may acquire 3D data other than the V-PCC data and convert the 3D data into the V-PCC data as preprocessing. The preprocessing unit 311 may integrate video components of the V-PCC data to generate one picture (video data). The preprocessing unit 311 may supply the V-PCC data subjected to the preprocessing to the encoding unit 312.

The encoding unit 312 executes processing regarding coding. For example, the encoding unit 312 may acquire V-PCC data that has been subjected to preprocessing and is supplied from the preprocessing unit 311. The encoding unit 312 may encode the V-PCC data. For example, the encoding unit 312 may encode 3D data having a plurality of video components. For example, the encoding unit 312 may encode each video component (and filler data) to be a subpicture of WVC (or a tile of HEVC) to generate a packed bitstream. The encoding unit 312 may supply the bitstream generated in this way to the content file generation unit 313.

The content file generation unit 313 executes processing related to generation of a content file that stores content data such as 3D data. For example, the content file generation unit 313 may acquire the bitstream supplied from the encoding unit 312. The content file generation unit 313 may generate a content file and store the acquired bitstream in the content file. For example, the content file generation unit 313 may store each bitstream of a plurality of video components in the content file. Moreover, the content file generation unit 313 may store the atlas information in the content file. The content file generation unit 313 may generate merge information for merging the bitstreams of the plurality of video components and store the merge information in the content file. The content file generation unit 313 may store various types of data in different tracks of the content file by a multi-track structure. The content file generation unit 313 may supply the content file generated in this way to the recording unit 314.

The recording unit 314 includes any recording medium such as a hard disk or a semiconductor memory, for example, and performs a process related to data recording. For example, the recording unit 314 may record the content file and the like supplied from the content file generation unit 313 in the recording medium. Furthermore, the recording unit 314 may read a content file and the like recorded in the recording medium in accordance with a request from the upload unit 315 and the like, or at a predetermined timing, and supply the content file and the like to the upload unit 315.

The upload unit 315 executes processing related to upload. For example, the upload unit 315 may acquire a content file and the like supplied from the recording unit 314. The upload unit 315 may upload the content file and the like to the outside of the file generation device 300 (for example, a distribution server and the like).

### <Flow of File Generation Processing>

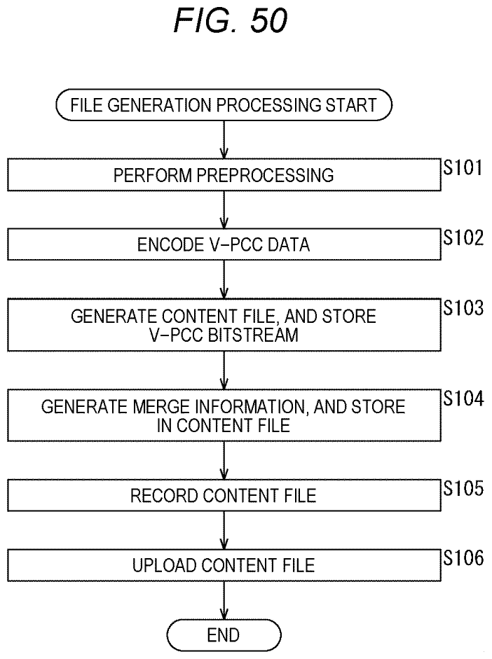

An example of a flow of file generation processing executed by the file generation device 300 to which the above Method 1 is applied will be described with reference to a flowchart of FIG. 50.

When the file generation processing is started, in step S101, the preprocessing unit 311 performs preprocessing on the V-PCC data.

In step S102, the encoding unit 312 encodes the V-PCC data (that is, 3D data having a plurality of video components) subjected to the preprocessing to generate a V-PCC bitstream.

In step S103, the content file generation unit 313 generates a content file and stores the V-PCC bitstream in the content file. For example, the content file generation unit 313 stores each bitstream and atlas information of a plurality of video components in (different tracks of) the content file.

In step S104, the content file generation unit 313 generates merge information for merging the plurality of bitstreams, and stores the merge information in the content file.

In step S105, the recording unit 314 records the content file. In step S106, the upload unit 315 uploads the content file. When the processing of step S106 ends, the file generation processing ends.

By doing so, the file generation device 300 can generate a content file capable of merging bitstreams of video components. Therefore, the file generation device 300 can suppress an increase in the number of decoder instances necessary for decoding the video components constituting the 3D data.

### <Reproduction Device>

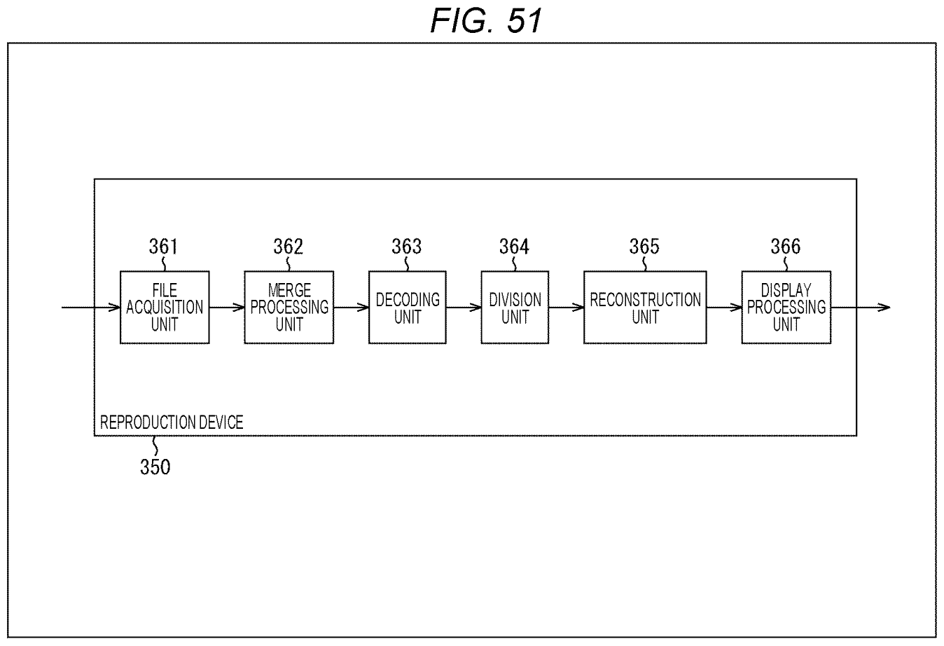

FIG. 51 is a block diagram illustrating an example of a configuration of a reproduction device that is an aspect of an information processing device to which the present technology is applied. A reproduction device 350 (first information processing device) illustrated in FIG. 51 is a device corresponding to the file generation device 300, and is a device that decodes a bitstream stored in a content file generated by the file generation device 300 and reproduces 3D data by applying the present technology. For example, the reproduction device 350 may apply Method 1 described above and acquire each bitstream of a plurality of video components of 3D data and merge information for merging the plurality of bitstreams. The reproduction device 350 may apply Method 1-1 described above and acquire the merge information on the basis of the information of the file. The reproduction device 350 may apply Method 1 described above and merge the plurality of bitstreams on the basis of the merge information. The reproduction device 350 may apply Method 1 described above, decode the merged bitstream, and generate decoded data. The reproduction device 350 may apply Method 1 described above and divide the decoded data into a plurality of video components on the basis of the merge information. The reproduction device 350 may apply Method 1 described above and reconstruct the 3D data using a plurality of video components obtained by the division.

Note that, in FIG. 51, main processing units, main data flows, and the like are illustrated, and those illustrated in FIG. 51 are not necessarily all. That is, in the reproduction device 350, there may be a processing unit not illustrated as a block in FIG. 51, or there may be processing or a data flow not illustrated as an arrow and the like in FIG. 51.

As illustrated in FIG. 51, the reproduction device 350 (first information processing device) includes a file acquisition unit 361, a merge processing unit 362, a decoding unit 363, a division unit 364, a reconstruction unit 365, and a display processing unit 366.

The file acquisition unit 361 performs processing regarding the acquisition of the content file and the like. For example, the file acquisition unit 361 may acquire data supplied from the outside of the reproduction device 350 (for example, a distribution server and the like). For example, the file acquisition unit 361 may acquire atlas information of 3D data, each bitstream of a plurality of video components, merge information for merging the plurality of bitstreams, and the like. That is, it can also be referred to as a 3D data acquisition unit. At that time, the file acquisition unit 361 may acquire the merge information on the basis of the information stored in the content file. The file acquisition unit 361 may supply the acquired data to the merge processing unit 362.

The merge processing unit 362 executes processing related to the merge of the bitstreams of the video components. For example, the merge processing unit 362 may acquire data (atlas information of 3D data, each bitstream of a plurality of video components, merge information, and the like) supplied from the file acquisition unit 361. The merge processing unit 362 may merge the bitstreams of the plurality of video components on the basis of the merge information. The merge processing unit 362 may supply the merged bitstream, merge information, atlas information, and the like to the decoding unit 363.

The decoding unit 363 executes processing related to decoding. For example, the decoding unit 363 may acquire data (merged bitstream, merge information, atlas information, and the like) supplied from the merge processing unit 362. The decoding unit 363 may decode a bitstream (encoded data) of the supplied data. For example, the decoding unit 363 may decode the merged bitstream to generate decoded data. The decoding unit 363 may supply the acquired data, the decoded data, and the like to the division unit 364.

The division unit 364 executes processing related to data division. For example, the division unit 364 may acquire data (including merge information, decoded data, and the like) supplied from the decoding unit 363. The division unit 364 may divide the decoded data into a plurality of video components on the basis of the merge information. The division unit 364 may supply the acquired data, the divided video component, and the like to the reconstruction unit 365.

The reconstruction unit 365 executes processing related to reconstruction of the 3D data. For example, the reconstruction unit 365 may acquire data (including atlas information of 3D data, a plurality of video components, and the like) supplied from the division unit 364. The reconstruction unit 365 may reconstruct the 3D data using a plurality of video components obtained by the division. The reconstruction unit 365 may supply the acquired data, the reconstructed 3D data, and the like to the display processing unit 366.

The display processing unit 366 executes processing related to display. For example, the display processing unit 366 may acquire data (including reconstructed 3D data and the like) supplied from the reconstruction unit 365. The display processing unit 366 may render the 3D data to generate a display image. The display processing unit 366 may display the display image on the display device.

### <Flow of Reproduction Processing>

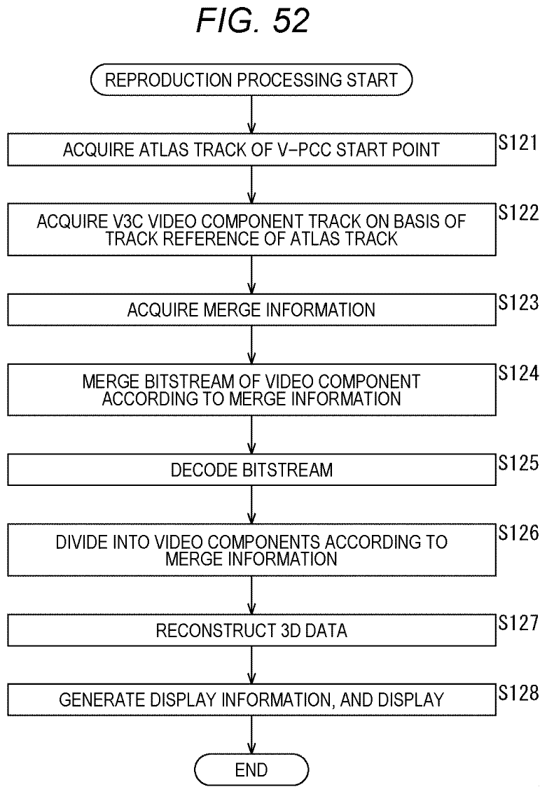

An example of a flow of reproduction processing executed by the reproduction device 350 to which the above-described Method 1 or Method 1-1 is applied will be described with reference to a flowchart of FIG. 52.

When the reproduction processing is started, in step S121, the file acquisition unit 361 acquires the atlas track of the start point of the V-PCC. For example, in a case where the 2D codec is WVC, the file acquisition unit 361 may acquire a track having sample_entry=‘v3c1’ as an atlas track (V3C atlas track).

In step S122, the file acquisition unit 361 acquires the V3C video component track on the basis of the track reference of the atlas track. That is, the file acquisition unit 361 acquires each bitstream of a plurality of video components of the 3D data. For example, the file acquisition unit 361 may acquire track_id referred to by “v3vo”, “v3vg”, and “v3va” from a track reference of an atlas track (V3C atlas track) (for example, track_id=2, 3, and 4).

In step S123, the file acquisition unit 361 acquires merge information for merging the plurality of bitstreams. At that time, the file acquisition unit 361 may acquire the merge information on the basis of information stored in a file that stores the merge information. For example, in a case where the 2D codec is VVC, the file acquisition unit 361 may acquire a track having sample_entry=‘vvc1’ and ‘subp’ in tref as a base track (VVC merge base track). For example, in a case where the 2D codec is HEVC, the file acquisition unit 361 may acquire a track referred to as “tbas” from a track reference of the V3C video component track as a base track (HEVC tile base track).

In step S124, the merge processing unit 362 merges the bitstreams of the plurality of video components on the basis of the merge information.

In step S125, the decoding unit 363 decodes the merged bitstream, and generates the decoded data. In step S126, the division unit 364 divides the decoded data into a plurality of video components on the basis of the merge information.

In step S127, the reconstruction unit 365 reconstructs the 3D data using the plurality of video components obtained by the division.

In step S128, the display processing unit 366 performs rendering using the reconstructed 3D data, generates display information, and displays the display information on the display device.

By doing so, the reproduction device 350 can merge and decode the bitstream of the video component. Therefore, the reproduction device 350 can suppress an increase in the number of decoder instances necessary for decoding the video components constituting the 3D data.

### Method 1-1-1

In a case where Method 1-1 is applied, merge information to be used may be selected as shown in the third row from the top of the table in FIG. 39 (Method 1-1-1).

For example, in the reproduction device 350, the file acquisition unit 361 may identify merge information to be used for merging a plurality of bitstreams from a plurality of pieces of merge information.

### <Flow of Reproduction Processing>

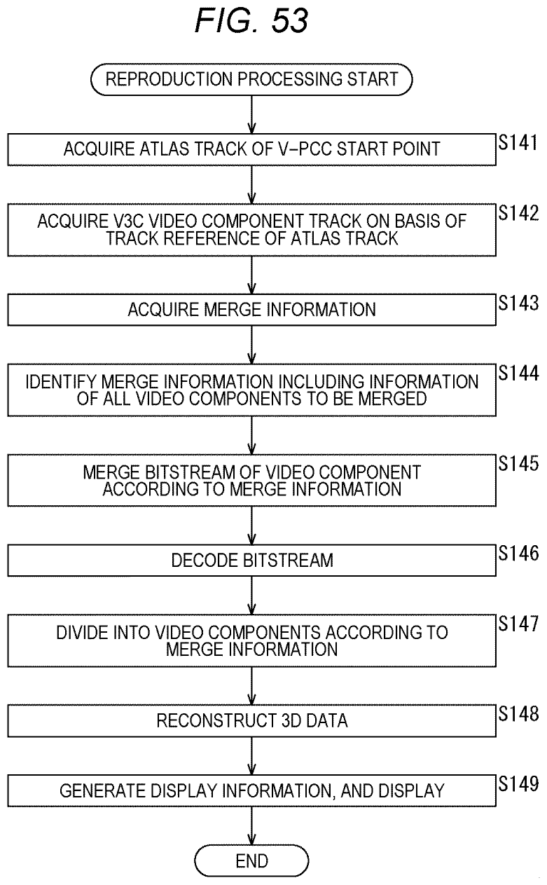

An example of a flow of reproduction processing executed by the reproduction device 350 to which Method 1-1-1 is applied will be described with reference to a flowchart of FIG. 53.

When the reproduction processing is started, the processing from step S141 to step S143 is performed similarly to the processing from step S121 to step S123 (FIG. 52).

In step S144, the file acquisition unit 361 identifies merge information including information of all video components to be merged. At that time, the file acquisition unit 361 may identify the merge information on the basis of information stored in a file that stores the merge information. For example, in a case where VVC is applied to a 2D codec, the file acquisition unit 361 may identify a base track (VVC merge base track) including all identifiers (track_id) of tracks for storing video components of 3D data in a track reference (‘subp’) among the acquired tracks as the base track to be applied to merging. Furthermore, in a case where HEVC is applied to the 2D codec, the file acquisition unit 361 may identify a base track (HEVC tile base track) of a common reference destination in track references (‘tbas’) of all video component tracks referred to from the atlas track as the base track to be applied to merging.

Note that, in a case where HEVC is applied to the 2D codec, the file acquisition unit 361 may acquire the base track (HEVC tile base track) of the common reference destination in the track references (‘tbas’) of all the video component tracks referred to from the atlas track in step S143. In that case, the processing of step S144 may be omitted.

In step S145, the merge processing unit 362 merges the bitstream of the video component according to the identified merge information.

The processing from step S146 to step S149 are performed similarly to the processing from step S125 to step S128 (FIG. 52). When the processing in step S149 ends, the reproduction processing ends.

By doing so, even in a case where there is a plurality of pieces of merge information, the reproduction device 350 can select appropriate merge information and apply the merge information to the merge processing of the bitstream of the video component.

### Method 1-1-2

In a case where Method 1-1 is applied, access information to merge information may be stored in the atlas track as shown in the fourth row from the top of the table of FIG. 39 (Method 1-1-2).

For example, in the file generation device 300, the content file generation unit 313 may add reference information designating merge information as a reference destination to atlas information for reconstructing the 3D data in the content file.

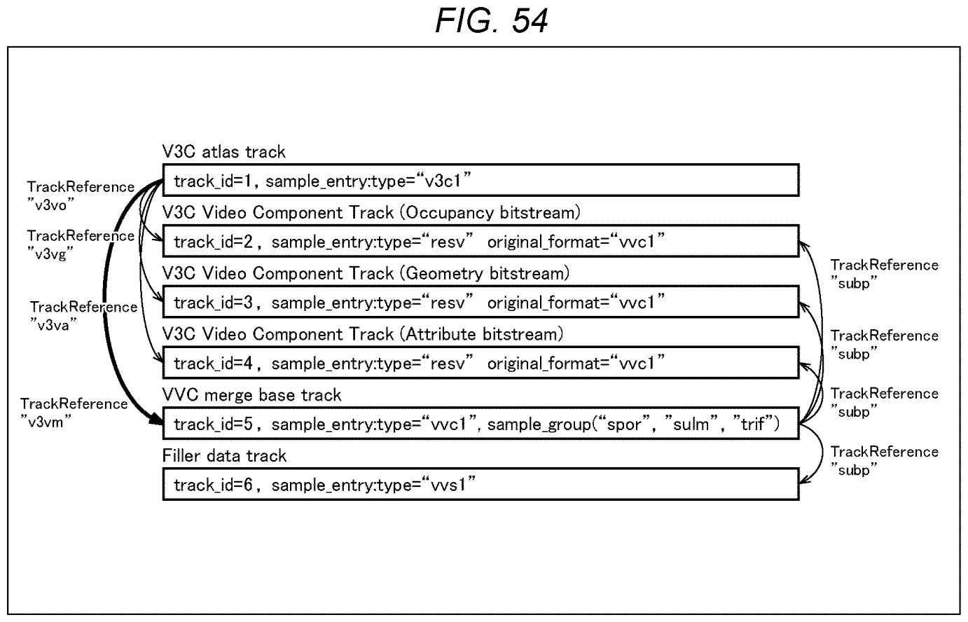

For example, in step S104 of the file generation processing of FIG. 50, the content file generation unit 313 may further add reference information designating merge information as a reference destination in the content file to atlas information for reconstructing the 3D data. For example, in a case where the 2D codec is VVC, the content file generation unit 313 may store a track reference (“v3vm”) whose reference destination is the base track (VVC merge base track) in an atlas track (V3C atlas track) as illustrated in FIG. 54. Similarly in a case where the 2D codec is HEVC, the content file generation unit 313 may store a track reference (“v3vm”) whose reference destination is the base track (HEVC tile base track) in the atlas track (V3C atlas track).

On the other hand, in the reproduction device 350, for example, the file acquisition unit 361 may acquire merge information designated as a reference destination in reference information added to atlas information for reconstructing 3D data.

### <Flow of Reproduction Processing>

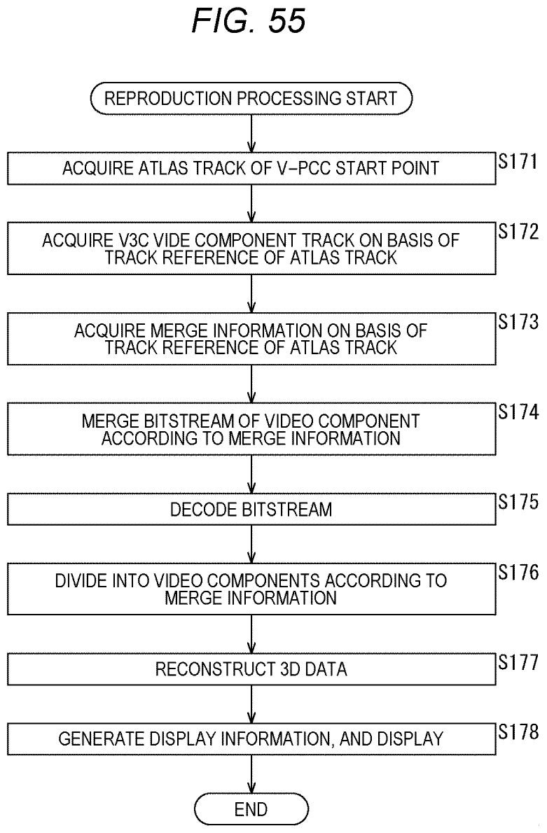

An example of a flow of reproduction processing in a case where the above-described Method 1-1-2 is applied will be described with reference to a flowchart of FIG. 55.

When the reproduction processing is started, each processing of steps S171 and S172 is executed similarly to each processing (FIG. 52) of steps S121 and S122.

In step S173, the file acquisition unit 361 acquires the base track (VVC merge base track or HEVC tile base track) on the basis of the track reference (“v3vm”) of the atlas track (V3C atlas track). That is, the file acquisition unit 361 acquires merge information designated as a reference destination by the track reference.

The processing from step S174 to step S178 is performed similarly to the processing from step S124 to step S128 (FIG. 52). When the processing in step S149 ends, the reproduction processing ends.

By doing so, even in a case where there is a plurality of pieces of merge information, the reproduction device 350 can easily acquire appropriate merge information and apply the merge information to the merge processing of the bitstream of the video component. That is, since the processing of identifying (selecting) the merge information becomes unnecessary, an increase in the load of the reproduction processing can be suppressed.

### Method 1-1-3

In a case where Method 1-1 is applied, “information indicating that the base track is not the reproduction start point track” may be added as shown in the fifth row from the top of the table in FIG. 39 (Method 1-1-3).

For example, in the file generation device 300, the content file generation unit 313 may add “information indicating that the base track is not the reproduction start point” to the merge information in the content file.

For example, in step S104 of the file generation processing in FIG. 50, the content file generation unit 313 may further add “information indicating that the base track is not the reproduction start point” to the merge information in the content file.

For example, in a case where the 2D codec is VVC, the content file generation unit 313 may set track in movie in flags of a track header box (TrackHeaderBox) of the base track (VVC merge base track) to “0”. By setting track in movie to “0”, it is indicated that the base track (VVC merge base track) is not the reproduction start point track. The reproduction device that interprets track in movie does not reproduce from the base track on the basis of this information (that is, reproduction starting from the base track (VVC merge base track) is prohibited).

Similarly in a case where the 2D codec is HEVC, the content file generation unit 313 may set track in movie in flags of a track header box (TrackHeaderBox) of the base track (HEVC tile base track) to “0”. By setting track in movie to “0”, it is indicated that the base track (HEVC tile base track) is not the reproduction start point track. The reproduction device that interprets track in movie does not reproduce from the base track on the basis of this information (that is, reproduction starting from the base track (HEVC tile base track) is prohibited).

As a result, “information indicating that the base track is not the reproduction start point” is added to the merge information acquired by the reproduction device 350. The decoding unit 363 of the reproduction device 350 may prohibit the reproduction based on the merge information on the basis of the information.

By doing so, it is possible to prevent the reproduction device 350 from executing reproduction with the base track as a start point and reproducing a video not assumed by the content author, such as displaying a merged picture. That is, the reproduction device 350 can perform correct reproduction more reliably.

### Method 1-1-4

In a case where Method 1-1 is applied, the base track may be a restricted track (restricted video track) as shown in the sixth row from the top of the table of FIG. 39 (Method 1-1-4).

For example, in the file generation device 300, the content file generation unit 313 may set the track for storing the merge information in the content file to the restricted video track.

For example, in step S104 of the file generation processing of FIG. 50, the content file generation unit 313 may set the track for storing the merge information to the restricted video track.

For example, in a case where the 2D codec is VVC, the content file generation unit 313 may deform the base track (VVC merge base track) using restricted sample entry transformation. Moreover, the content file generation unit 313 may set ‘v3 cm’ as the scheme type (SchemeType) to indicate a track for merging the video component of the V-PCC into one bitstream.

Similarly, in a case where the 2D codec is HEVC, the content file generation unit 313 may deform the base track (HEVC tile base track) using restricted sample entry transformation. Moreover, the content file generation unit 313 may set ‘v3 cm’ as the scheme type (SchemeType) to indicate a track for merging the video component of the V-PCC into one bitstream.

Therefore, the track storing the merge information is set to the restricted video track. The decoding unit 363 of the reproduction device 350 may prohibit the reproduction based on the merge information on the basis of the restriction.

By doing so, it is possible to prevent the reproduction device 350 from executing reproduction with the base track as a start point and reproducing a video not assumed by the content author, such as displaying a merged picture. That is, the reproduction device 350 can perform correct reproduction more reliably.

### Method 1-2

In a case where Method 1 is applied, merge information may be acquired on the basis of MPD information as shown in the seventh row from the top of the table in FIG. 39 (Method 1-2).

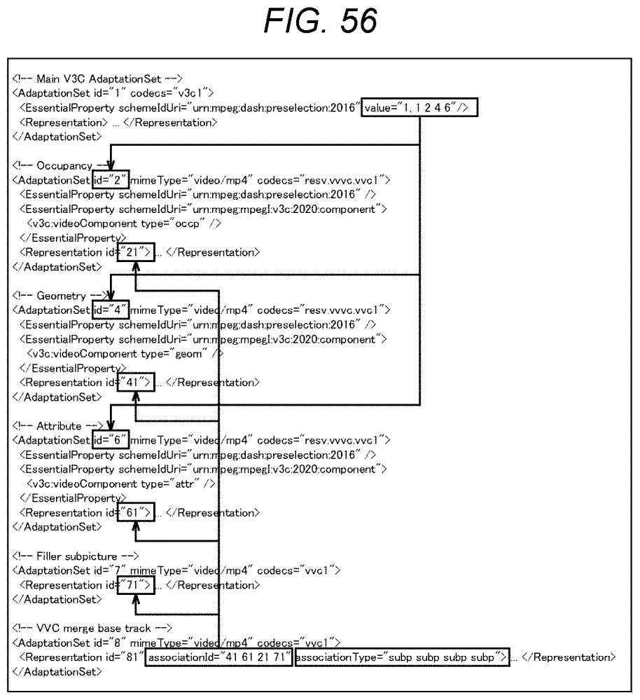

FIG. 56 illustrates a description example of the MPD in a case where the 2D codec is VVC. For the V-PCC data having the configuration as in the examples of FIGS. 45 and 46, the MPD can be described as in the example of FIG. 56. For example, in this MPD, @codec=“v3c1” is set in an adaptation set (AdaptationSet id=1) of the atlas track (V3C Atlas track). Furthermore, a track reference (value=“1, 1 2 4 6”) having an adaptation set of each video component as a reference destination is set in the preselection. This value indicates an identifier (AdaptationSet id) of the adaptation set of the reference destination. Furthermore, in the representation (Representation) of the base track (VVC merge base track), each video component (V3C Video component) and the identifier (Representation@id) of the representation of the filler data are set as @associationId (associationId=“41 61 21 71”). Furthermore, ‘subp’, which is the value of the track reference of MP4, is set as @associationType (associationType=“subp subp subp subp”).

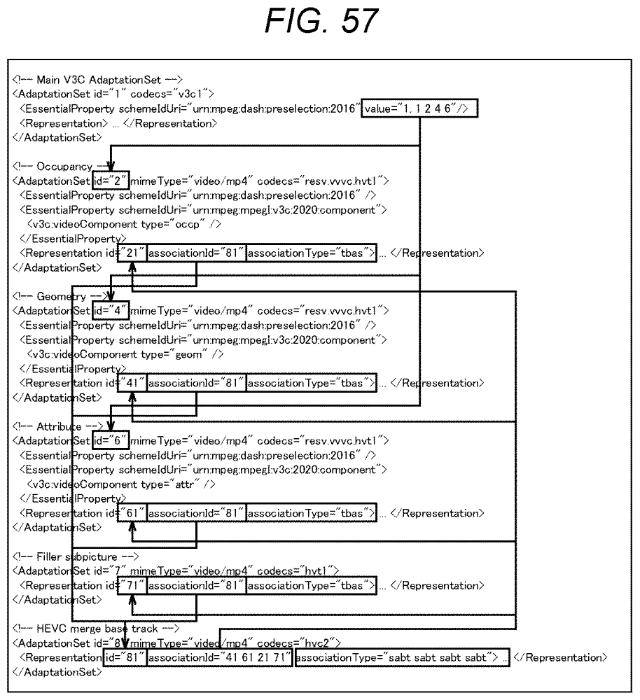

FIG. 57 illustrates a description example of the MPD in a case where the 2D codec is HEVC. For the V-PCC data having the configuration as in the examples of FIGS. 47 and 48, the MPD can be described as in the example of FIG. 57. For example, in this MPD, @codec=“v3c1” is set in an adaptation set (AdaptationSet id=1) of the atlas track (V3C Atlas track). Furthermore, a track reference (value=“1, 1 2 4 6”) having an adaptation set of each video component as a reference destination is set in the preselection. This value indicates an identifier (AdaptationSet id) of the adaptation set of the reference destination. Furthermore, in the representation of the base track (HEVC tile base track), each video component (V3C Video component) and the identifier (Representation@id) of the representation of the filler data are set as @associationId (associationId=“41 61 21 71”). Furthermore, ‘sabt’, which is the value of the track reference of MP4, is set as @associationType (associationType=“sabt sabt sabt sabt”). Furthermore, in the representations of the video components (V3C Video component) and the filler data, an identifier (Representation@id) of the representation of the base track (HEVC tile base track) is set as @associationId (associationId=“81”). Furthermore, ‘tbas’, which is the value of the track reference of MP4, is set as @associationType (associationType=“tbas”).

The file generation device may generate such an MPD, and the reproduction device may acquire merge information on the basis of the information of the MPD.

### <File Generation Device>

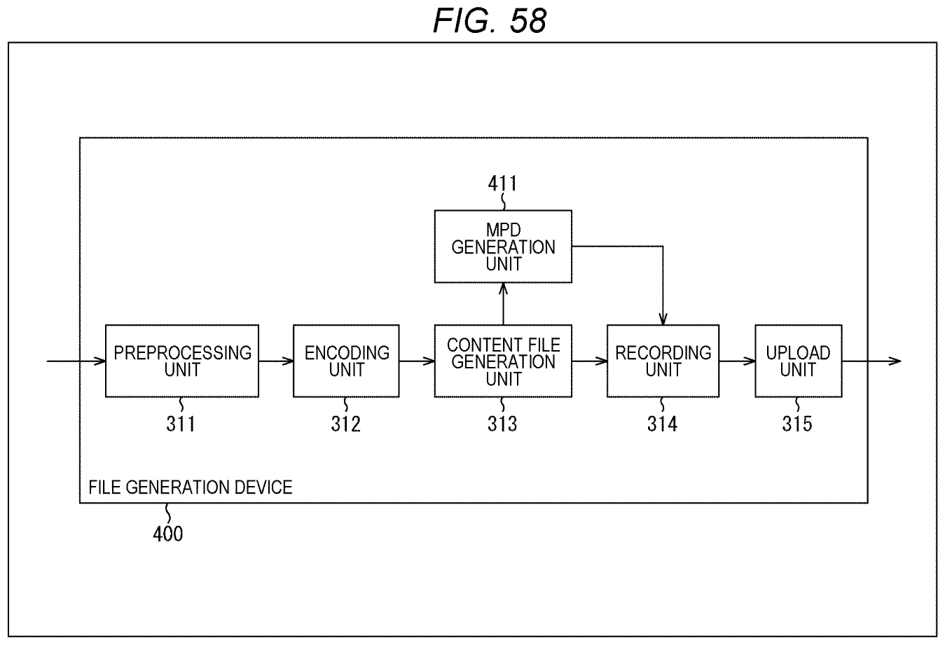

FIG. 58 illustrates a main configuration example of a file generation device to which the above-described Method 1-2 is applied. Similarly to the file generation device 300 (FIG. 49), a file generation device 400 illustrated in FIG. 58 is a device that encodes 3D data with an encoding method conforming to the V-PCC by applying the present technology. However, the file generation device 400 generates an MPD (control file) that controls the distribution of the content file.

Note that, in FIG. 58, main processing units, main data flows, and the like are illustrated, and those illustrated in FIG. 58 are not necessarily all. That is, in the file generation device 400, there may be a processing unit not illustrated as a block in FIG. 58, or there may be processing or a data flow not illustrated as an arrow and the like in FIG. 58.

As illustrated in FIG. 58, the file generation device 400 (second information processing device) further includes an MPD generation unit 411 in addition to the configuration of the file generation device 300. The content file generation unit 313 may further supply the content file and the like to the MPD generation unit 411.

The MPD generation unit 411 executes processing related to generation of an MPD (control file). For example, the MPD generation unit 411 may acquire the content file and the like supplied from the content file generation unit 313. Furthermore, the MPD generation unit 411 may generate an MPD corresponding to the content file. The MPD is a control file that controls distribution of 3D data. That is, the MPD generation unit 411 can also be referred to as a control file generation unit. The MPD generation unit 411 supplies the generated MPD to the recording unit 314.

The recording unit 314 may further record the MPD and the like supplied from the MPD generation unit 411 on the recording medium. Furthermore, the recording unit 314 may read a content file and the like recorded in the recording medium in accordance with a request from the upload unit 315 and the like, or at a predetermined timing, and supply the MPD and the like to the upload unit 315. The upload unit 315 may further acquire the MPD and the like supplied from the recording unit 314. The upload unit 315 may upload the MPD and the like to the outside of the file generation device 300 (for example, a distribution server and the like).

### <Flow of File Generation Processing>

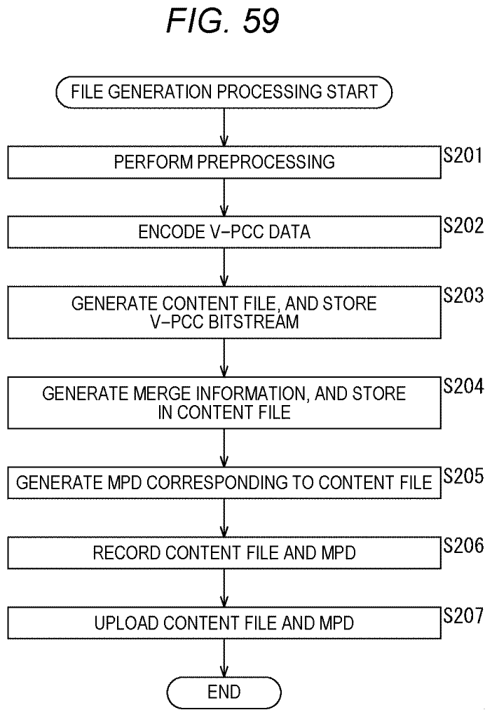

An example of a flow of file generation processing executed by the file generation device 400 to which the above Method 1-2 is applied will be described with reference to a flowchart of FIG. 59.

When the file generation processing is started, the processing from step S201 to step S204 is performed similarly to the processing from step S101 to step S104 (FIG. 50). In step S205, the MPD generation unit 411 generates the MPD corresponding to the content file. At that time, the MPD generation unit 411 may describe the information of the track reference in the MPD. For example, the MPD generation unit 411 may generate an MPD having a description as in the example of FIG. 56 or 57 described above.

In step S206, the recording unit 314 records the content file and the MPD. In step S207, the upload unit 315 uploads the content file and the MPD. When the processing of step S207 ends, the file generation processing ends.

By doing so, the file generation device 400 can generate a content file capable of merging bitstreams of video components. Therefore, the file generation device 400 can suppress an increase in the number of decoder instances necessary for decoding the video components constituting the 3D data.

### <Reproduction Device>

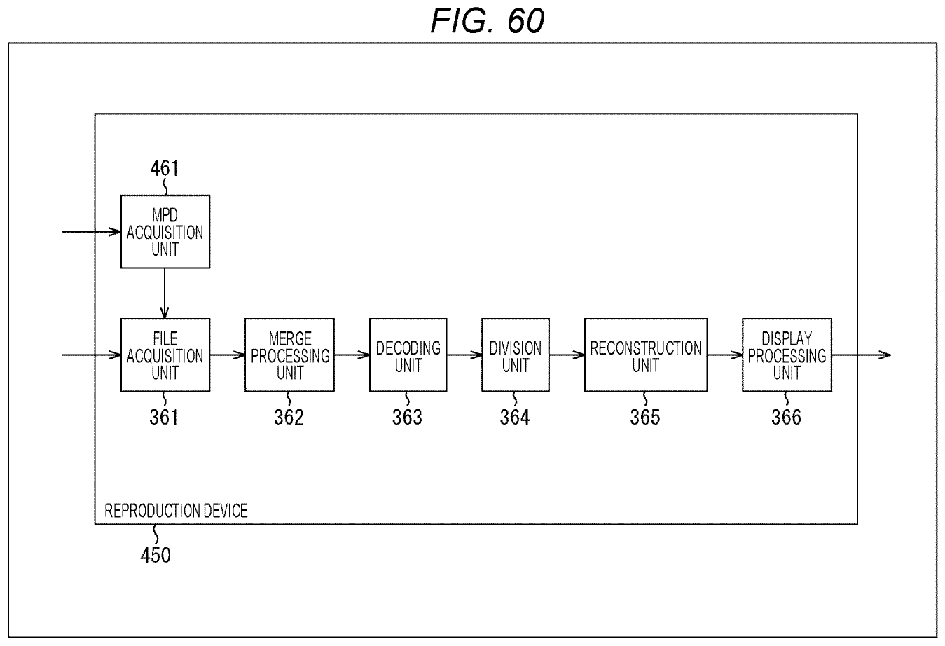

FIG. 60 illustrates a main configuration example of a reproduction device to which the above-described Method 1-2 is applied. A reproduction device 450 illustrated in FIG. 60 is a device corresponding to the file generation device 400, and is a device that decodes a bitstream stored in a content file generated by the file generation device 400 and reproduces 3D data by applying the present technology, similarly to the reproduction device 350 (FIG. 51). However, the reproduction device 450 acquires the MPD generated by the file generation device 400, and acquires the content file on the basis of the MPD.

Note that, in FIG. 60, main processing units, main data flows, and the like are illustrated, and those illustrated in FIG. 60 are not necessarily all. That is, in the reproduction device 450, there may be a processing unit not illustrated as a block in FIG. 60, or there may be processing or a data flow not illustrated as an arrow and the like in FIG. 60.

As illustrated in FIG. 60, the reproduction device 450 (first information processing device) further includes an MPD acquisition unit 461 in addition to the configuration of the reproduction device 350.

The MPD acquisition unit 461 executes processing related to acquisition of the MPD. For example, the MPD acquisition unit 461 may acquire the MPD. The MPD is a control file that controls distribution of 3D data. That is, the MPD acquisition unit 461 can also be referred to as a control file acquisition unit. The MPD acquisition unit 461 may supply the acquired MPD to the file acquisition unit 361.

The file acquisition unit 361 basically executes processing similar to the case of the reproduction device 350. However, the file acquisition unit 361 may acquire the MPD supplied from the MPD acquisition unit 461. Furthermore, the file acquisition unit 361 may acquire merge information on the basis of information stored in the MPD.

### <Flow of Reproduction Processing>

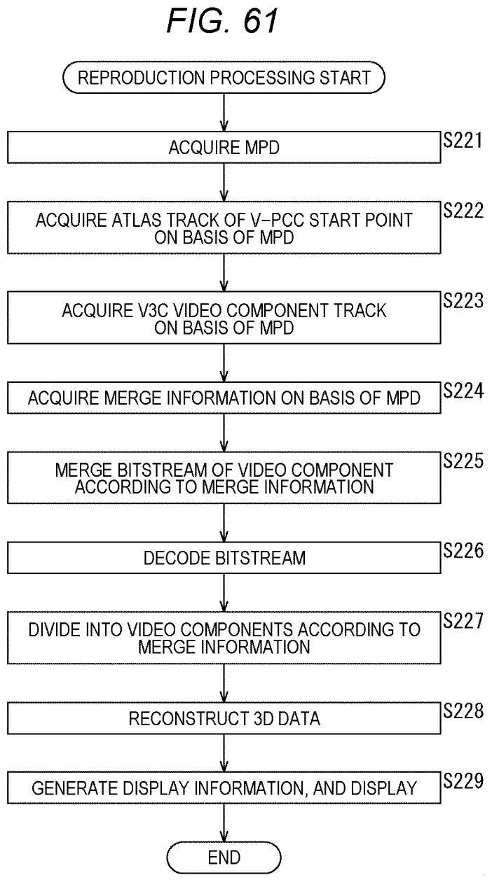

An example of a flow of reproduction processing executed by the reproduction device 450 to which the above-described Method 1-2 is applied will be described with reference to a flowchart of FIG. 61.

When the reproduction processing is started, in step S221, the MPD acquisition unit 461 acquires an MPD. For example, the MPD acquisition unit 461 may acquire an MPD having the description as in the example of FIG. 56 or 57 described above.

In step S222, the file acquisition unit 361 acquires the atlas track of the start point of the V-PCC on the basis of the MPD. For example, the file acquisition unit 361 may acquire a bitstream corresponding to an adaptation set (AdaptationSet id=1) of @codec=“v3c1”.

In step S223, the file acquisition unit 361 acquires the V3C video component track on the basis of the track reference of the atlas track. That is, the file acquisition unit 361 acquires each bitstream of a plurality of video components of the 3D data. For example, the file acquisition unit 361 may acquire the adaptation set (AdaptationSet id=2, 4, 6) being referred to from the preselection of the adaptation set (AdaptationSet id=1) of the atlas track, and acquire the identifier (Representation id=21, 41, 61) of the representation in the adaptation set.

In step S224, the file acquisition unit 361 acquires merge information for merging the plurality of bitstreams. At that time, the file acquisition unit 361 may acquire the merge information on the basis of the MPD. For example, in a case where the 2D codec is VVC, the file acquisition unit 361 may acquire a track corresponding to a representation including subp in @codec=‘vvc1’ and @association Type as a base track (VVC merge base track) (Representation id=81). Furthermore, in a case where the 2D codec is HEVC, the file acquisition unit 361 may acquire a track corresponding to a representation in which @associationId corresponding to @association Type (‘tbas’) of all tracks is a common value as a base track (HEVC tile base track) (Representation id=81).

The processing from step S225 to step S229 is performed similarly to the processing from step S124 to step S128 (FIG. 52). When the processing in step S229 ends, the reproduction processing ends.

By doing so, the reproduction device 450 can merge and decode the bitstream of the video component. Therefore, the reproduction device 450 can suppress an increase in the number of decoder instances necessary for decoding the video components constituting the 3D data.

### Method 1-2-1

In a case where Method 1-2 is applied, merge information to be used may be selected as shown in the eighth row from the top of the table in FIG. 39 (Method 1-2-1).

For example, in the reproduction device 450, the file acquisition unit 361 may identify merge information to be used for merging a plurality of bitstreams from a plurality of pieces of merge information.

### <Flow of Reproduction Processing>

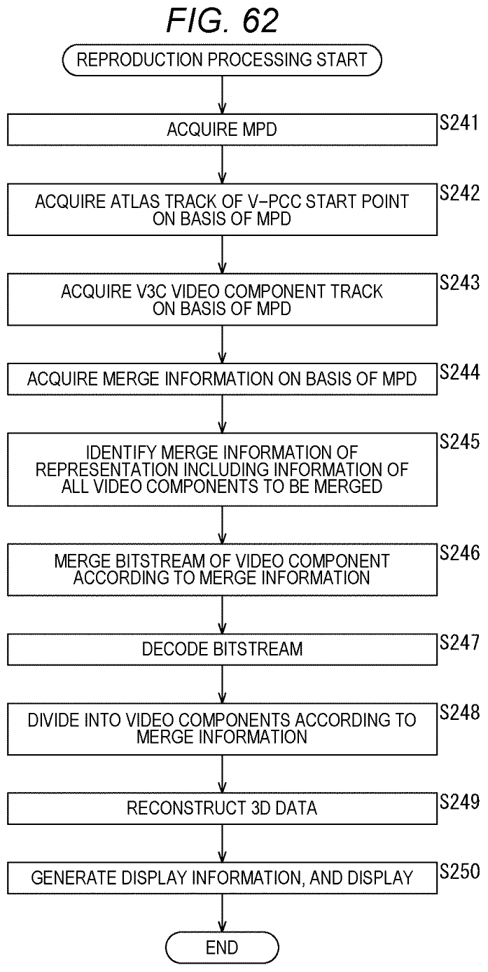

An example of a flow of reproduction processing executed by the reproduction device 450 to which Method 1-2-1 is applied will be described with reference to a flowchart of FIG. 62.

When the reproduction processing is started, the processing from step S241 to step S244 is performed similarly to the processing from step S221 to step S224 (FIG. 61).

In step S245, the file acquisition unit 361 identifies merge information of a representation including information of all video components to be merged. At that time, the file acquisition unit 361 may identify the merge information on the basis of the MPD. For example, in a case where VVC is applied to a 2D codec, the file acquisition unit 361 may identify a track of a representation including all Representation ids of video components of 3D data in @associationId among the acquired tracks as a base track (VVC merge base track) (Representation id=81). Furthermore, in a case where the 2D codec is HEVC, the file acquisition unit 361 may identify a track corresponding to a representation in which @associationId corresponding to @association Type (‘tbas’) of all video component tracks referred to from the atlas track corresponds to a common representation, as a base track (HEVC tile base track) (Representation id=81).

Note that, in a case where HEVC is applied to the 2D codec, in step S244, the file acquisition unit 361 may acquire a track in which @associationId corresponding to @association Type (‘tbas’) of all video component tracks referred to from the atlas track corresponds to a common representation, as the base track (HEVC tile base track). In that case, the processing of step S245 may be omitted.

The processing from step S246 to step S250 are performed similarly to the processing from step S225 to step S229 (FIG. 61). When the processing in step S250 ends, the reproduction processing ends.

By doing so, even in a case where there is a plurality of pieces of merge information, the reproduction device 450 can select appropriate merge information and apply the merge information to the merge processing of the bitstream of the video component.

### Method 1-2-2

In a case where Method 1-2 is applied, access information to merge information may be stored in the adaptation set of the atlas track as shown in the ninth row from the top of the table in FIG. 39 (Method 1-2-2). Here, the access information is reference information (information designating the adaptation set (or representation) of the reference destination) between the adaptation sets (or representations). That is, the reference information from the adaptation set of the atlas track to the adaptation set of the base track may be stored in the MPD.

For example, in the file generation device 400, the MPD generation unit 411 may add reference information designating merge information as a reference destination to the adaptation set of atlas information for reconstructing the 3D data in the MPD (control file).

For example, in step S205 of the file generation processing of FIG. 59, the MPD generation unit 411 may generate an MPD, and add reference information designating merge information as a reference destination to the adaptation set of atlas information for reconstructing the 3D data in the MPD.

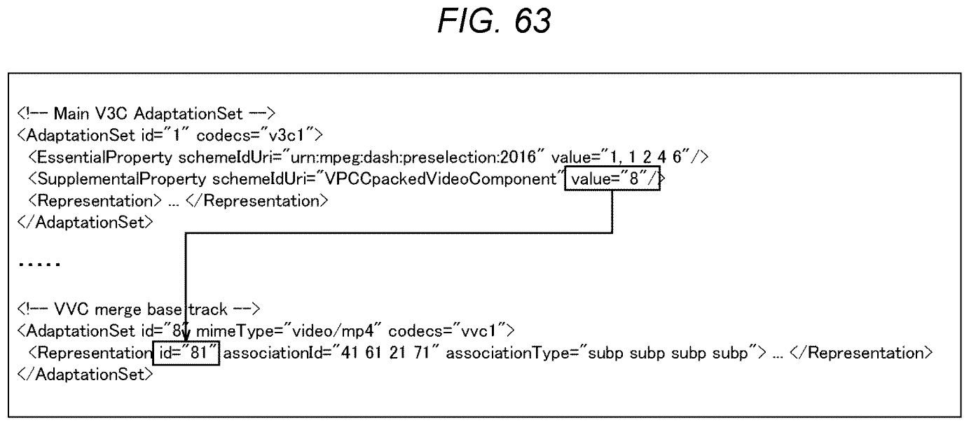

For example, in a case where the 2D codec is VVC, the content file generation unit 313 may add, to the adaptation set of the atlas track (V3C atlas track), a supplemental property (SupplementalProperty) indicating an identifier (AdaptationSet id) of the adaptation set of the track to be merged into Value with schemeIdUri being “VPCCpackedVideoComponent”. This supplemental property is access information to an adaptation set (AdaptationSet) of a track serving as a start point for merging video components and decoding them in one bitstream. FIG. 63 illustrates access information from the adaptation set of the atlas track to the adaptation set of the base track (VVC merge base track) in the case of VVC.

Note that, in a case where the 2D codec is HEVC, the VVC merge base track described above may be replaced with HEVC tile base track.

On the other hand, in the reproduction device 450, the file acquisition unit 361 may acquire merge information designated as a reference destination in the reference information added to the adaptation set of the atlas information for reconstructing the 3D data of the MPD (control file).

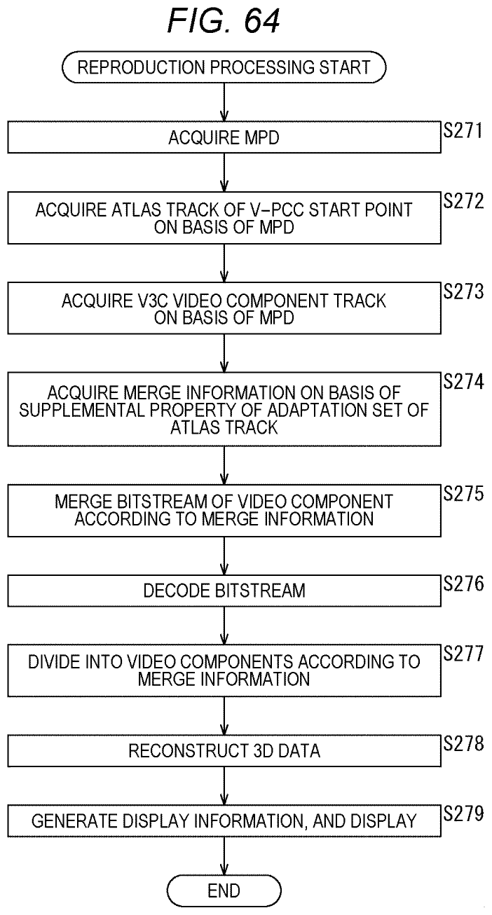

An example of a flow of reproduction processing executed by the reproduction device 450 to which Method 1-2-2 is applied will be described with reference to a flowchart of FIG. 64.

When the reproduction processing is started, the processing from step S271 to step S273 is performed similarly to the processing from step S221 to step S223 (FIG. 61).

In step S274, the file acquisition unit 361 acquires merge information on the basis of the supplemental property of the adaptation set of the atlas track. In the supplemental property illustrated in FIG. 63, for example, schemeIdUri is “VPCCpackedVideoComponent”, and an identifier (AdaptationSet id) of the adaptation set of the base track as a reference destination is indicated in Value thereof (value=“8”). That is, the access information from the adaptation set of the atlas track to the adaptation set of the base track (VVC merge base track) is indicated. The file acquisition unit 361 may acquire (merge information of) the base track on the basis of such access information. Note that, in the case of HEVC, VVC merge base track AdaptationSet may be replaced with HEVC tile base track AdaptationSet.

The processing from step S275 to step S279 are performed similarly to the processing from step S225 to step S229 (FIG. 61).

By doing so, even in a case where there is a plurality of pieces of merge information, the reproduction device 450 can easily acquire appropriate merge information and apply the merge information to the merge processing of the bitstream of the video component. That is, since the processing of identifying (selecting) the merge information becomes unnecessary, an increase in the load of the reproduction processing can be suppressed.

### Method 1-2-3

In a case where Method 1-2 is applied, “information indicating that the base track is not the reproduction start point track” may be added as shown in the tenth row from the top of the table in FIG. 39 (Method 1-2-3).

For example, in the file generation device 400, the MPD generation unit 411 may add such “information indicating that the base track is not the reproduction start point” to the adaptation set of the merge information of the MPD (control file). For example, in step S205 of the file generation processing of FIG. 59, the MPD generation unit 411 may generate an MPD and add “information indicating that the base track is not the reproduction start point” to the adaptation set of the merge information in the MPD.

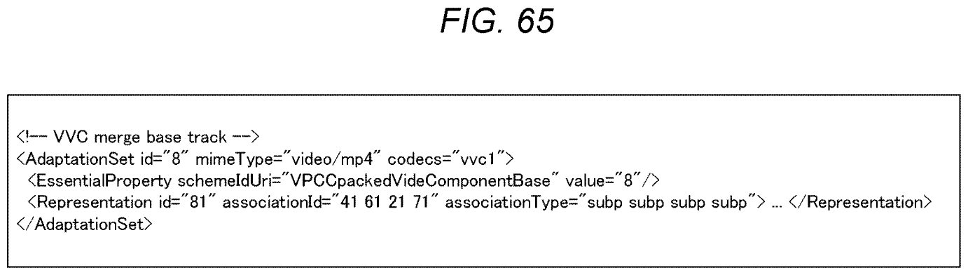

The “information indicating that the base track is not the reproduction start point” may be any information. For example, schemeIdUri may be an essential property (EssentialProperty) of “VPCCpackedVideoComponentBase”. For example, in a case where the 2D codec is WVC, the MPD generation unit 411 may store this essential property in the adaptation set of the base track (VVC merge base track) as illustrated in FIG. 65. Note that, in a case where the 2D codec is HEVC, the MPD generation unit 411 may store the essential property as described above in the adaptation set of the base track (HEVC tile base track).

Therefore, “information indicating that the base track is not the reproduction start point” is added to the adaptation set of the merge information of the MPD (control file). The decoding unit 363 of the reproduction device 450 may prohibit the reproduction based on the merge information on the basis of the information. For example, in the above-described reproduction processing, the decoding unit 363 may prohibit the reproduction based on the merge information on the basis of the “information indicating that the base track is not the reproduction start point” added to the adaptation set of the merge information.

By doing so, it is possible to prevent the reproduction device 450 from executing reproduction with the base track as a start point and reproducing a video not assumed by the content author, such as displaying a merged picture. That is, the reproduction device 450 can perform correct reproduction more reliably.

### Method 1-2-4

In a case where Method 1-2 is applied, the base track may be a restricted video track as shown in the eleventh row from the top of the table of FIG. 39 (Method 1-2-4).

For example, in the file generation device 400, the MPD generation unit 411 may set the track storing the merge information to the restricted video track in the MPD. For example, in step S205 of the file generation processing of FIG. 59, the MPD generation unit 411 may generate an MPD and set a track for storing merge information in the MPD as a restricted video track.

For example, in a case where the 2D codec is VVC, the MPD generation unit 411 may deform the base track (VVC merge base track) using restricted sample entry transformation. Moreover, the MPD generation unit 411 may set ‘v3 cm’ in SchemeType and indicate that it is a track for merging video components of the V-PCC into one bitstream. Moreover, the MPD generation unit 411 may set @codecs of the base track (VVC merge base track) to “resv.vvvc.vvc1”.

Similarly in a case where the 2D codec is HEVC, the MPD generation unit 411 may deform the base track (HEVC tile base track) using restricted sample entry transformation. Moreover, the MPD generation unit 411 may set ‘v3 cm’ in the scheme type (SchemeType) and indicate that it is a track for merging video components of the V-PCC into one bitstream. Moreover, the MPD generation unit 411 may set @codecs of the base track (HEVC tile base track) to “resv.vvvc.hvc1”.

Therefore, the track for storing the merge information of the content file is set to the restricted video track. The decoding unit 363 of the reproduction device 450 may prohibit the reproduction based on the merge information on the basis of the restriction. For example, in the reproduction processing described above, the decoding unit 363 may prohibit the reproduction based on the merge information according to the restriction set to the track that stores the merge information of the content file.

By doing so, it is possible to prevent the reproduction device 450 from executing reproduction with the base track as a start point and reproducing a video not assumed by the content author, such as displaying a merged picture. That is, the reproduction device 450 can perform correct reproduction more reliably.

### Method 1-2-5

In a case where Method 1-2 is applied, a track related to merging may be distributed as one file as shown in the twelfth row from the top of the table in FIG. 39 (Method 1-2-5).

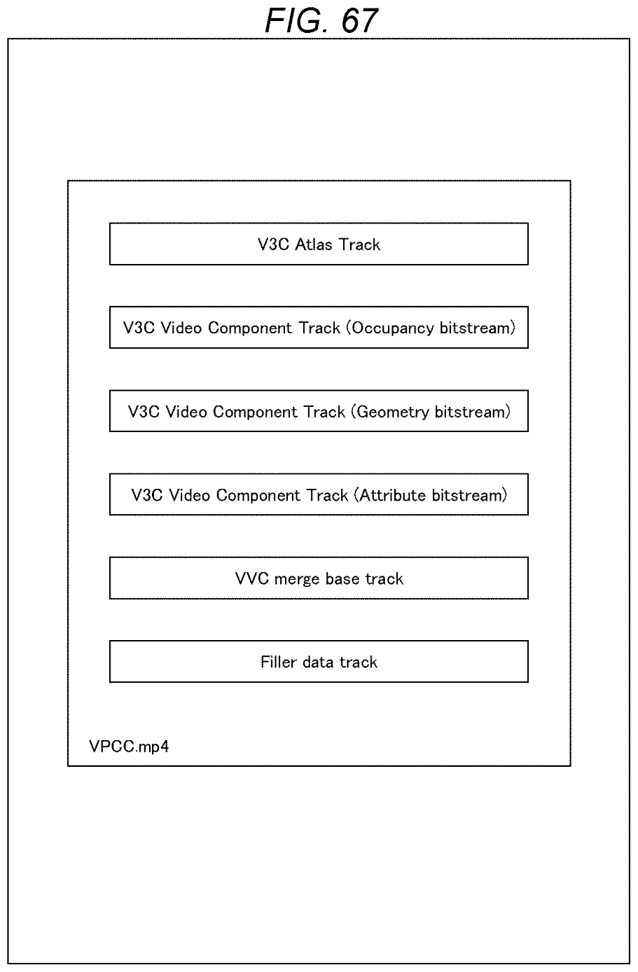

For example, as illustrated in FIG. 67, an atlas track (V3C Atlas track), each video component track (V3C Videocomponent track), a base track (VVC merge base track or HEVC tile base track), and a filler track (Filler data track) that stores filler data may be distributed as one file (VPCC.mp4).

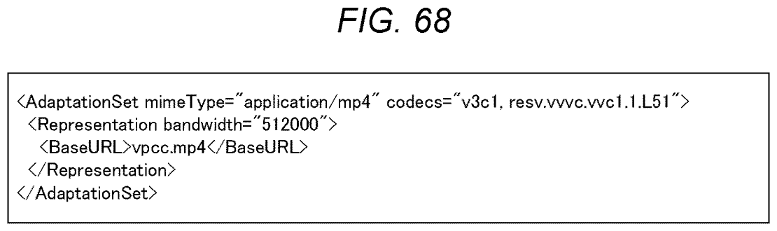

In the MPD, for example, as in the description illustrated in FIG. 68, information for controlling the distribution of the collected one file (VPCC.mp4) is described.

For example, in a case where there are a plurality of LoDs, each subpicture or tile is converted into a file. That is, tracks used at the time of decoding are put together into one file. By doing so, the number of candidate base tracks can be reduced. That is, by limiting merge information to be a candidate, it is possible to suppress an increase in load of selection of merge information (typically, selection can be unnecessary by making merge information into one).

For example, in the file generation device 400, the content file generation unit 313 may generate a distribution file that stores a plurality of video components to be merged and merge information thereof.

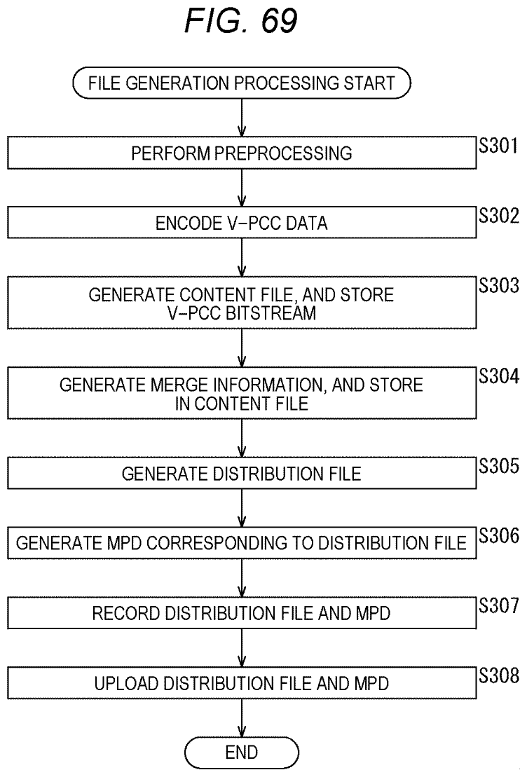

An example of a flow of file generation processing executed by the file generation device 400 to which Method 1-2-5 described above is applied will be described with reference to a flowchart of FIG. 69.

When the file generation processing is started, the processing from step S301 to step S304 is performed similarly to the processing from step S201 to step S204 (FIG. 59).

In step S305, the content file generation unit 313 generates one distribution file that stores the atlas track, each video component track, the base track, and the filler track.

In step S306, the MPD generation unit 411 generates an MPD corresponding to the distribution file. In step S307, the recording unit 314 records the distribution file and the MPD. In step S308, the upload unit 315 uploads the distribution file and the MPD. When the processing of step S308 ends, the file generation processing ends.

By doing so, the file generation device 400 can put tracks related to merging together into one file. Therefore, the file generation device 400 can suppress an increase in the number of decoder instances necessary for decoding the video components constituting the 3D data.

On the other hand, the file acquisition unit 361 of the reproduction device 450 may acquire the distribution file and acquire each bitstream of the plurality of video components stored in the distribution file and the merge information thereof.

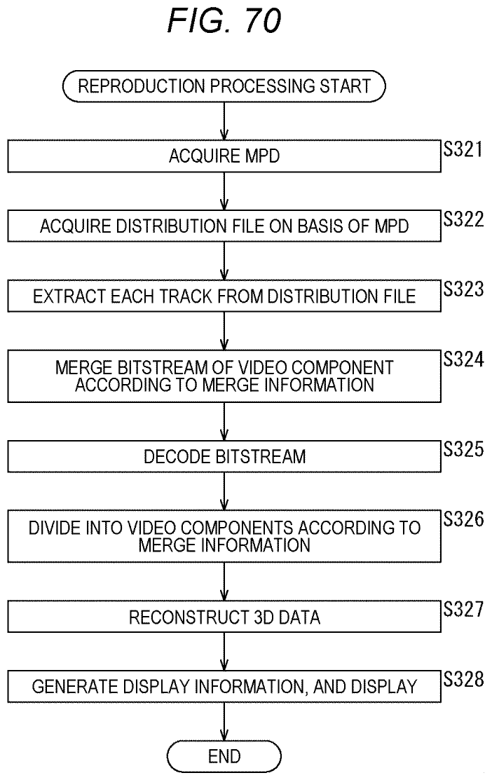

An example of a flow of reproduction processing executed by the reproduction device 450 to which Method 1-2-5 is applied will be described with reference to a flowchart of FIG. 70.

When the reproduction processing is started, in step S321, the MPD acquisition unit 461 acquires an MPD. For example, the MPD acquisition unit 461 may acquire an MPD having the description as in the example of FIG. 68 described above.

In step S322, the file acquisition unit 361 acquires the distribution file (VPCC.mp4) on the basis of the MPD.

In step S323, the file acquisition unit 361 extracts each track (atlas track, each video component track, base track, filler track, and the like) from the distribution file.

The processing from step S324 to step S328 are performed similarly to the processing from step S225 to step S229 (FIG. 61). When the processing in step S328 ends, the reproduction processing ends.

By doing so, the reproduction device 450 can acquire and reproduce the distribution file in which the tracks related to merging are put together. Therefore, the reproduction device 450 can suppress an increase in the number of decoder instances necessary for decoding the video components constituting the 3D data.

### Method 1-2-6

In a case where Method 1-2 is applied, a combination of tracks to be merged may be designated in units of groups of tracks as shown in the thirteenth row from the top of the table in FIG. 39 (Method 1-2-6).

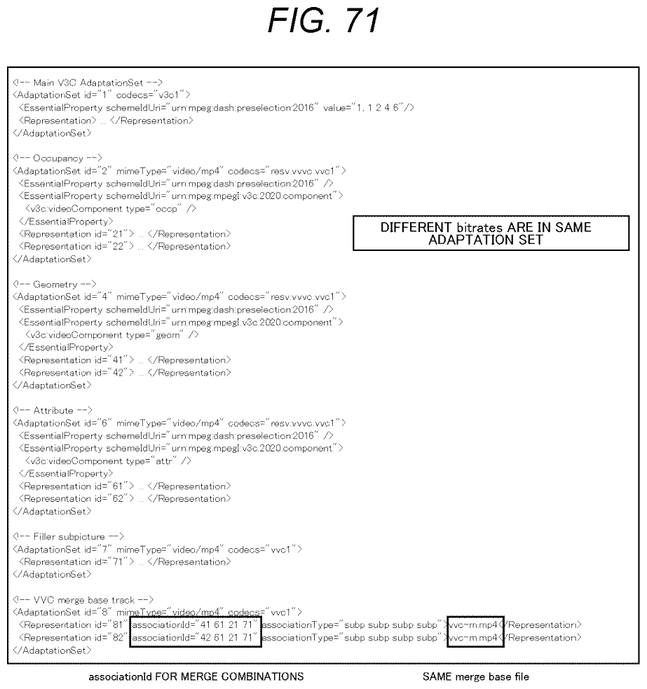

A case where a plurality of bit rates can be adapted in a video component will be considered. In that case, in the MPD, when the representation of the base track is described for all the combinations of the representations to be merged, for example, as in the description example of FIG. 71, the size of the MPD increases, and there is a possibility that the transmission efficiency deteriorates. In the MPD of FIG. 71, two representations are described for the base track. There is a possibility that the representation of the base track increases and the size of the MPD increases according to the increase in the combination of merging.

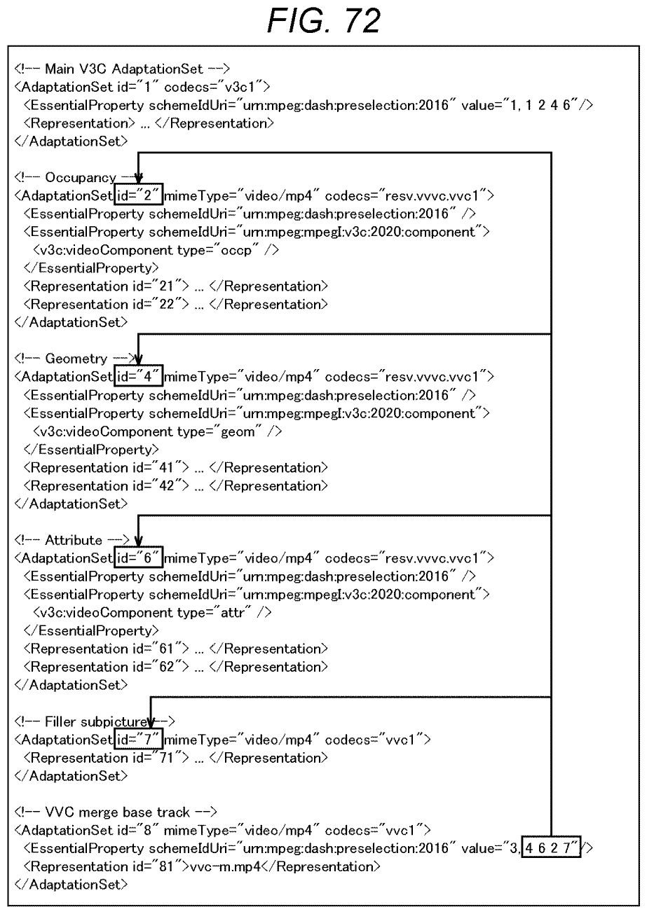

Therefore, a combination of tracks to be merged may be designated by a group of tracks (that is, the adaptation set). FIG. 72 illustrates an example of the MPD in that case. As illustrated in FIG. 72, a representation to be merged may be selected for each adaptation set of the video component using preselection (Preselection). Variations of the bit rates of the video components of the V-PCC are stored in the same adaptation set. Therefore, by selecting a representation to be merged using the adaptation set, it is possible to collectively designate variations of all bit rates. That is, the adaptation set of the base track and the adaptation set of each video component may be associated using preselection. The main track (Main track) of preselection may be a base track.

For example, in the file generation device 400, the MPD generation unit 411 may add “information designating the adaptation set of the bitstream to be merged” to the adaptation set of the merge information of the MPD (control file). For example, in step S205 of the file generation processing in FIG. 59, the MPD generation unit 411 may add “information designating the adaptation set of the bitstream to be merged” to the adaptation set of the merge information of the MPD.

Therefore, “information designating the adaptation set of the bitstream to be merged” is added to the adaptation set of the merge information of the MPD (control file). The merge processing unit 362 of the reproduction device 450 may merge the bitstream of the representation in the adaptation set designated by the information. For example, in step S225 of the reproduction processing of FIG. 61, the merge processing unit 362 may merge the bitstream of the representation in the adaptation set designated by “information designating the adaptation set of the bitstream to be merged” added to the adaptation set of the merge information of the MPD.

By doing so, an increase in the size of the MPD can be suppressed, and an increase in the amount of transmission data can be suppressed.

### Method 1-3

In a case where Method 1 is applied, merging and distributing may be performed as shown in the fourteenth row from the top of the table in FIG. 39 (Method 1-3).

For example, a third information processing device includes a 3D data acquisition unit that acquires each bitstream of a plurality of video components of 3D data and merge information for merging the plurality of bitstreams, a merge processing unit that merges the plurality of bitstreams on the basis of the merge information, a file generation unit that generates a distribution file and stores the merged bitstream, and a supply unit that supplies the distribution file and an atlas file that stores atlas information for reconstructing the 3D data.

For example, in the third information processing device, each bitstream of a plurality of video components of 3D data and merge information for merging the plurality of bitstreams are acquired, the plurality of bitstreams is merged on the basis of the merge information, a distribution file is generated, the merged bitstream is stored, and the distribution file and an atlas file storing atlas information for reconstructing the 3D data are supplied.

For example, a fourth information processing device includes a file acquisition unit that acquires a distribution file that stores a bitstream in which each bitstream of a plurality of video components of 3D data is merged and an atlas file that stores atlas information for reconstructing the 3D data, a decoding unit that decodes the merged bitstream and generates decoded data, a division unit that divides the decoded data into a plurality of video components, and a reconstruction unit that reconstructs the 3D data using the plurality of video components obtained by the division and the atlas information.

For example, in the fourth information processing device, a distribution file storing a bitstream in which each bitstream of a plurality of video components of 3D data is merged and an atlas file storing atlas information for reconstructing the 3D data are acquired, the merged bitstream is decoded to generate decoded data, the decoded data is divided into a plurality of video components, and the 3D data is reconstructed using the plurality of video components obtained by the division and the atlas information.

By doing so, the load of the reproduction processing can be distributed.

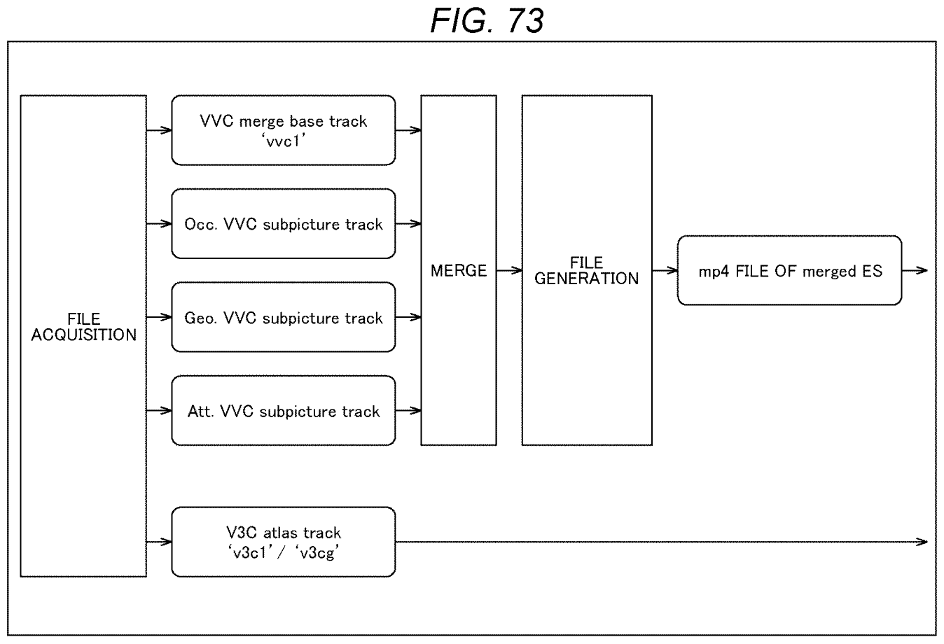

For example, an edge server (third information processing device) may be provided between the distribution server and the reproduction device, and the bitstreams of the video components may be merged in the edge server. For example, as illustrated in FIG. 73, the edge server may acquire (each track of) the content file from the distribution server. FIG. 73 illustrates an example of an outline of processing of the edge server in a case where the 2D codec is WVC. In this example, the edge server performs “file acquisition” to acquire the VVC merge base track, the Occ. VVC subpicture track, the Geo. VVC subpicture track, the Att. VVC subpicture track, the V3C atlas track, and the like.

The edge server performs “merging”, and merges the Occ. VVC subpicture track, the Geo. VVC subpicture track, and the Att. VVC subpicture track on the basis of the WVC merge base track. The edge server performs “file generation” and generates a distribution file (mp4 file of the merged ES) that stores the merged bitstream. The edge server supplies the distribution file and the V3C atlas track to the client (reproduction device). In a case where the 2D codec is HEVC, basically similar processing is also executed.

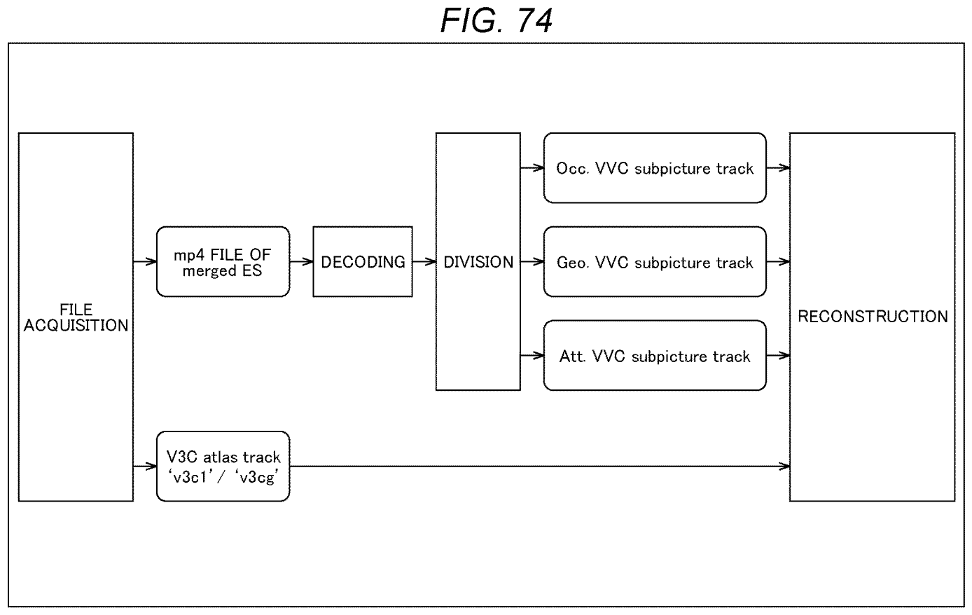

On the other hand, the client (fourth information processing device) executes processing as illustrated in FIG. 74. FIG. 74 illustrates an example of an outline of processing of the client in a case where the 2D codec is VVC. That is, the client performs “file acquisition” and acquires the distribution file (mp4 file of the merged ES) and the V3C atlas track supplied from the edge server. Furthermore, the client performs “decoding”, decodes the merged bitstream stored in the distribution file, and generates decoded data. The client performs “division” and divides the decoded data into video components (Occ. VVC subpicture track, Geo. VVC subpicture track, and Att. WVC subpicture track). The reconstruction unit reconstructs the 3D data using the tracks (Occ. VVC subpicture track, Geo. VVC subpicture track, Att. VVC subpicture track, and V3C atlas track) of the V-PCC.

By doing so, the load of the reproduction processing can be distributed to the edge server and the client, and an increase in the load of the client can be suppressed.

Note that the client may request the edge server to acquire the content file from the distribution server.

### Method 1-3-1

In a case where Method 1-3 is applied, information for division into video components may be transmitted as shown in the bottom row of the table of FIG. 39 (Method 1-3-1).

As in the examples of FIGS. 73 and 74, when the reproduction processing is divided into the edge server and the client, there is a possibility that the information for dividing the decoded data into the video components cannot be obtained in the “division” of the client, and the division cannot be performed correctly.

Therefore, in the third information processing device, the file generation unit may store “information for division into video components” in the distribution file.

Therefore, “information for division into video components” is stored in the distribution file. Therefore, in the fourth information processing device, the division unit may divide the decoded data into a plurality of video components on the basis of the “information for division into video components”.

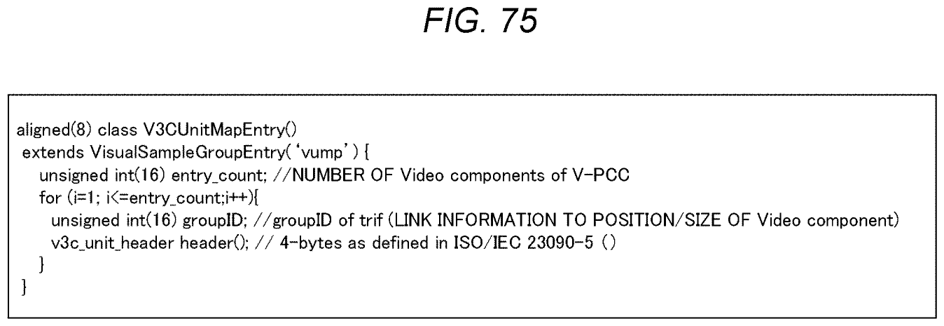

For example, V3CUnitMapEntry as illustrated in FIG. 75 may be stored in the distribution file as “information for division into video components”. For example, V3CUnitMapEntry may be stored in a sample group (Sample Group (‘trif’)) indicating a rectangular region of a picture. This V3CUnitMapEntry is information indicating a rectangular region of a picture.

In this V3CUnitMapEntry, parameters such as entry count, groupID, and v3c_unit_header_header( ) are set. entry_count is a parameter indicating the number of video components of the V-PCC. groupID indicates the groupID of the trif (for example, link information to information indicating the position and size of the video component). v3c_unit_header_header( ) is 4-byte information.

By storing such information in the distribution file, the client can easily acquire the information and apply the information to division. That is, the client can more easily and correctly divide the decoded data into components on the basis of the information.

For example, in the third information processing device, the file generation unit may store “information indicating a rectangular region on a picture” as “information for division into video components” in the sample group of the distribution file.

For example, in the fourth information processing device, the “information for division into video components” referred to by the division unit may be “information indicating a rectangular region on a picture” stored in the sample group of the distribution file.

### <Edge Server>

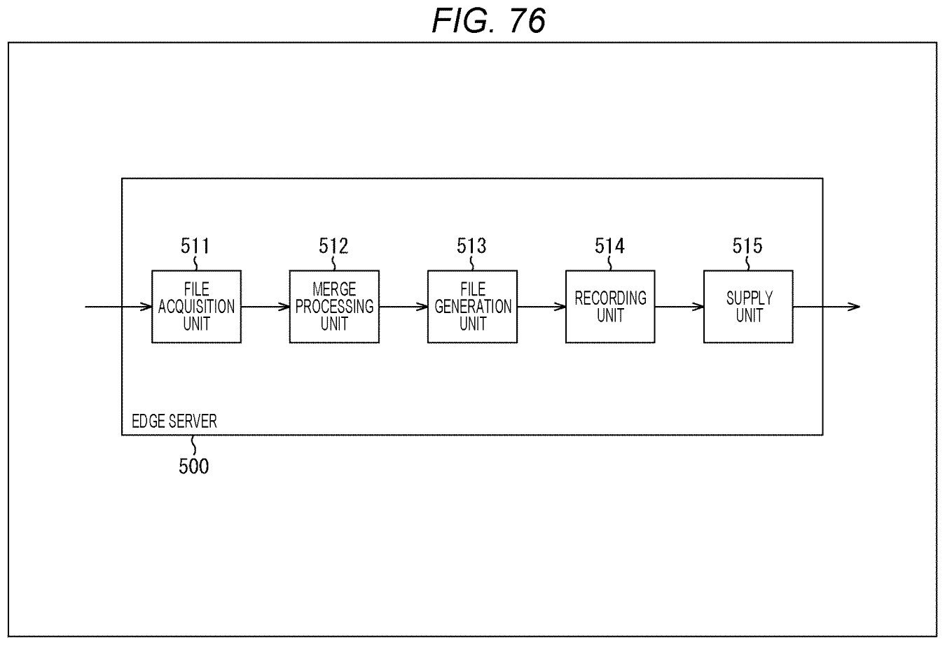

FIG. 76 is a block diagram illustrating an example of a configuration of an edge server that is an aspect of an information processing device to which the present technology is applied. An edge server 500 (third information processing device) illustrated in FIG. 76 is an apparatus that merges the bitstreams of the video components stored in the content file generated by the file generation device 300 by applying the present technology.

Note that, in FIG. 76, main processing units, main data flows, and the like are illustrated, and those illustrated in FIG. 76 are not necessarily all. That is, in the edge server 500, there may be a processing unit not illustrated as a block in FIG. 76, or there may be a process or a data flow not illustrated as an arrow and the like in FIG. 76.

As illustrated in FIG. 76, the edge server 500 (third information processing device) includes a file acquisition unit 511, a merge processing unit 512, a file generation unit 513, a recording unit 514, and a supply unit 515.

The file acquisition unit 511 performs processing regarding the acquisition of the content file and the like. For example, the file acquisition unit 511 may acquire data supplied from the outside of the edge server 500 (for example, a distribution server and the like). For example, the file acquisition unit 511 may acquire atlas information of 3D data, each bitstream of a plurality of video components, merge information for merging the plurality of bitstreams, and the like. That is, it can also be referred to as a 3D data acquisition unit. The file acquisition unit 511 may supply the acquired data to the merge processing unit 512.

The merge processing unit 512 executes processing related to the merge of the bitstreams of the video components. For example, the merge processing unit 512 may acquire data (atlas information of 3D data, each bitstream of a plurality of video components, merge information, and the like) supplied from the file acquisition unit 511. The merge processing unit 512 may merge the bitstreams of the plurality of video components on the basis of the merge information. The merge processing unit 512 may supply the merged bitstream, merge information, atlas information, and the like to the file generation unit 513.

The file generation unit 513 executes processing related to generation of a distribution file that stores content data such as 3D data. For example, the file generation unit 513 may acquire the merged bitstream, merge information, atlas information, and the like supplied from the merge processing unit 512. The file generation unit 513 may generate a distribution file and store the merged bitstream in the distribution file. Furthermore, the file generation unit 513 may store the merge information in the distribution file. The file generation unit 513 may supply the distribution file and the atlas information generated in this manner to the recording unit 514.

The recording unit 514 includes any recording medium such as a hard disk or a semiconductor memory, for example, and performs a process related to data recording. For example, the recording unit 514 may record the distribution file, the atlas information, and the like supplied from the file generation unit 513 in the recording medium. Furthermore, the recording unit 514 may read a distribution file, atlas information, and the like recorded on the recording medium in accordance with a request from the supply unit 515 and the like, or at a predetermined timing, and supply the distribution file, atlas information, and the like to the supply unit 515.

The supply unit 515 executes processing related to supply of the distribution file. For example, the supply unit 515 may acquire the distribution file, the atlas information, and the like supplied from the recording unit 514. The supply unit 515 may supply the distribution file, the atlas information, and the like to the outside of the edge server 500 (for example, a client and the like).

### <Flow of Edge Server Processing>

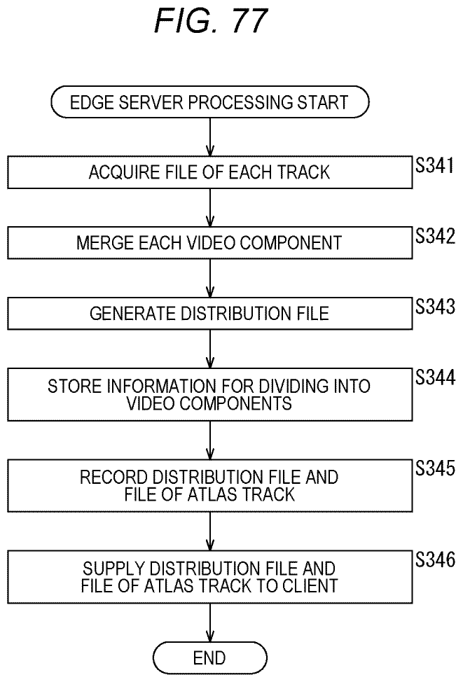

An example of a flow of edge server processing executed by the edge server 500 to which Method 1-3 or Method 1-3-1 is applied will be described with reference to a flowchart of FIG. 77.

When the edge server processing is started, the file acquisition unit 511 acquires the file of each track in step S341.

In step S342, the merge processing unit 512 merges the video components.

In step S343, the file generation unit 513 generates a distribution file and stores a merged bitstream and the like. In step S344, the file generation unit 513 stores information (for example, merge information) for division into video components in the distribution file.

In step S345, the recording unit 514 records the distribution file and the file of the atlas track. In step S346, the supply unit 515 supplies the distribution file and the file of the atlas track to the client.

When the processing of step S346 ends, the edge server processing ends.

### <Client>

The configuration of the client (fourth information processing device) is, for example, equivalent to that in which the merge processing unit 362 is omitted from the reproduction device 350 in FIG. 51.

### <Flow of Reproduction Processing>

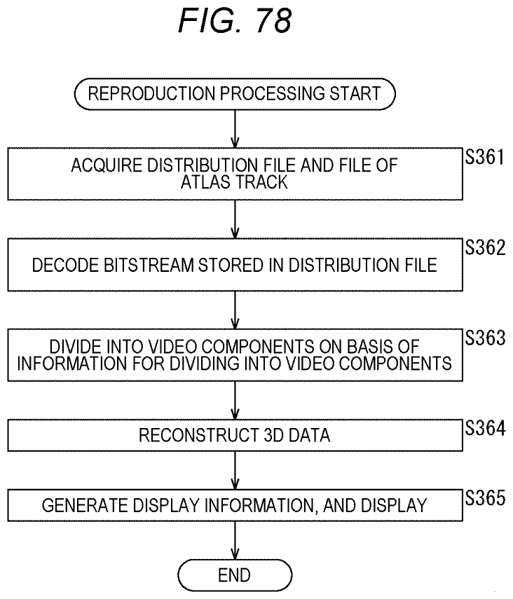

An example of a flow of reproduction processing executed by a client to which Method 1-3 or Method 1-3-1 is applied will be described with reference to a flowchart of FIG. 78. The configuration of the client will be described with reference to FIG. 51.

When the reproduction processing is started, the file acquisition unit 361 of the client acquires the distribution file and the file of the atlas track in step S361. In step S362, the decoding unit 363 decodes the bitstream stored in the distribution file. In step S363, the division unit 364 performs division into video components on the basis of information for division into the video components. In step S364, the reconstruction unit 365 reconstructs the 3D data. In step S365, the display processing unit 366 generates and displays the display information. When the processing of step S365 ends, the reproduction processing ends.

By doing so, the load of the reproduction processing can be distributed to the edge server and the client, and an increase in the load of the client can be suppressed.

### Method 1-4

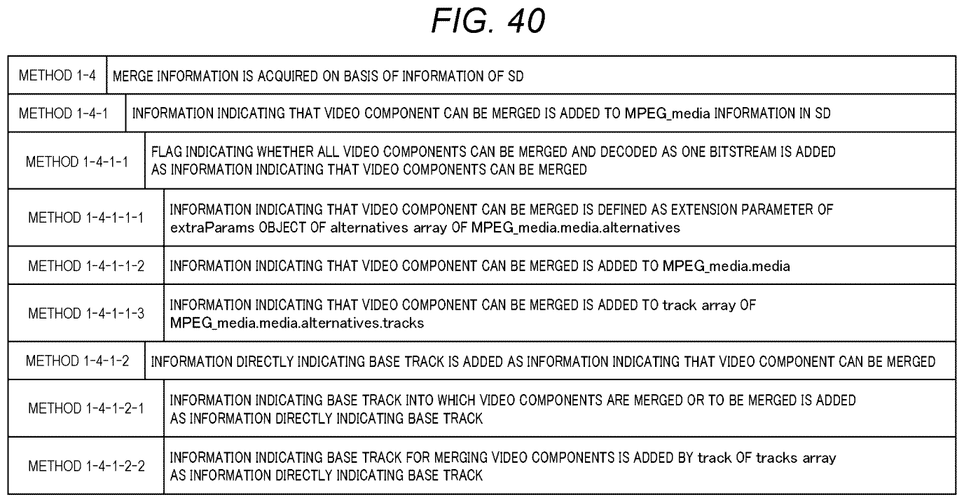

In a case where Method 1 is applied, merge information may be acquired on the basis of information of a scene description (SD) as shown in the uppermost part of the table in FIG. 40 (Method 1-4). The scene description is a control file that describes a scene of the 3D content. The reproduction device may acquire and reproduce content on the basis of the scene description.

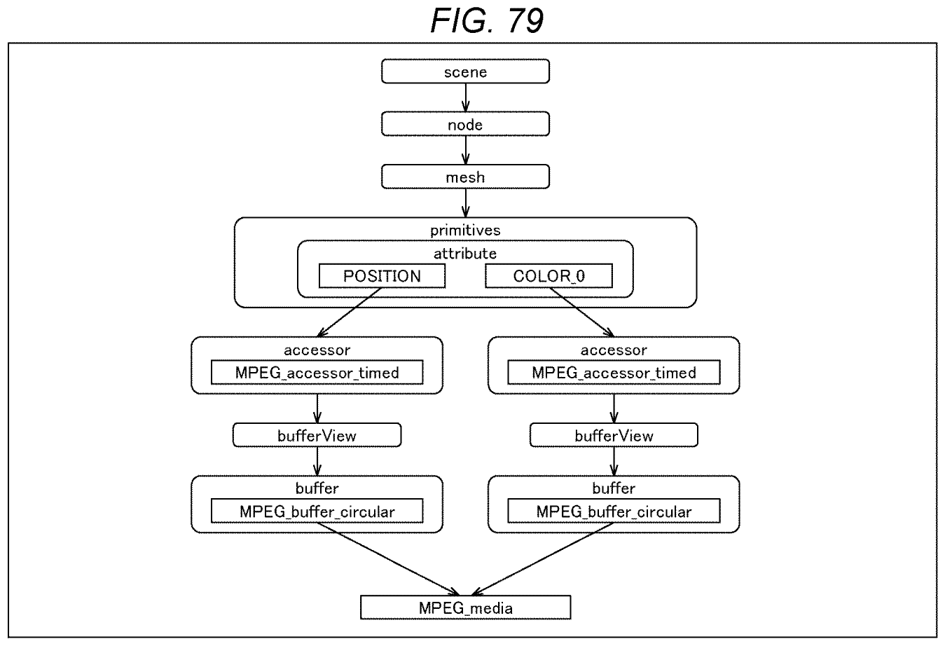

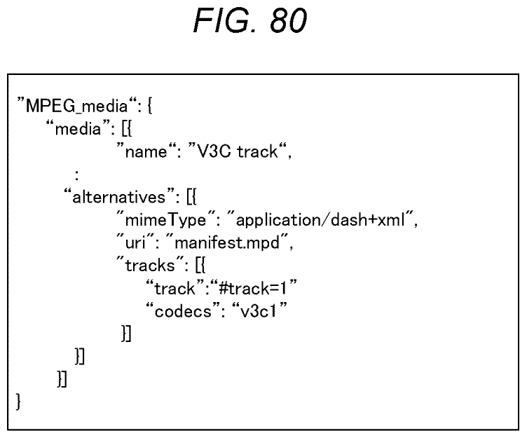

FIG. 79 illustrates an example of a scene graph in a case where one V-PCC object is signaled in the scene description. As illustrated in FIG. 79, MPEG_media can be accessed from accessors different from each other for a geometry (POSITION) and an attribute (COLOR_0). Furthermore, access information to the adaptation set of the MP4 file or the MPD file of the V-PCC is included from MPEG_media. FIG. 80 illustrates a description of only the MPEG_media part in a case where access information from MPEG_media to the adaptation set of the MPD file is included.

### <File Generation Device>

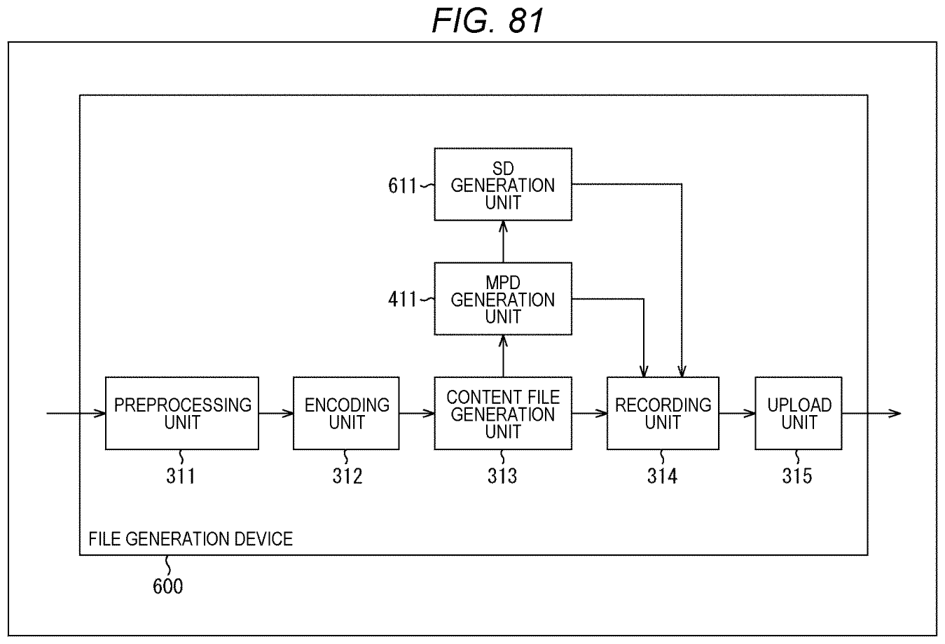

FIG. 81 illustrates a main configuration example of a file generation device to which the above-described Method 1-4 is applied. Similarly to the file generation device 400 (FIG. 58), a file generation device 600 illustrated in FIG. 81 is a device that encodes 3D data with an encoding method conforming to the V-PCC by applying the present technology. However, the file generation device 600 generates a scene description.

Note that, in FIG. 81, main processing units, main data flows, and the like are illustrated, and those illustrated in FIG. 81 are not necessarily all. That is, in the file generation device 600, there may be a processing unit not illustrated as a block in FIG. 81, or there may be processing or a data flow not illustrated as an arrow and the like in FIG. 81.

As illustrated in FIG. 81, the file generation device 600 (second information processing device) further includes an SD generation unit 611 in addition to the configuration of the file generation device 400. The MPD generation unit 411 may further supply the content file, the MPD, and the like to the SD generation unit 611.

The SD generation unit 611 executes processing related to generation of a scene description. For example, the SD generation unit 611 may acquire the content file, the MPD, and the like supplied from the MPD generation unit 411. The SD generation unit 611 may generate a scene description corresponding to the content file or the MPD. The SD generation unit 611 supplies the generated scene description to the recording unit 314.

The recording unit 314 may further record the scene description and the like supplied from the SD generation unit 611 on the recording medium. Furthermore, the recording unit 314 may read a scene description and the like recorded on the recording medium in accordance with a request from the upload unit 315 and the like, or at a predetermined timing, and supply the scene description and the like to the upload unit 315. The upload unit 315 may further acquire a scene description and the like supplied from the recording unit 314. The upload unit 315 may upload the scene description and the like to the outside of the file generation device 300 (for example, a distribution server and the like).

### <Flow of File Generation Processing>

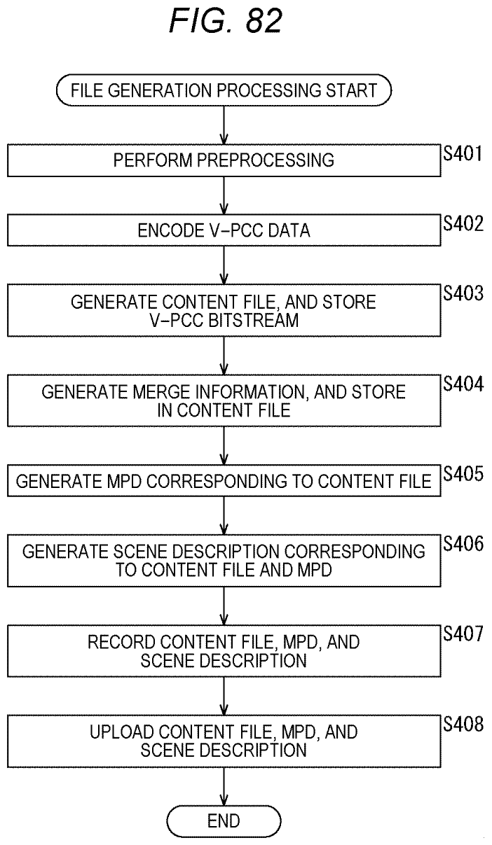

An example of a flow of file generation processing executed by the file generation device 400 to which the above Method 1-4 is applied will be described with reference to a flowchart of FIG. 82.

When the file generation processing is started, the processing from step S401 to step S405 is performed similarly to the processing from step S201 to step S205 (FIG. 59). In step S406, the SD generation unit 611 generates a scene description corresponding to the content file or the MPD.

In step S407, the recording unit 314 records the content file, the MPD, and the scene description. In step S408, the upload unit 315 uploads the content file, the MPD, and the scene description. When the processing of step S408 ends, the file generation processing ends.

By doing so, the file generation device 600 can generate the scene description.

### <Reproduction Device>

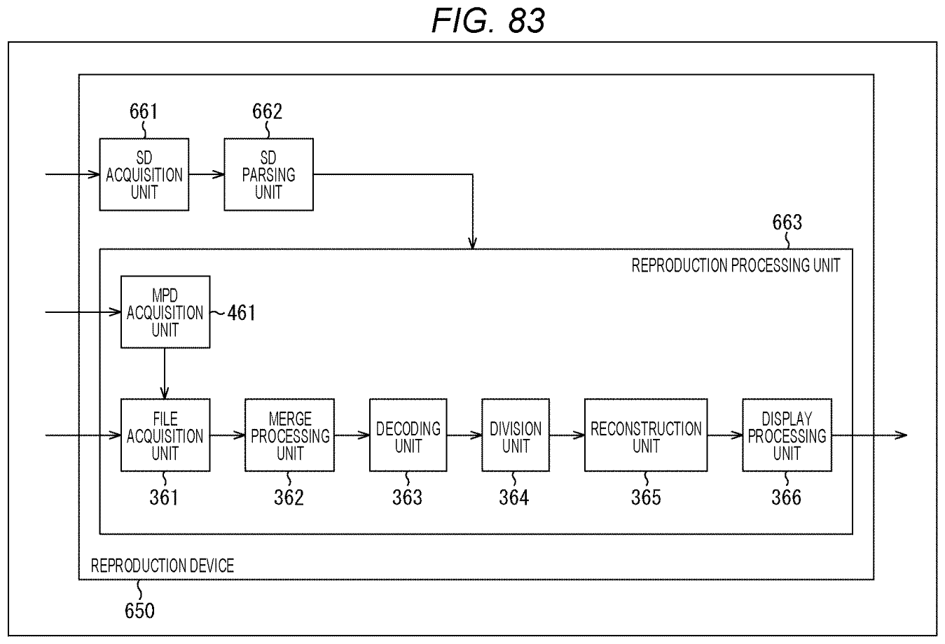

FIG. 83 illustrates a main configuration example of a reproduction device to which the above-described Method 1-4 is applied. A reproduction device 650 illustrated in FIG. 83 is a device corresponding to the file generation device 600, and is a device that decodes a bitstream stored in a content file generated by the file generation device 600 and reproduces 3D data by applying the present technology, similarly to the reproduction device 450 (FIG. 60). However, the reproduction device 650 acquires the scene description generated by the file generation device 600, and acquires the content file on the basis of the scene description.

Note that, in FIG. 83, main processing units, main data flows, and the like are illustrated, and those illustrated in FIG. 83 are not necessarily all. That is, in the reproduction device 650, there may be a processing unit not illustrated as a block in FIG. 83, or there may be processing or a data flow not illustrated as an arrow and the like in FIG. 83.

As illustrated in FIG. 83, the reproduction device 650 (first information processing device) includes an SD acquisition unit 661, an SD parsing unit 662, and a reproduction processing unit 663. The reproduction processing unit 663 includes a file acquisition unit 361, a merge processing unit 362, a decoding unit 363, a division unit 364, a reconstruction unit 365, a display processing unit 366, and an MPD acquisition unit 461. That is, the reproduction processing unit 663 has a configuration similar to the reproduction device 450 (FIG. 60) and performs the similar processing.

The SD acquisition unit 661 executes processing related to acquisition of the scene description. For example, the SD acquisition unit 661 may acquire the scene description. The SD acquisition unit 661 may supply the acquired scene description to the SD parsing unit 662.

The SD parsing unit 662 performs processing related to parsing of the scene description. For example, the SD parsing unit 662 may acquire the scene description supplied from the SD acquisition unit 661. The SD parsing unit 662 may parse the scene description and grasp the description. The SD parsing unit 662 may control the reproduction processing unit 663 (each processing unit therein) in accordance with the parsing result, that is, the description content of the scene description. For example, the SD parsing unit 662 may control acquisition of the MPD or the content file according to the scene description.

### <Flow of Reproduction Processing>

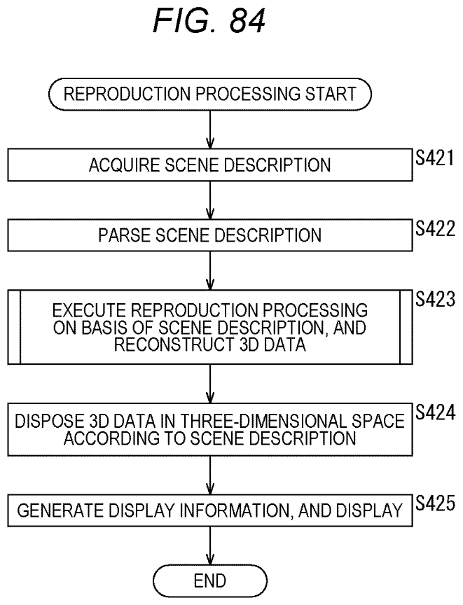

An example of a flow of reproduction processing executed by the reproduction device 650 to which the above-described Method 1-4 is applied will be described with reference to a flowchart of FIG. 84.

When the reproduction processing is started, in step S421, the SD acquisition unit 661 acquires the scene description. In step S422, the SD parsing unit 662 parses the scene description and controls the reproduction processing unit 663.

In step S423, the reproduction processing unit 663 executes reproduction processing on the basis of the control by the SD parsing unit 662, that is, the scene description, and reconfigures the 3D data. For example, the file acquisition unit 361 acquires an atlas track of the V-PCC or a representation of an atlas track designated by “track” information of MPEG_media. The subsequent processing is executed similarly to the reproduction processing described above. Then, in the reproduction processing, processing up to the reconstruction of the 3D data is executed.

In step S424, the display processing unit 366 arranges the reconstructed 3D data in the three-dimensional space according to the control (scene description) by the SD parsing unit 662. In step S425, the display processing unit 366 performs rendering to generate and display the display information.

When the processing of step S424 ends, the display processing ends.

By doing so, the reproduction processing can be executed using the scene description. Furthermore, at that time, by applying each method described above in the MPD or the content file, the effect of each method can be obtained.

### Method 1-4-1

In a case where Method 1-4 is applied, information indicating that a video component can be merged may be added to MPEG_media information in the scene description as shown in the second row from the top of the table in FIG. 40 (Method 1-4-1).

For example, the SD generation unit 611 of the file generation device 600 (second information processing device) may generate a scene description describing a scene of 3D content. Then, the SD generation unit 611 may store “description indicating that a plurality of bitstreams can be merged and decoded” in MPEG_media of the scene description. For example, in step S406 of the file generation processing in FIG. 82, the SD generation unit 611 may generate a scene description describing a scene of 3D content, and store “description indicating that a plurality of bitstreams can be merged and decoded” in MPEG_media of the scene description.

On the other hand, the SD acquisition unit 661 of the reproduction device 650 (first information processing device) may acquire a scene description describing a scene of 3D content. The SD parsing unit 662 may parse the acquired scene description and control reproduction of the 3D data. MPEG_media of the scene description may include “description indicating that a plurality of bitstreams can be merged and decoded”. The file acquisition unit 361 may acquire the bitstream and the merge information on the basis of the description. For example, in step S421 of the reproduction processing of FIG. 84, the SD acquisition unit 661 may acquire a scene description describing a scene of the 3D content. MPEG_media of the scene description may include “description indicating that a plurality of bitstreams can be merged and decoded”. In step S422, the SD parsing unit 662 may parse the acquired scene description and control reproduction of the 3D data. In step S423, the file acquisition unit 361 may acquire the bitstream and the merge information on the basis of the description.

### Method 1-4-1-1

In a case where Method 1-4-1 is applied, as shown in the third row from the top of the table in FIG. 40, a flag indicating whether all the video components can be merged and decoded as one bitstream may be added as information indicating that the video components can be merged (Method 1-4-1-1).

For example, the above “description indicating that a plurality of bitstreams can be merged and decoded” may be flag information indicating whether all the bitstreams can be merged and decoded as one bitstream.

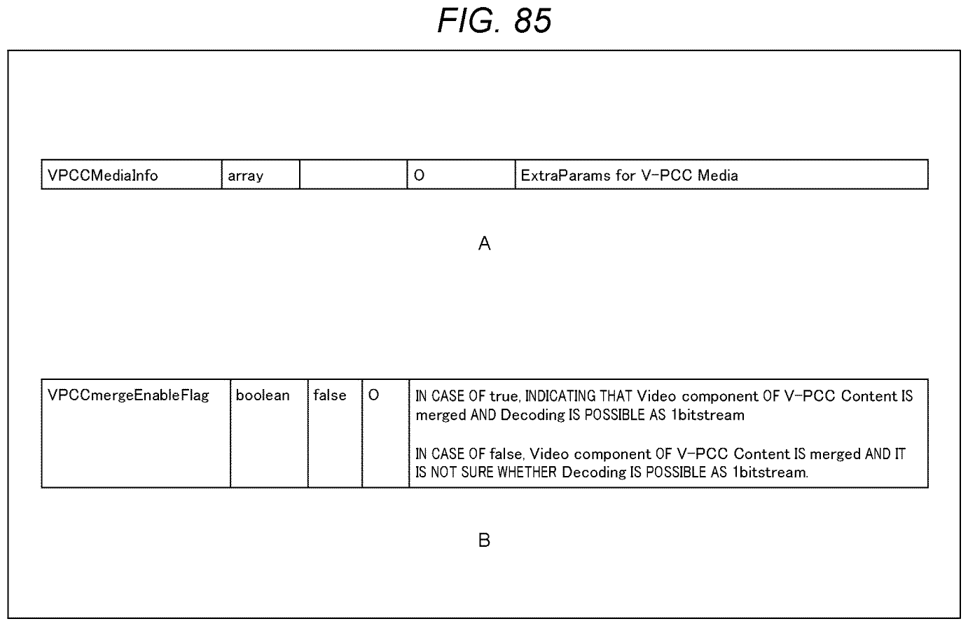

For example, in the scene description, VPCCMediaInfo may be defined as the extension parameter, and the object VPCCmergeEnableFlag may be defined. As illustrated in A of FIG. 85, VPCCMediaInfo is an extension parameter that provides supplement information of V-PCC media. As illustrated in B of FIG. 85, VPCCmergeEnableFlag is flag information indicating whether video components of V-PCC Content can be merged and decoded as one bitstream or may not be decoded. That is, as the above “flag information indicating whether all bitstreams can be merged and decoded as one bitstream”, the VPCCmergeEnableFlag is stored in the scene description.

The SD generation unit 611 of the file generation device 600 stores such information in the scene description. The SD parsing unit 662 of the reproduction device 650 can easily grasp whether or not the content can be merged by parsing this information of the scene description. That is, the SD parsing unit 662 can easily control whether or not to merge the video components on the basis of the information. For example, a client that cannot decode a plurality of video components can easily determine whether the V-PCC content indicated by MPEG_media can be reproduced only by referring to the scene description. That is, it is not necessary to acquire the file written in the uri and determine whether or not to perform reproduction.

### Method 1-4-1-1-1

Note that the information may be stored anywhere in the scene description. It may be arranged at a plurality of places. For example, in a case where Method 1-4-1-1 is applied, as shown in the fourth row from the top of the table in FIG. 40, information indicating that the video component can be merged may be defined as an extension parameter of the extraParams object of the alternatives array of MPEG_media.media.alternatives (Method 1-4-1-1-1).

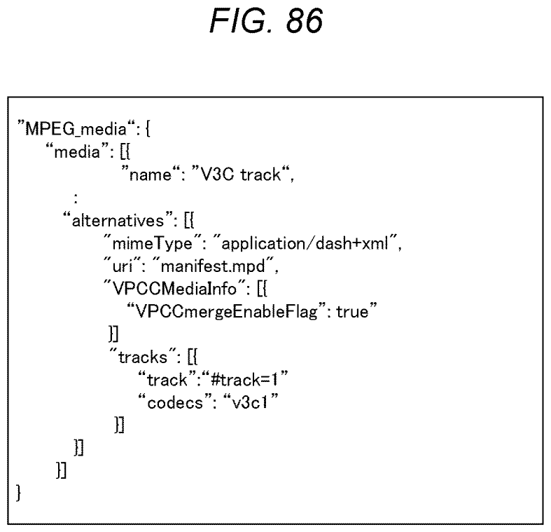

FIG. 86 illustrates a description example of MPEG_media of the scene description. In this example, VPCCMediaInfo is set as an extension parameter of the alternatives array of MPEG_media.media.alternatives, and VPCCmergeEnableFlag is defined as an object thereof.

For example, the SD generation unit 611 of the file generation device 600 may define the above “flag information indicating whether all bitstreams can be merged and decoded as one bitstream” as an extended object of MPEG_media.media.alternatives of the scene description. The SD parsing unit 662 of the reproduction device 650 may refer to the flag information stored in MPEG_media.media.alternatives.

### Method 1-4-1-1-2

In a case where Method 1-4-1-1 is applied, as shown in the fifth row from the top of the table in FIG. 40, information indicating that the video component can be merged may be added to MPEG_media.media (Method 1-4-1-1-2).

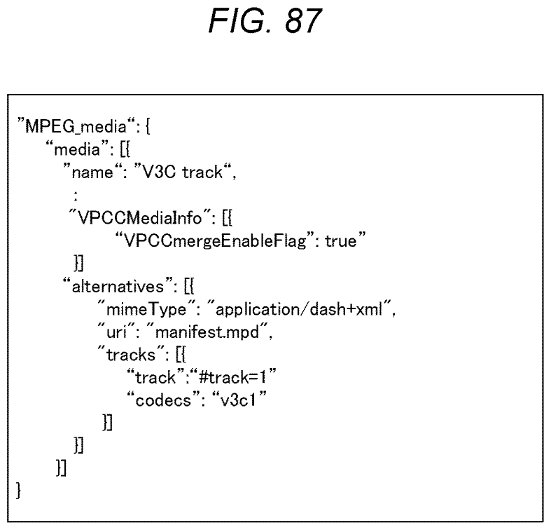

FIG. 87 illustrates a description example of MPEG_media of the scene description. In this example, VPCCMediaInfo is set as an extension parameter of MPEG_media.media, and VPCCmergeEnableFlag is defined as the object.

For example, the SD generation unit 611 of the file generation device 600 may define the above “flag information indicating whether all bitstreams can be merged and decoded as one bitstream” as an extended object of MPEG_media.media of the scene description. The SD parsing unit 662 of the reproduction device 650 may refer to the flag information stored in MPEG_media.media.

By storing the information indicating that the video component can be merged in this position, it can be used as common signaling in a case where all media indicated by alternatives are the V-PCC and can be merged, and the size of the glTF file can be reduced.

### Method 1-4-1-1-3

In a case where Method 1-4-1-1 is applied, as shown in the sixth row from the top of the table in FIG. 40, information indicating that the video component can be merged may be added to the track array of MPEG_media.media.alternatives.tracks (Method 1-4-1-1-3).

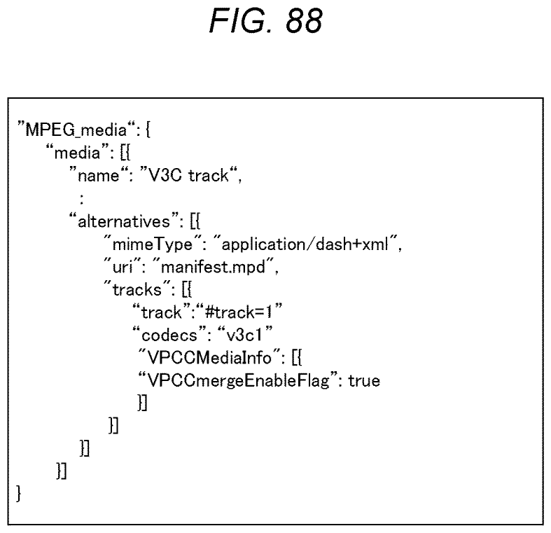

FIG. 88 illustrates a description example of MPEG_media of the scene description. In this example, VPCCMediaInfo is set as an extension parameter of the track array of MPEG_media.media.alternatives.tracks, and VPCCmergeEnableFlag is defined as an object thereof.

For example, the SD generation unit 611 of the file generation device 600 may define the above “flag information indicating whether all bitstreams can be merged and decoded as one bitstream” as an extended object of MPEG_media.media.alternatives.tracks of the scene description. The SD parsing unit 662 of the reproduction device 650 may refer to the flag information stored in MPEG_media.media.alternatives.tracks.

### Method 1-4-1-2

In a case where Method 1-4-1 is applied, as shown in the seventh row from the top of the table in FIG. 40, information directly indicating the base track may be added as information indicating that the video component can be merged (Method 1-4-1-2).

For example, the above “description indicating that a plurality of bitstreams can be merged and decoded” may be information indicating a track in which merge information is stored.

### Method 1-4-1-2-1

In a case where Method 1-4-1-2 is applied, as shown in the eighth row from the top of the table in FIG. 40, information indicating the base track into which the video components are merged or to be merged may be added as the information directly indicating the base track (Method 1-4-1-2-1).

For example, in the file generation device 600, the SD generation unit 611 may define “information indicating a track in which merge information is stored” as an extended object of MPEG_media.media.alternatives of a scene description. The SD parsing unit 662 of the reproduction device 650 may refer to the information stored in MPEG_media.media.alternatives.

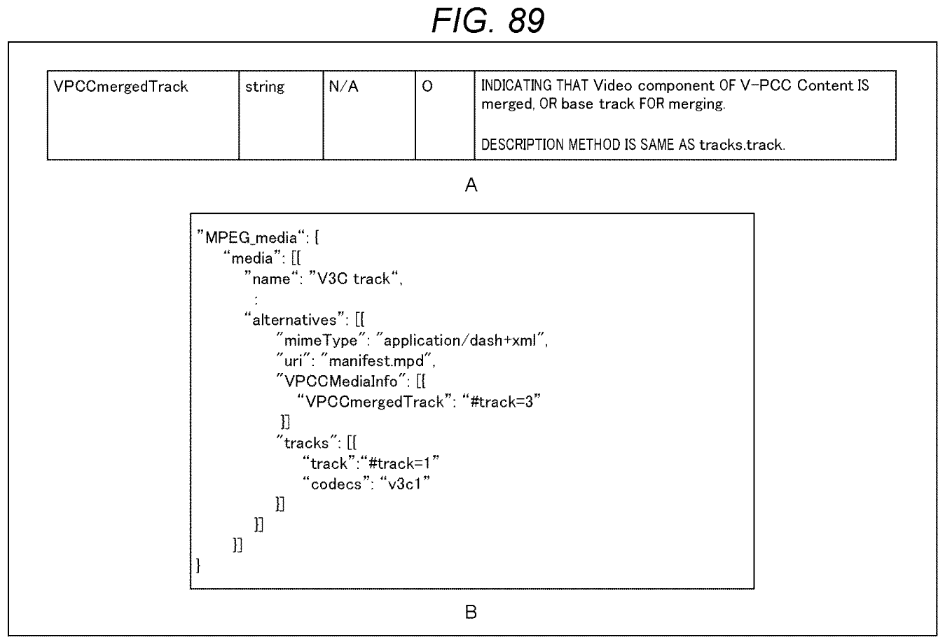

For example, in the scene description, VPCCMediaInfo may be defined as the extension parameter, and the object VPCCmergedTrack may be defined. As illustrated in A of FIG. 89, VPCCmergedTrack indicates a base track into which the video component of the V-PCC Content is merged or to be merged. The description method is similar to tracks.track. That is, as the “information indicating base track into which video components are merged or to be merged” described above, the VPCCmergedTrack is stored in the scene description.

B of FIG. 89 illustrates a description example of MPEG_media of the scene description. In this example, VPCCMediaInfo is set as an extension parameter of MPEG_media.media.alternatives, and VPCCmergedTrack is defined as the object. This extension may be extended to extraParams of the alternatives array or may be extended to the tracks array.

The SD generation unit 611 of the file generation device 600 stores such information in the scene description. The SD parsing unit 662 of the reproduction device 650 can easily grasp whether or not the content can be merged by parsing this information of the scene description. That is, the SD parsing unit 662 can easily control whether or not to merge the video components on the basis of the information. Moreover, the SD parsing unit 662 can easily grasp where information necessary for merging the video components is included.

### Method 1-4-1-2-2

In a case where Method 1-4-1-2 is applied, as shown at the bottom of the table in FIG. 40, information indicating a base track for merging video components may be added by a track of a tracks array as information directly indicating a base track (Method 1-4-1-2-2).

For example, in the file generation device 600, the SD generation unit 611 may define “information indicating a track in which merge information is stored” as a track of a track array of MPEG_media.media.alternatives.tracks of a scene description. The SD parsing unit 662 of the reproduction device 650 may refer to the information stored in MPEG_media.media.alternatives.tracks. Moreover, information for identifying whether the track is a VVC track or an HEVC track in the base track may be stored.

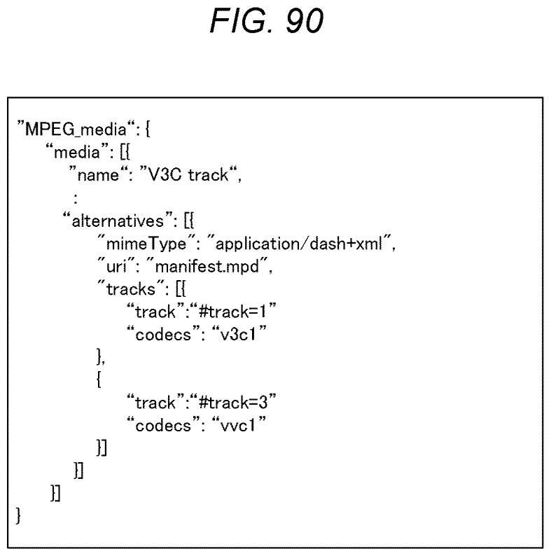

FIG. 90 illustrates a description example of MPEG_media of the scene description. In this example, “information indicating a track in which merge information is stored” is defined as one track array of MPEG_media.media.alternatives.tracks.

The SD generation unit 611 of the file generation device 600 stores such information in the scene description. The SD parsing unit 662 of the reproduction device 650 can easily grasp whether or not the content can be merged by parsing this information of the scene description. That is, the SD parsing unit 662 can easily control whether or not to merge the video components on the basis of the information. Moreover, the SD parsing unit 662 can easily grasp where information necessary for merging the video components is included. Therefore, the reproduction processing can be made efficient.

### <Flow of File Generation Processing>

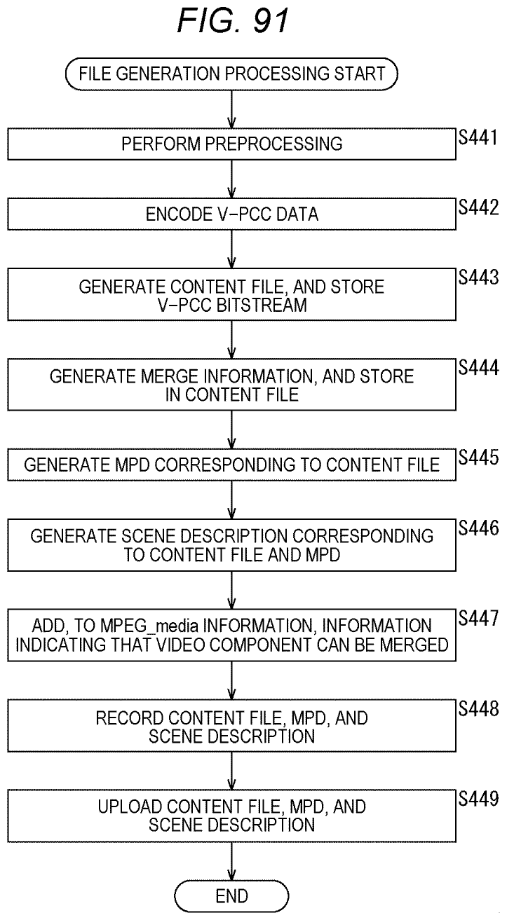

An example of a flow of file generation processing executed by the file generation device 600 to which Method 1-4-1 is applied will be described with reference to a flowchart of FIG. 91.

When the file generation processing is started, the processing from step S441 to step S446 is performed similarly to the processing from step S401 to step S406 (FIG. 82).

In step S447, the SD generation unit 611 adds information indicating that the video component can be merged to the MPEG_media information.

Each processing of steps S448 and S449 is executed similarly to each processing of steps S407 and S408. When the processing of step S449 ends, the file generation processing ends.

### <Flow of Reproduction Processing>

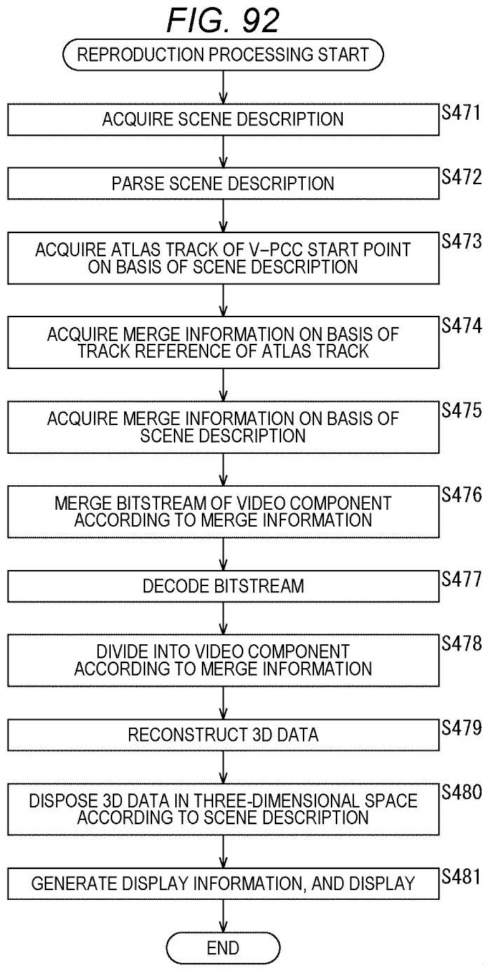

An example of a flow of reproduction processing executed by the reproduction device 650 to which Method 1-4-1 is applied will be described with reference to a flowchart of FIG. 92.

When the reproduction processing is started, in step S471, the SD acquisition unit 661 acquires the scene description. In step S472, the SD parsing unit 662 parses a scene description.

In step S473, the file acquisition unit 361 acquires the atlas track of the start point of the V-PCC on the basis of the scene description. In step S474, the file acquisition unit 361 acquires merge information on the basis of the track reference of the atlas track. In step S475, the file acquisition unit 361 acquires merge information on the basis of the scene description.

In step S476, the merge processing unit 362 merges the bitstream of the video component according to the merge information.

In step S477, the decoding unit 363 decodes the bitstream.

In step S478, the division unit 364 performs division into video components according to the merge information.

In step S479, the reconstruction unit 365 reconstructs the 3D data.

In step S480, the display processing unit 366 arranges the 3D data in a three-dimensional space according to the scene description. In step S481, the display processing unit 366 generates and displays the display information.

When the processing of step S481 ends, the reproduction processing ends.

By doing so, it is possible to easily control whether or not to merge the video components on the basis of the scene description.

### Method 1-5

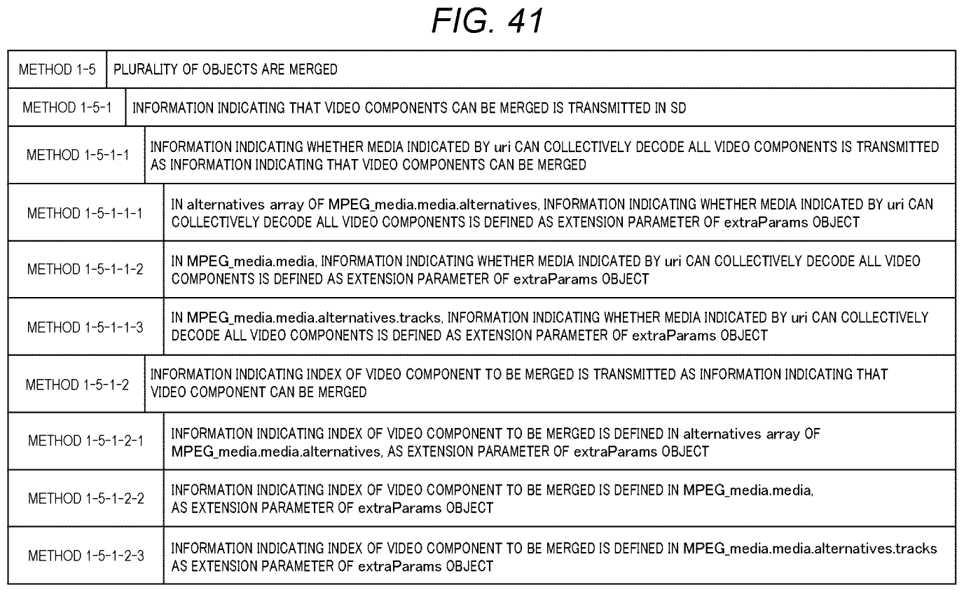

A plurality of objects can be described in the scene description. That is, a plurality of objects can be arranged in a three-dimensional space. In a case where Method 1 is applied, for these multiple objects, the plurality of objects may be merged as shown in the top row of the table in FIG. 41 (Method 1-5).

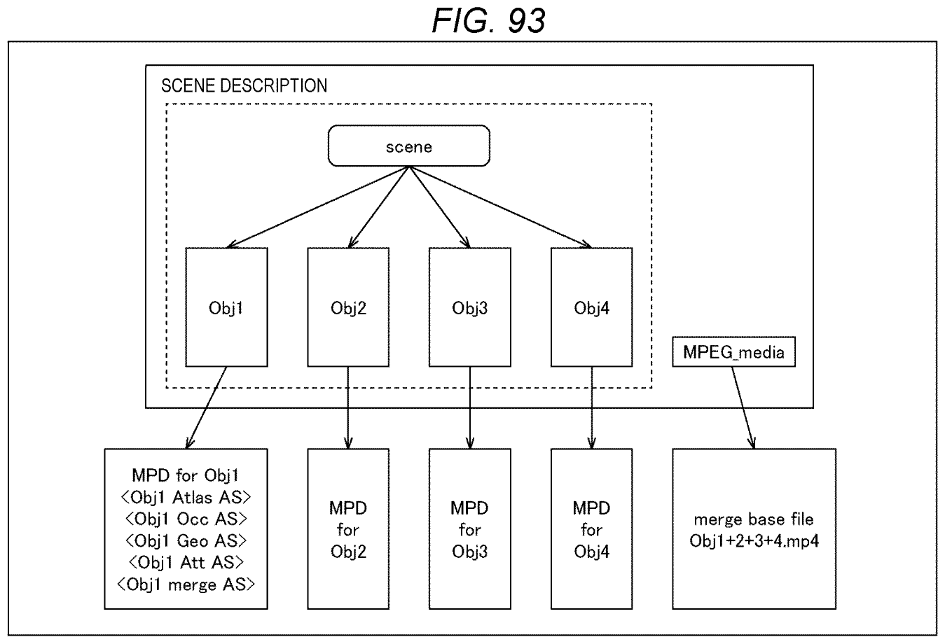

For example, as illustrated in FIG. 93, in a case where four objects (Obj1, Obj2, Obj3, Obj4) are described in the scene description, bitstreams of the video components of the four objects may be merged and decoded as one bitstream.

In that case, as illustrated in FIG. 93, merge information (merge base file (Obj1+2+3+4.mp4)) for merging the bitstreams of the video components of the four objects is required for merging. Therefore, MPEG_media that manages the merge information is described in the scene description.

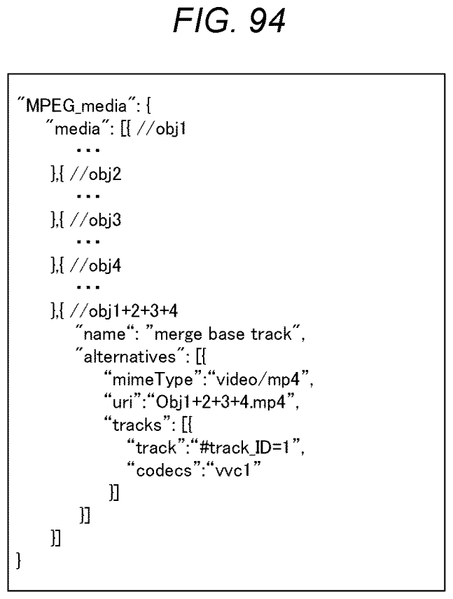

A description example of MPEG_media is illustrated in FIG. 94. A merge base file (Obj1+2+3+4.mp4) is defined as one of media arrays of MPEG_media.media. By doing so, the reproduction device 650 can access the merge information on the basis of the scene description and merge the bitstreams of the video components of the four objects.

For example, in the file generation device 600, the SD generation unit 611 may generate a scene description describing a scene of 3D content. The content file generation unit 313 may generate merge information for merging a plurality of bitstreams of a plurality of objects constituting a scene described in the scene description, and store the merge information in the content file.

### <Flow of File Generation Processing>

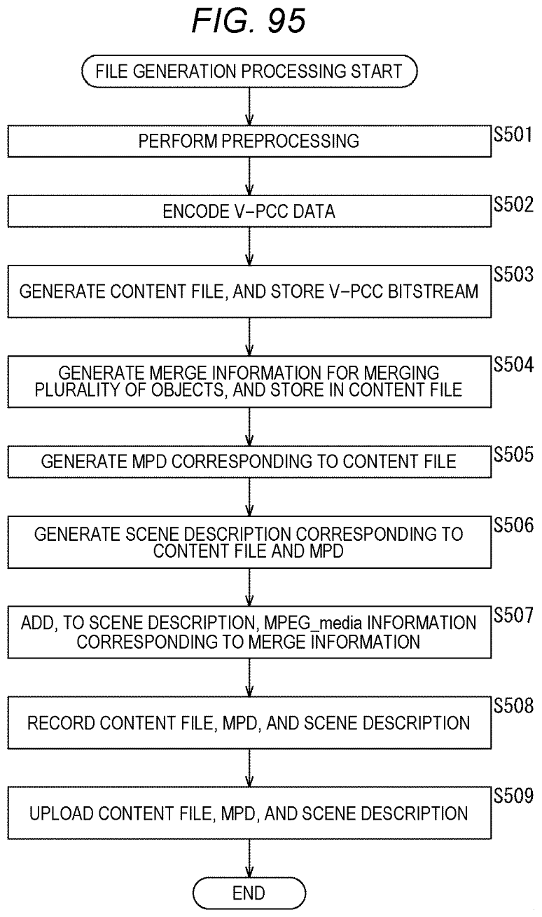

An example of a flow of file generation processing executed by the file generation device 600 to which Method 1-5 is applied will be described with reference to a flowchart of FIG. 95.

When the file generation processing is started, the processing from step S501 to step S503 is performed similarly to the processing from step S401 to step S403 (FIG. 82).

In step S504, the content file generation unit 313 generates merge information (merge base file (Obj1+2+3+4.mp4)) for merging a plurality of objects, and stores the merge information in the content file.

Each processing of steps S505 and S506 is executed similarly to each processing (FIG. 82) of steps S405 and S406.

In step S507, MPEG_media information corresponding to the merge information is generated and added to the scene description.

Each processing of steps S508 and S509 is executed similarly to each processing (FIG. 82) of steps S407 and S408. When the processing of step S509 ends, the file generation processing ends.

### <Reproduction Device>

For example, in the reproduction device 650, the SD acquisition unit 661 may acquire a scene description describing a scene of the 3D content. The SD parsing unit 662 may parse the acquired scene description and control reproduction of the 3D data. The file acquisition unit 361 may acquire a plurality of bitstreams and merge information for merging the bitstreams of the plurality of objects for each of the plurality of objects constituting the scene described in the scene description. The merge processing unit 362 may merge the bitstreams of the plurality of objects on the basis of the merge information. The decoding unit 363 may decode the merged bitstream to generate decoded data. The division unit 364 may divide the decoded data into a plurality of video components of a plurality of objects on the basis of the merge information. The reconstruction unit 365 may reconstruct the 3D data using a plurality of video components obtained by division for each of the plurality of objects.

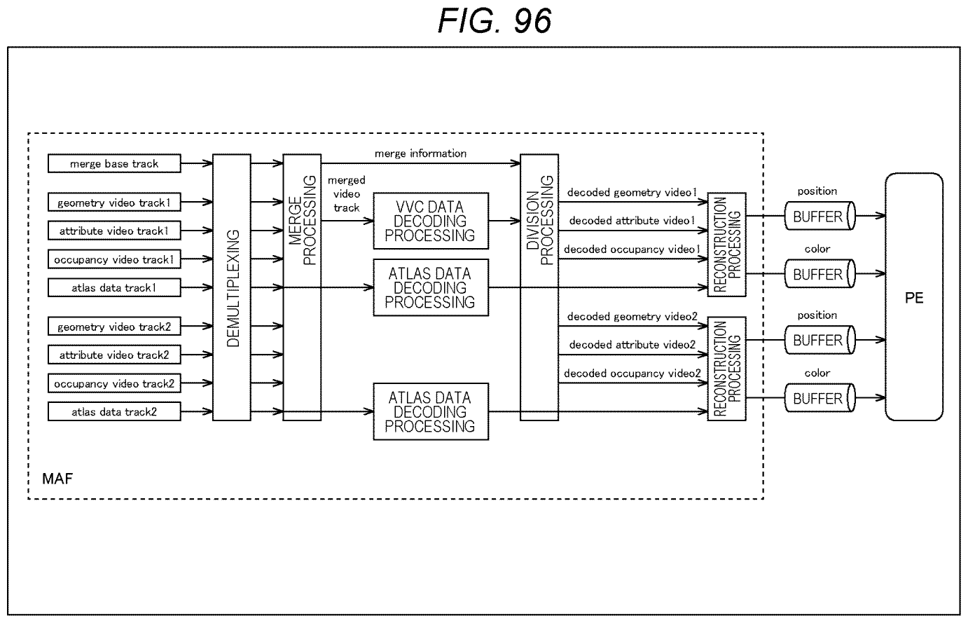

In the reproduction device 650, processing as illustrated in FIG. 96 is executed. That is, the MAF acquires the bitstream of each track, demultiplexes the bitstream, and performs merge processing on the bitstreams of the video components of the plurality of objects. Then, the MAF performs VVC data decoding processing, and decodes the merged bitstream as one bitstream. Furthermore, the MAF also decodes atlas data for each object. The MAF performs division processing on the basis of the merge information, and divides the decoded data of the merged video component into video components. Then, the MAF reconstructs the 3D data and stores the 3D data in a buffer. The PE obtains the 3D data via the buffer and renders it to generate and display display information.

### <Flow of Reproduction Processing>

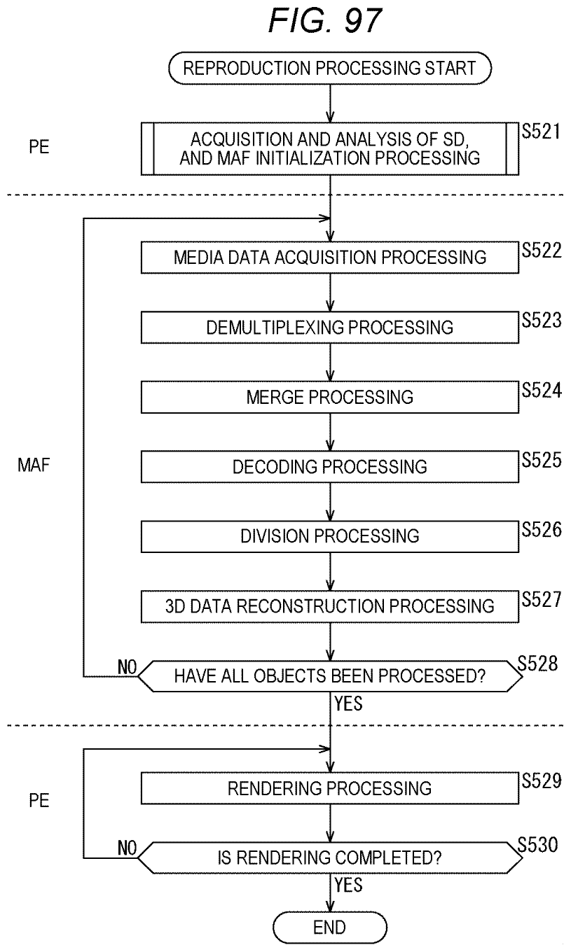

An example of a flow of reproduction processing executed by the reproduction device 650 to which Method 1-5 is applied will be described with reference to a flowchart of FIG. 97.

When the reproduction processing is started, the SD acquisition unit 661 and the SD parsing unit 662 execute the MAF initialization processing in step S521. In the MAF initialization processing, acquisition of a scene description, parsing of the scene description, initialization of the MAF based on the scene description, and the like are performed.

In step S522, the file acquisition unit 361 executes media data acquisition processing to acquire media data.

In step S523, the file acquisition unit 361 performs demultiplexing by performing demultiplexing processing.

In step S524, the merge processing unit 362 executes merge processing to merge the bitstreams of the video components of the plurality of objects.

In step S525, the decoding unit 363 performs decoding processing and performs decoding.

In step S526, the division unit 364 executes division processing and divides the video component.

In step S527, the reconstruction unit 365 executes 3D data reconstruction processing to reconstruct the 3D data.

In step S528, the SD parsing unit 662 determines whether or not all objects of the scene description have been processed. In a case where it is determined that there is an object not yet processed, the processing returns to step S522 and subsequent processing is repeated. In a case where it is determined in step S528 that all the objects have been processed, the processing proceeds to step S528.

In step S529, the display processing unit 366 executes rendering processing, arranges the reconstructed 3D data of each object in a three-dimensional space on the basis of the scene description, renders the 3D data, and generates display information. Then, the display information is displayed on a display device and the like.

In step S530, the display processing unit 366 determines whether or not to end the rendering processing. In a case where it is determined not to end the processing, the processing returns to step S529, and the rendering processing is continued. Furthermore, in a case where it is determined in step S530 that the rendering processing is to be ended, the reproduction processing is ended.

Note that, as illustrated in FIG. 97, the MAF initialization processing in step S521 is executed by a presentation engine (PE). Furthermore, the media data acquisition processing in step S522, the demultiplexing processing in step S523, the merge processing in step S524, the decoding processing in step S525, the division processing in step S526, the 3D data reconstruction processing in step S527, and the determination processing in step S528 are executed by a media access function (MAF). Furthermore, the rendering processing in step S529 and the determination processing in step S530 are executed by the presentation engine (PE).

### <Flow of MAF Initialization Processing>

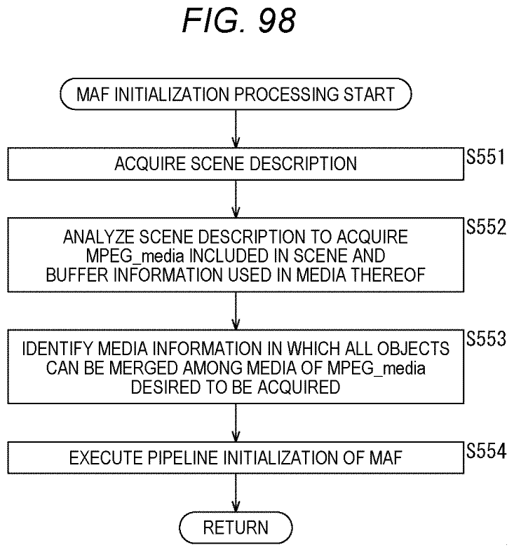

Next, an example of a flow of MAF initialization processing executed in step S521 of FIG. 97 will be described with reference to a flowchart of FIG. 98.

When the MAF initialization processing is started, the SD acquisition unit 661 acquires a scene description in step S551.

In step S552, the SD parsing unit 662 parses the scene description and acquires MPEG_media included in the scene and buffer information used in the media.

In step S553, the SD parsing unit 662 identifies media information in which all objects can be merged among media of MPEG_media desired to be acquired. For example, the SD parsing unit 662 acquires all entries of MPEG_media, and controls the file acquisition unit 361 and the MPD acquisition unit 461 to acquire all MPD/MP4.

In the case of the MPD, the file acquisition unit 361 acquires MP4 of the representation in which @codec is “vvc1”. Under the control of the SD parsing unit 662, the file acquisition unit 361 selects MP4 having a track reference “subp” from the acquired MP4. The file acquisition unit 361 parses the MP4 having subp, and acquires track_id of the video component track to be merged with reference information of the spor sample group (indicating track_id of MP4). In this way, the MPD file of all the objects is acquired, the video component information is acquired, track_id in the file is acquired, and the SD parsing unit 662 identifies whether the file is to be merged across a plurality of objects.

In step S554, the SD parsing unit 662 executes pipeline initialization of the MAF. For example, the SD parsing unit 662 generates a pipeline of buffer information (attribute type and the like) associated with media information (mimetype, uri, reference track, codecs) in MAF by using MediaInfo of MPEG_media.

When the processing of step S554 ends, the MAF initialization processing ends.

By doing so, in the 6DoF content distribution, it is conceivable that the 3D space including the plurality of pieces of 3D model data is configured by data obtained by encoding the spatial arrangement information with the MPEG-I Scene Description and the 3D model data with the V-PCC codec. In this case, in an approach in which one decoder instance is required for current one piece of V-PCC content, the number of decoder instances corresponding to the number of pieces of V-PCC content existing in space is required. However, by merging the video components of the plurality of objects as described above, even a client whose number of decoder instances is smaller than the number of pieces of V-PCC content can decode all V-PCCs, reconstruct 3D data, and completely reconstruct a scene.

### Method 1-5-1

In the case of the MAF initialization processing of FIG. 98, in order to perform processing of identifying a merge base file in which all video components can be merged, acquisition and parsing of MPD/MP4, which is not conventionally performed in a presentation engine, needs to be performed. Therefore, information indicating that the entry of the merge base track of MPEG_media of the scene description is an entry in which video components of all V-PCC content can be merged may be signaled. That is, in a case where Method 1-5 is applied, as shown in the second row from the top of the table in FIG. 41, information indicating that video components can be merged may be transmitted in the SD (Method 1-5-1).

For example, in the file generation device 600, the SD generation unit 611 may store “description indicating that video components of a plurality of objects can be merged” in the scene description.

For example, in the reproduction device 650, the SD parsing unit 662 may identify media of merge information for merging a plurality of objects in MPEG_media of a scene description on the basis of “description indicating that video components of a plurality of objects can be merged” stored in the scene description. The merge processing unit 362 may merge the bitstreams of the plurality of objects on the basis of the identified merge information.

### Method 1-5-1-1

In a case where Method 1-5-1 is applied, as shown in the third row from the top of the table in FIG. 41, information indicating whether the media indicated by the uri can collectively decode all the video components may be transmitted as the information indicating that the video components can be merged (Method 1-5-1-1).

For example, the above “description indicating that video components of a plurality of objects can be merged” may be flag information indicating whether the media indicated by the uri can collectively decode all the video components.

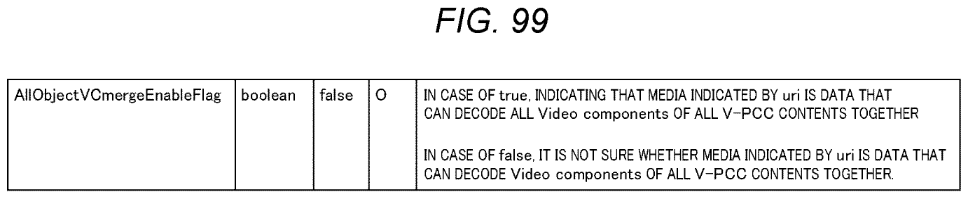

For example, AllobjectVCmergeEnableFlag may be defined in the scene description. As illustrated in FIG. 99, this AllObjectVCmergeEnableFlag is flag information indicating whether the media indicated by the uri can or may not decode all video components of all objects (V-PCC content) together.

### Method 1-5-1-1-1

In a case where Method 1-5-1-1 is applied, as shown in the fourth row from the top of the table in FIG. 41, in the alternatives array of MPEG_media.media.alternatives, information indicating whether the media indicated by the uri can collectively decode all video components may be defined as an extension parameter of the extraParams object (Method 1-5-1-1-1).

For example, the SD generation unit 611 of the file generation device 600 may define the above “flag information indicating whether the media represented by the uri can collectively decode all video components” as an extended object of MPEG_media.media.alternatives of the scene description. The SD parsing unit 662 of the reproduction device 650 may refer to the flag information stored in MPEG_media.media.alternatives.

For example, as an extended object of MPEG_media.media.alternatives in the scene description, an object of the VPCCMediaInfo extension that provides supplement information of the V-PCC-related media to be referred to may be additionally defined. Then, AllObjectVCmergeEnableFlag indicating that Video Components of all V-PCC content can be merged into Item of the VPCCMediaInfo extension object may be defined.

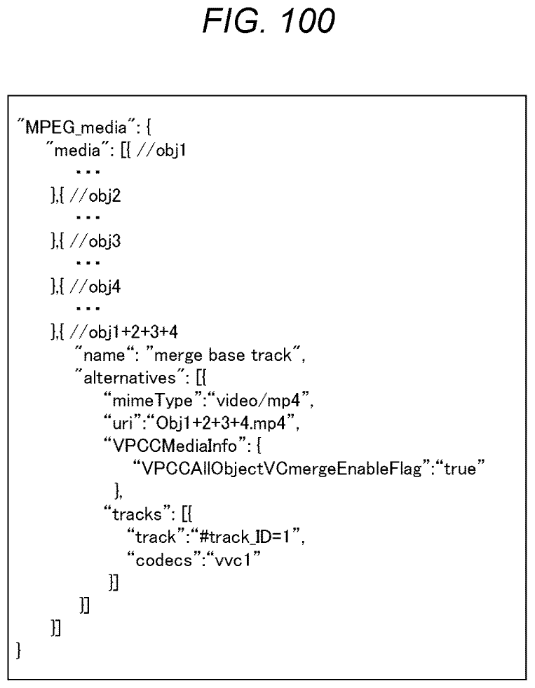

FIG. 100 is a diagram illustrating a description example of MPEG_media. As illustrated in FIG. 100, VPCCMediaInfo is defined as an extended object of MPEG_media.media.alternatives, and AllObjectVCmergeEnableFlag is defined therein. This AllObjectVCmergeEnableFlag indicates that Obj1+2+3+4.mp4 indicated by the uri of MPEG_media is a file that can merge video components of all V-PCC.

In this case, in step S553 of the MAF initialization processing of FIG. 98, the SD parsing unit 662 acquires all the entries of MPEG_media, and performs identification on the basis of whether AllObjectVCmergeEnableFlag=true in VPCCMediaInfo.

By doing so, a client that cannot decode a plurality of video components even in content in a 3D space including a plurality of pieces of V-PCC content can easily determine whether or not a scene can be reconstructed by the AllobjectVCmergeEnableFlag of the scene description.

### Method 1-5-1-1-2

In a case where Method 1-5-1-1 is applied, as shown in the fifth row from the top of the table in FIG. 41, in MPEG_media.media, information indicating whether the media indicated by the uri can collectively decode all video components may be defined as an extension parameter of the extraParams object (Method 1-5-1-1-2).

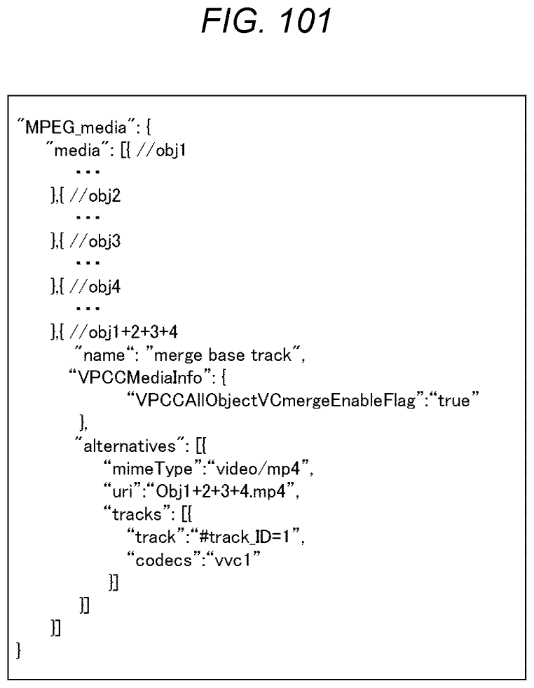

FIG. 101 illustrates a description example of MPEG_media of the scene description. In this example, VPCCMediaInfo is set as an extension parameter of MPEG_media.media, and AllObjectVCmergeEnableFlag is defined as the object.

For example, the SD generation unit 611 of the file generation device 600 may define the above “flag information indicating whether the media represented by the uri can collectively decode all video components” as an extended object of MPEG_media.media of the scene description. The SD parsing unit 662 of the reproduction device 650 may refer to the flag information stored in MPEG_media.media.

By doing so, a client that cannot decode a plurality of video components even in content in a 3D space including a plurality of pieces of V-PCC content can easily determine whether or not a scene can be reconstructed by the AllObjectVCmergeEnableFlag of the scene description. Furthermore, it can be used as signaling common to all media indicated by alternatives, and the size of the glTF file can be reduced.

### Method 1-5-1-1-3

In a case where Method 1-5-1-1 is applied, as shown in the sixth row from the top of the table in FIG. 41, in MPEG_media.media.alternatives.tracks, information indicating whether the media indicated by the uri can collectively decode all video components may be defined as an extension parameter of the extraParams object (Method 1-5-1-1-3).

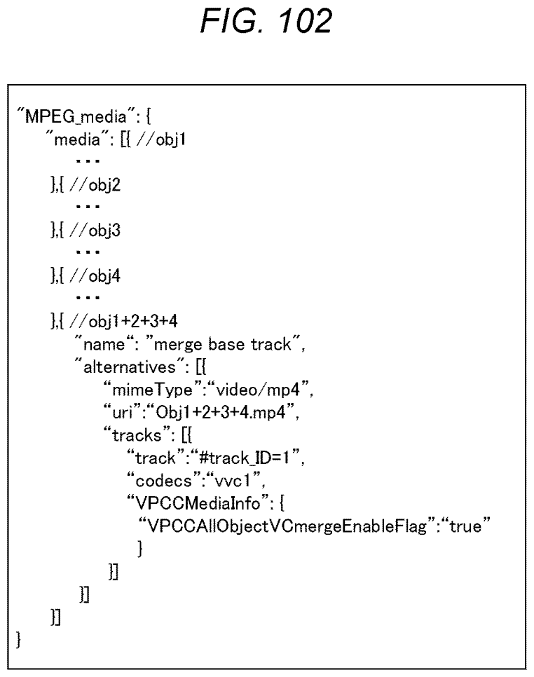

FIG. 102 illustrates a description example of MPEG_media of the scene description. In this example, VPCCMediaInfo is set as an extension parameter of the track array of MPEG_media.media.alternatives.tracks, and AllObjectVCmergeEnableFlag is defined as an object thereof.

For example, the SD generation unit 611 of the file generation device 600 may define the above “flag information indicating whether the media represented by the uri can collectively decode all video components” as an extended object of MPEG_media.media.alternatives.tracks of the scene description. The SD parsing unit 662 of the reproduction device 650 may refer to the flag information stored in MPEG_media.media.alternatives.tracks.

By doing so, a client that cannot decode a plurality of video components even in content in a 3D space including a plurality of pieces of V-PCC content can easily determine whether or not a scene can be reconstructed by the AllobjectVCmergeEnableFlag of the scene description.

### Method 1-5-1-2

In a case where Method 1-5-1 is applied, as shown in the seventh row from the top of the table in FIG. 41, information indicating an index of a video component to be merged may be transmitted as information indicating that the video component can be merged (Method 1-5-1-2).

For example, the above “description indicating that video components of a plurality of objects can be merged” may be information indicating an index of a video component to be merged.

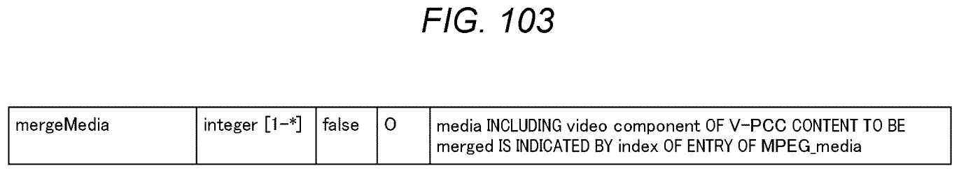

For example, mergeMedia may be defined in the scene description. As illustrated in FIG. 103, this mergeMedia is information indicating media including a video component of an object (V-PCC content) to be merged, with an index (index) of an entry of MPEG_media. That is, mergeMedia is association information to each video component entered in the merge information.

### Method 1-5-1-2-1

In a case where Method 1-5-1-2 is applied, as shown in the eighth row from the top of the table in FIG. 41, information indicating an index of a video component to be merged may be defined in the alternatives array of MPEG_media.media.alternatives, as an extension parameter of the extraParams object (Method 1-5-1-2-1).

For example, the SD generation unit 611 of the file generation device 600 may define the above “information indicating the index of the video component to be merged” as the extended object of MPEG_media.media.alternatives of the scene description. The SD parsing unit 662 of the reproduction device 650 may refer to the information stored in MPEG_media.media.alternatives.

For example, association information to media including a video component track (video component track(s)) of V-PCC to be merged into an entry of a merge base track (merge base track) of MPEG_media may be added to the scene description. For example, an object of the VPCCMediaInfo extension that provides supplement information of the V-PCC content to be referred to may be additionally defined as an extended object of MPEG_media.media.alternatives. Then, mergeMedia may be defined in which an array of index values of media of MPEG_media including the video component track (Video Component track) of the V-PCC content merged by the merge base track into Item of the VPCCMediaInfo extension object is used as association information.

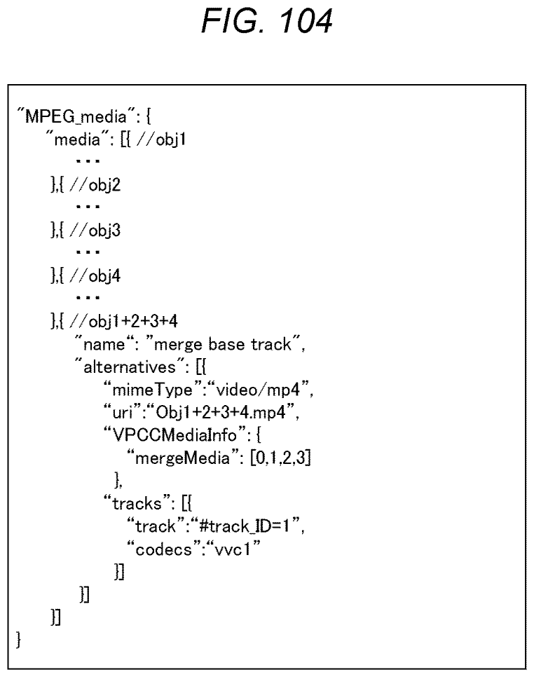

FIG. 104 is a diagram illustrating a description example of MPEG_media. As illustrated in FIG. 104, Obj1+2+3+4.mp4 indicated by the uri of MPEG_media indicates that the index values of the entries of the media indicated by mergeMedia indicate entries of media of Obj1, Obj2, Obj3, and Obj4, and indicate that the video components included in these are files that can be merged.

In this case, in step S553 of the MAF initialization processing of FIG. 98, the SD parsing unit 662 acquires all the entries of MPEG_media, and performs identification by confirming that all V-PCC content is included from the value of mergeMedia of VPCCMediaInfo.

By doing so, in the content in the 3D space including the plurality of pieces of V-PCC content, the client that cannot decode the plurality of video components can easily determine whether the scene can be reconstructed only by the information of mergeMedia of the scene description. Moreover, in addition to merging video components of all V-PCC content, it is possible to indicate merging of video components of specific V-PCC content, and it is also possible for a client having a plurality of decoder instances to distribute processing according to the capability of each decoder instance.

### Method 1-5-1-2-2

In a case where Method 1-5-1-2 is applied, as shown in the ninth row from the top of the table in FIG. 41, information indicating an index of a video component to be merged may be defined in the MPEG_media.media, as an extension parameter of the extraParams object (Method 1-5-1-2-2).

For example, the SD generation unit 611 of the file generation device 600 may define the above “information indicating the index of the video component to be merged” as the extended object of MPEG_media.media of the scene description. The SD parsing unit 662 of the reproduction device 650 may refer to the information stored in MPEG_media.media.

By doing so, in the content in the 3D space including the plurality of pieces of V-PCC content, the client that cannot decode the plurality of video components can easily determine whether the scene can be reconstructed only by the information of mergeMedia of the scene description. Moreover, in addition to merging video components of all V-PCC content, it is possible to indicate merging of video components of specific V-PCC content, and it is also possible for a client having a plurality of decoder instances to distribute processing according to the capability of each decoder instance. Furthermore, it can be used as signaling common to all media indicated by alternatives, and the size of the glTF file can be reduced.

### Method 1-5-1-2-3

In a case where Method 1-5-1-2 is applied, as shown in the bottom row of the table in FIG. 41, information indicating an index of a video component to be merged may be defined in MPEG_media.media.alternatives.tracks as an extension parameter of the extraParams object (Method 1-5-1-2-3).

For example, the SD generation unit 611 of the file generation device 600 may define the above “information indicating the index of the video component to be merged” as the extended object of MPEG_media.media.alternatives.tracks of the scene description. The SD parsing unit 662 of the reproduction device 650 may refer to the information stored in MPEG_media.media.alternatives.tracks.

By doing so, in the content in the 3D space including the plurality of pieces of V-PCC content, the client that cannot decode the plurality of video components can easily determine whether the scene can be reconstructed only by the information of mergeMedia of the scene description. Moreover, in addition to merging video components of all V-PCC content, it is possible to indicate merging of video components of specific V-PCC content, and it is also possible for a client having a plurality of decoder instances to distribute processing according to the capability of each decoder instance.

### Method 1-5-1-3

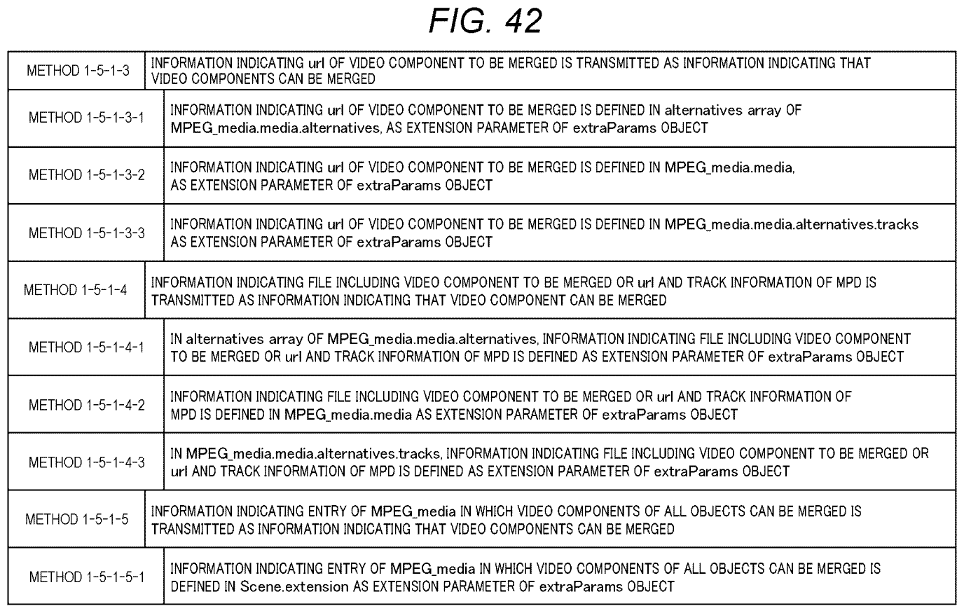

In a case where Method 1-5-1 is applied, as shown at the top of the table in FIG. 42, information indicating a url of a video component to be merged may be transmitted as information indicating that the video components can be merged (Method 1-5-1-3).

For example, the above “description indicating that video components of a plurality of objects can be merged” may be information indicating a url of a video component to be merged.

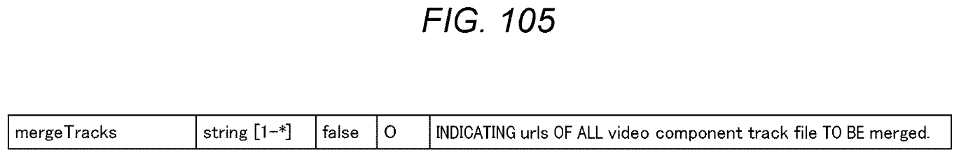

For example, mergeTracks may be defined in the scene description. As illustrated in FIG. 105, this mergeTracks is information indicating urls of all video components (video component track file) to be merged.

### Method 1-5-1-3-1

In a case where Method 1-5-1-3 is applied, as shown in the second row from the top of the table in FIG. 42, information indicating a url of a video component to be merged may be defined in the alternatives array of MPEG_media.media.alternatives, as an extension parameter of the extraParams object (Method 1-5-1-3-1).

For example, the SD generation unit 611 of the file generation device 600 may define the above “information indicating a url of the video component to be merged” as the extended object of MPEG_media.media.alternatives of the scene description. The SD parsing unit 662 of the reproduction device 650 may refer to the flag information stored in MPEG_media.media.alternatives.

For example, mergeTracks may be defined which indicates a list of urls of the video component track (Video Component track) of the V-PCC content merged by the merge base track into Item of the VPCCMediaInfo extension object of the scene description.

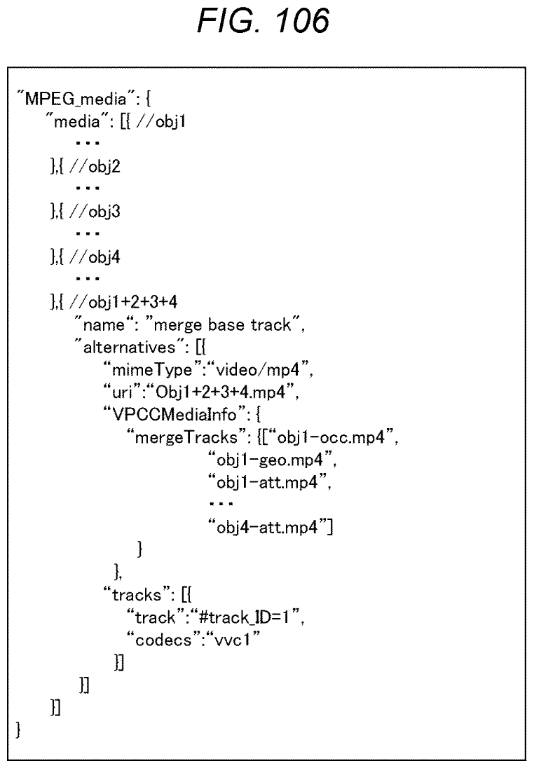

FIG. 106 is a diagram illustrating a description example of MPEG_media. As illustrated in FIG. 106, Obj1+2+3+4.mp4 indicated by the uri in the media entry of MPEG_media indicates that the MP4 file group of the video component indicated by mergeTracks can be merged.

In this case, in step S553 of the MAF initialization processing of FIG. 98, the SD parsing unit 662 acquires all the entries of MPEG_media, and acquires a list of video component tracks (video component track) from mergeTrack of VPCCMediaInfo. The SD parsing unit 662 parses the MPD referred to from the MPEG_media entry of each V-PCC content, specifies the adaptation set of the video component from the preselection of the atlas adaptation set, acquires the url, and confirms whether the acquired list of the video component tracks is included. The SD parsing unit 662 performs this processing on all the V-PCC content and identifies whether the video components of all the V-PCC content can be merged.

By doing so, in the content in the 3D space including the plurality of pieces of V-PCC content, the client that cannot decode the plurality of video components can easily determine whether the scene can be reconstructed only by the scene description and the information of the MPD. The MPD needs to be parsed, but the MP4 does not need to be parsed, which is easy. Moreover, in addition to merging video components of all V-PCC content, it is possible to indicate merging of video components of specific V-PCC content, and it is also possible for a client having a plurality of decoder instances to distribute processing according to the capability of each decoder instance.

### Method 1-5-1-3-2

In a case where Method 1-5-1-3 is applied, as shown in the third row from the top of the table in FIG. 42, information indicating a url of a video component to be merged may be defined in the MPEG_media.media, as an extension parameter of the extraParams object (Method 1-5-1-3-2).

For example, the SD generation unit 611 of the file generation device 600 may define the above “information indicating the url of the video component to be merged” as the extended object of MPEG_media.media of the scene description. The SD parsing unit 662 of the reproduction device 650 may refer to the flag information stored in MPEG_media.media.

By doing so, in the content in the 3D space including the plurality of pieces of V-PCC content, the client that cannot decode the plurality of video components can easily determine whether the scene can be reconstructed only by the scene description and the information of the MPD. The MPD needs to be parsed, but the MP4 does not need to be parsed, which is easy. Moreover, in addition to merging video components of all V-PCC content, it is possible to indicate merging of video components of specific V-PCC content, and it is also possible for a client having a plurality of decoder instances to distribute processing according to the capability of each decoder instance. Moreover, it can be used as signaling common to all media indicated by alternatives, and the size of the glTF file can be reduced.

### Method 1-5-1-3-3

In a case where Method 1-5-1-3 is applied, as shown in the fourth row from the top of the table in FIG. 42, information indicating a url of a video component to be merged may be defined in MPEG_media.media.alternatives.tracks as an extension parameter of the extraParams object (Method 1-5-1-3-3).

For example, the SD generation unit 611 of the file generation device 600 may define the above “information indicating the url of the video component to be merged” as the extended object of MPEG_media.media.alternatives.tracks of the scene description. The SD parsing unit 662 of the reproduction device 650 may refer to the flag information stored in MPEG_media.media.alternatives.tracks.

By doing so, in the content in the 3D space including the plurality of pieces of V-PCC content, the client that cannot decode the plurality of video components can easily determine whether the scene can be reconstructed only by the scene description and the information of the MPD. The MPD needs to be parsed, but the MP4 does not need to be parsed, which is easy. Moreover, in addition to merging video components of all V-PCC content, it is possible to indicate merging of video components of specific V-PCC content, and it is also possible for a client having a plurality of decoder instances to distribute processing according to the capability of each decoder instance.

### Method 1-5-1-4

In a case where Method 1-5-1 is applied, as shown in the fifth row from the top of the table in FIG. 42, information indicating a file including a video component to be merged or a url and track information of an MPD may be transmitted as information indicating that the video component can be merged (Method 1-5-1-4).

For example, the above “description indicating that video components of a plurality of objects can be merged” may be information indicating a url and a track of a file including a video component to be merged or a control file for controlling distribution of the video component.

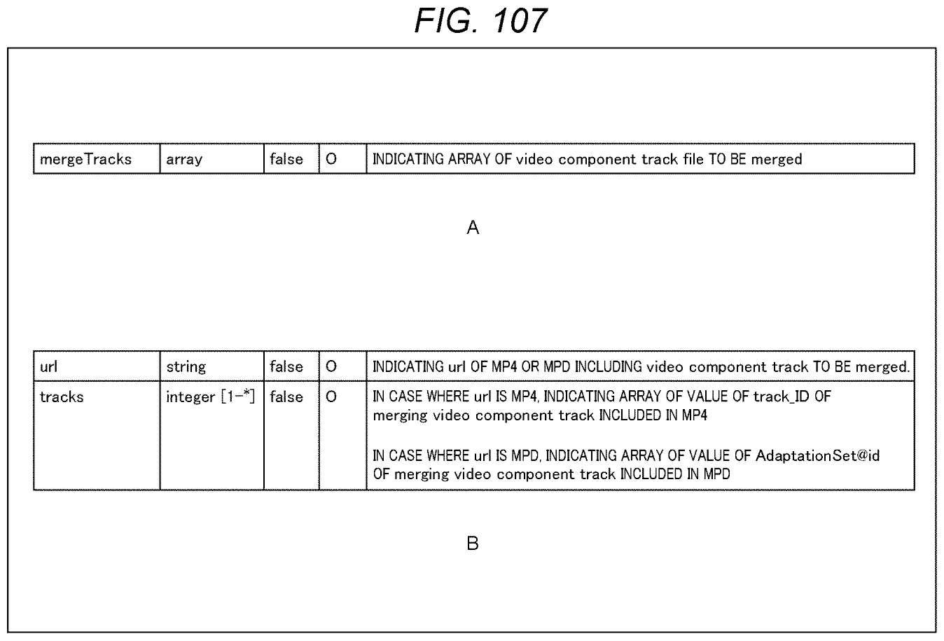

For example, mergeTracks may be defined in the scene description. As illustrated in A of FIG. 107, this mergeTracks is information indicating a file (video component track file) that stores a video component to be merged. Items include an url and a track. As illustrated in B of FIG. 107, this url is information indicating the url of the file (MP4) including the track (video component track) storing the video component to be merged or the MPD. As illustrated in B of FIG. 107, in a case where the url is a file (MP4), Tracks are information indicating an array of track ID of the video component track (video component track) to be merged included in the file. In a case where the url is an MPD, the url is information indicating an array of AdaptationSet@id of the video component track (video component track) to be merged included in the MPD.

### Method 1-5-1-4-1

In a case where Method 1-5-1-4 is applied, as shown in the sixth row from the top of the table in FIG. 42, in the alternatives array of MPEG_media.media.alternatives, information indicating a file including a video component to be merged or a url and track information of an MPD may be defined as an extension parameter of the extraParams object (Method 1-5-1-4-1).

For example, the SD generation unit 611 of the file generation device 600 may define the above “information indicating url and track of file including video component to be merged or control file for controlling distribution of video component” as an extended object of MPEG_media.media.alternatives of the scene description. The SD parsing unit 662 of the reproduction device 650 may refer to the information stored in MPEG_media.media.alternatives.

For example, mergeTracks indicating a list of MP4 including the video component track of the V-PCC content (Video Component track) to be merged by merge base track into Item of the VPCCMediaInfo extension object of the scene description or the url information and track information of MPD may be defined.

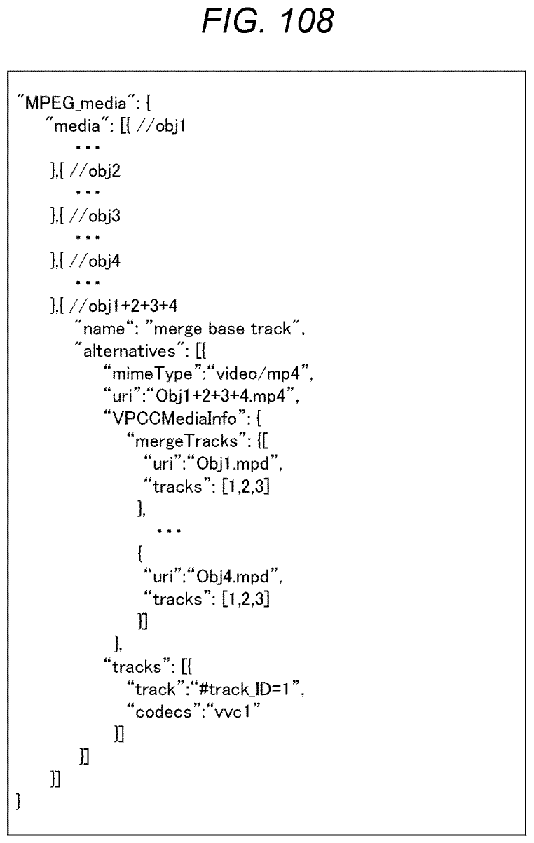

FIG. 108 is a diagram illustrating a description example of MPEG_media. As illustrated in FIG. 108, Obj1+2+3+4.mp4 indicated by the uri in the entry of the media of MPEG_media indicates that the video components of the adaptation set (for example, AdapttionSet@id of obj1.mpd is 1, 2, or 3) in the file (for example, obj1.mpd) indicated by the url indicated by mergeTracks can be merged.

In this case, in step S553 of the MAF initialization processing of FIG. 98, the SD parsing unit 662 acquires all the entries of MPEG_media, and checks whether the url of the array of mergeTracks of VPCCMediaInfo matches the url of the entry of MPEG_media. This processing is performed for all objects to identify whether all objects can be merged.

By doing so, in the content in the 3D space including the plurality of pieces of V-PCC content, the client that cannot decode the plurality of video components can easily determine whether the scene can be reconstructed only by the information of the scene description. Moreover, in addition to merging video components of all V-PCC, it is possible to indicate merging of video components of specific V-PCC, and it is also possible for a client having a plurality of decoder instances to distribute processing according to the capability of each decoder instance.

### Method 1-5-1-4-2

In a case where Method 1-5-1-4 is applied, as shown in the seventh row from the top of the table in FIG. 42, information indicating a file including a video component to be merged or a url and track information of an MPD may be defined in MPEG_media.media as an extension parameter of an extraParams object (Method 1-5-1-4-2).

For example, the SD generation unit 611 of the file generation device 600 may define the above “information indicating url and track of file including video component to be merged or control file for controlling distribution of video component” as an extended object of MPEG_media.media of the scene description. The SD parsing unit 662 of the reproduction device 650 may refer to the flag information stored in MPEG_media.media.

By doing so, in the content in the 3D space including the plurality of pieces of V-PCC content, the client that cannot decode the plurality of video components can easily determine whether the scene can be reconstructed only by the information of the scene description. Moreover, in addition to merging video components of all V-PCC, it is possible to indicate merging of video components of specific V-PCC, and it is also possible for a client having a plurality of decoder instances to distribute processing according to the capability of each decoder instance. Moreover, it can be used as signaling common to all media indicated by alternatives, and the size of the glTF file can be reduced.

### Method 1-5-1-4-3

In a case where Method 1-5-1-4 is applied, as shown in the eighth row from the top of the table in FIG. 42, in MPEG_media.media.alternatives.tracks, information indicating a file including a video component to be merged or a url and track information of an MPD may be defined as an extension parameter of the extraParams object (Method 1-5-1-4-3).

For example, the SD generation unit 611 of the file generation device 600 may define the above “information indicating url and track of file including video component to be merged or control file for controlling distribution of video component” as an extended object of MPEG_media.media.alternatives.tracks of the scene description. The SD parsing unit 662 of the reproduction device 650 may refer to the flag information stored in MPEG_media.media.alternatives.tracks.

By doing so, in the content in the 3D space including the plurality of pieces of V-PCC content, the client that cannot decode the plurality of video components can easily determine whether the scene can be reconstructed only by the information of the scene description. Moreover, in addition to merging video components of all V-PCC, it is possible to indicate merging of video components of specific V-PCC, and it is also possible for a client having a plurality of decoder instances to distribute processing according to the capability of each decoder instance.

### Method 1-5-1-5

In a case where Method 1-5-1 is applied, as shown in the ninth row from the top of the table in FIG. 42, information indicating an entry of MPEG_media in which video components of all objects can be merged may be transmitted as information indicating that the video components can be merged (Method 1-5-1-5).

For example, the above “description indicating that video components of a plurality of objects can be merged” may be information indicating an entry of MPEG_media in which the video components of the plurality of objects can be merged.

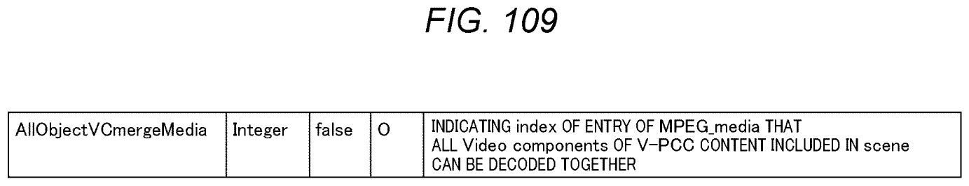

For example, AllobjectVCmergeMedia may be defined in the scene description. As illustrated in FIG. 109, this AllObjectVCmergeMedia is information indicating an index of an entry of MPEG_media that can collectively decode all video components of the V-PCC content included in a scene.

### Method 1-5-1-5-1

In a case where Method 1-5-1-5 is applied, as shown in the bottom row of the table in FIG. 42, information indicating an entry of MPEG_media in which video components of all objects can be merged may be defined in Scene.extension as an extension parameter of the extraParams object (Method 1-5-1-5-1).

For example, the SD generation unit 611 of the file generation device 600 may define the above “information indicating entry of MPEG_media in which video components of a plurality of objects can be merged” as the extended object of the Scene.extension of the scene description. The SD parsing unit 662 of the reproduction device 650 may refer to the information stored in the Scene.extension.

For example, association information to media that can be merged may be added to the Scene object of the scene description. For example, an object of MPEG VPCCMediaInfo extension that provides supplement information of V-PCC media associated with the Scene may be additionally defined in the extension of the Scene object. Then, AllObjectVCmergeMedia indicating an entry of MPEG_media in which video components of all V-PCC content can be merged may be defined in Item of the MPEG VPCCMediaInfo extension object.

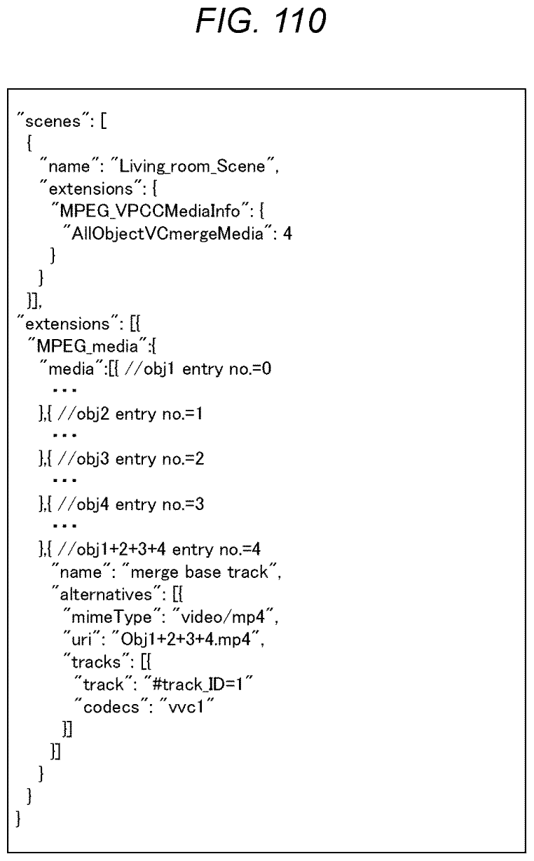

FIG. 110 is a diagram illustrating a description example of MPEG_media. As illustrated in FIG. 110, an entry indicating index=4 of MPEG_media, that is, Obj1+2+3+4.mp4, in which the value of AllObjectVCmergeMedia of MPEG VPCCMediaInfo included in the extension of Scene is 4, is a file in which video components of all V-PCCs can be merged.

In this case, in step S553 of the MAF initialization processing of FIG. 98, the SD parsing unit 662 performs identification with a value of an index of MPEG_media indicated by AllObjectVCmergeMedia of MPEG_VPCCMediaInfo of the Scene object.

By doing so, in the content in the 3D space including the plurality of pieces of V-PCC content, the client that cannot decode the plurality of video components can easily determine whether the scene can be reconstructed only by the value of AllobjectVCmergeMedia of Scene of the scene description.

Note that the Node object may be extended to define MPEG_VPCCMediaInfo or AllObjectVCmergeMedia.

### Method 1-5-1-6

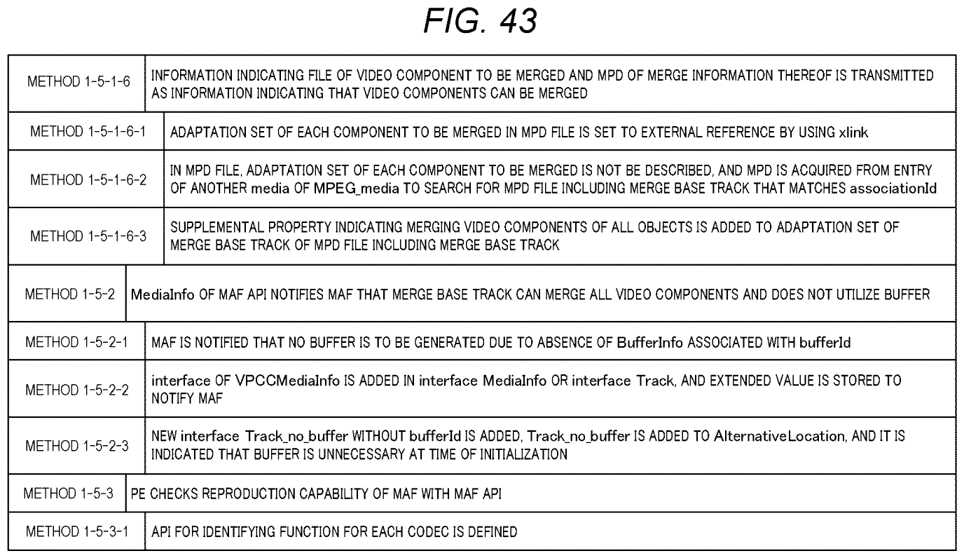

In a case where Method 1-5-1 is applied, as shown at the top of the table in FIG. 43, information indicating the file of the video component to be merged and the MPD of the merge information thereof may be transmitted as information indicating that the video components can be merged (Method 1-5-1-6).

For example, the above “description indicating that video components of a plurality of objects can be merged” may be information indicating a control file that controls distribution of the video components and the merge information of all the objects to be merged. For example, the MPD generation unit 411 of the file generation device 600 may generate a control file (MPD) that controls distribution of video components of all objects to be merged and merge information thereof. The SD generation unit 611 may store information indicating the MPD in the scene description as “description indicating that video components of a plurality of objects can be merged”. The SD parsing unit 662 of the reproduction device 650 may acquire the MPD designated by the information.

A file referred to from an entry of a merge base track of MPEG_media in a scene description may be set as an MPD including the merge base track, and information may be signaled in the MPD. For example, an MPD file including all the merge base track and the Atlas, Occupancy, Geometry, and Attribute tracks of the V-PCC to be merged may be generated and referred to from MPEG_media. At that time, an adaptation set of the merge base track may be referred to from the tracks of alternatives.tracks. The representation information of the video component to be merged may be associated with the representation of the merge base track of the MPD file by using @associationId. At that time, “subp” may be used as @associationType.

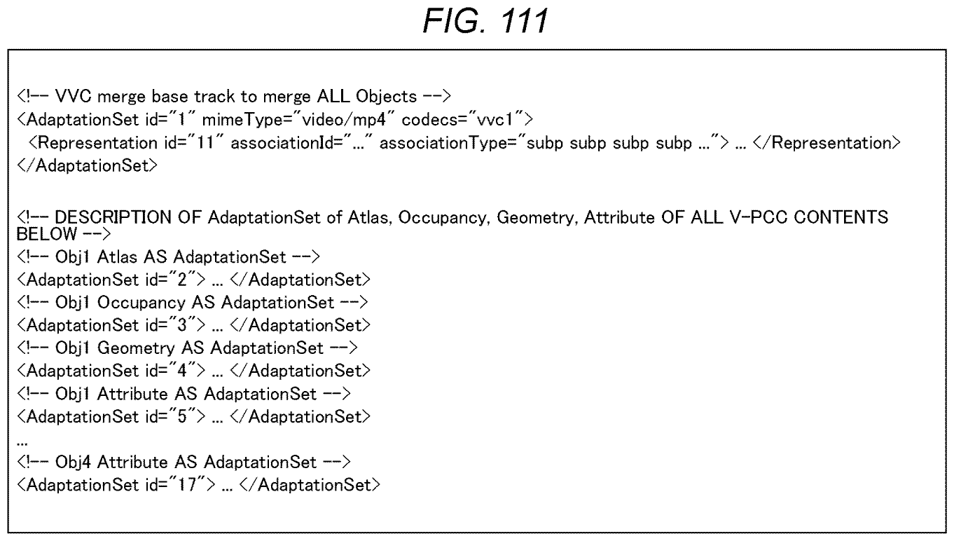

FIG. 111 is a diagram illustrating a description example of MPEG_media. As illustrated in FIG. 111, the media entry of MPEG_media of a merge base track indicates that AdaptationSet@id=1 of Obj1+2+3+4.mpd is a merge base track from the uri and the track. The MPD file indicates a video component track associated with representaiton@associationId and representaiton@associationType in the representation (representation included in AdaptationSet@id=1) of the merge base track.

In this case, in step S553 of the MAF initialization processing of FIG. 98, the SD parsing unit 662 may acquire all entries of MPEG_media, acquire the MPD from the url, and acquire the adaptation set indicated by the track. In a case where subp is included in Representation@associationType, it may be identified as a merge base track. Moreover, it is confirmed whether the representation associated with Representation@associationType includes the same url as the information of the V-PCC content referred to by other MPEG_media, and it is identified that the video components of all the V-PCC content can be merged.

By doing so, in the content in the 3D space configured of the plurality of pieces of V-PCC content, the client that cannot decode the plurality of video components can easily determine whether the scene can be reconstructed only by the information of the scene description and the MPD. The MPD needs to be parsed, but the MP4 does not need to be parsed, so that the processing is easy. Moreover, in addition to merging video components of all V-PCC, it is possible to indicate merging of video components of specific V-PCC, and it is also possible for a client having a plurality of decoder instances to distribute processing according to the capability of each decoder instance.

### Method 1-5-1-6-1

In a case where Method 1-5-1-6 is applied, as shown in the second row from the top of the table in FIG. 43, the adaptation set of each component to be merged in the MPD file may be set to external reference by using xlink (Method 1-5-1-6-1).

For example, the MPD generation unit 411 of the file generation device 600 may generate a control file (MPD) that externally refers to the adaptation set of the video component to be merged. The file acquisition unit 361 of the reproduction device 650 may externally refer to the adaptation set of the video component to be merged on the basis of the MPD.

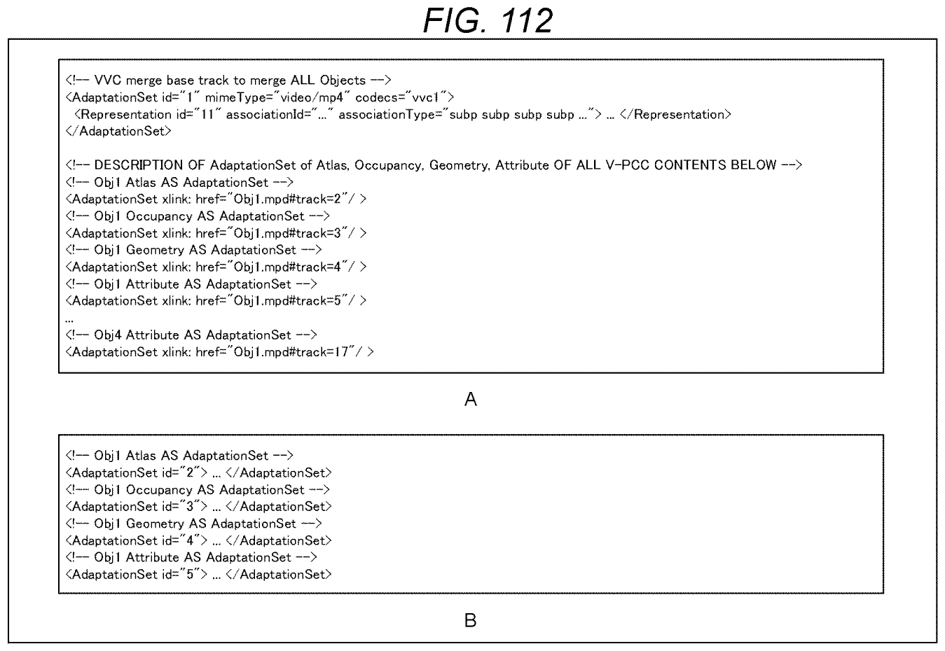

For example, the adaptation set of Atlas, Occupancy, Geometry, Attribute of the V-PCC to be merged in the MPD file may be used as the external reference using xlink. A of FIG. 112 is an example of the MPD (Obj1+2+3+4.mpd) including merge information for merging all objects. Furthermore, B of FIG. 112 is an example of an MPD (Obj1.mpd) for Obj1. As illustrated in A of FIG. 112 and B of FIG. 112, information in these MPDs is associated (externally referred to) using xlink.

By doing so, in the content in the 3D space configured of the plurality of pieces of V-PCC content, the client that cannot decode the plurality of video components can easily determine whether the scene can be reconstructed only by the information of the scene description and the MPD. The MPD needs to be parsed, but the MP4 does not need to be parsed, so that the processing is easy. Moreover, in addition to merging video components of all V-PCC, it is possible to indicate merging of video components of specific V-PCC, and it is also possible for a client having a plurality of decoder instances to distribute processing according to the capability of each decoder instance. Moreover, since which V-PCC content is referred to can be known from the reference file name of the xlink, it is possible to easily specify the V-PCC content used in the merge. Furthermore, the description amount of the MPD including the merge base track can be reduced. Moreover, since the description of the adaptation set is not doubly written in the MPD of the merge base track and the MPD of each object, in a case where there is a change in the adaptation set, it is only necessary to change the MPD of each object, and management becomes easy.

### Method 1-5-1-6-2

In a case where Method 1-5-1-6 is applied, as shown in the third row from the top of the table in FIG. 43, in the MPD file, the adaptation set of each component to be merged may not be described, and the MPD may be acquired from an entry of another media of MPEG_media to search for an MPD file including the merge base track that matches associationId (Method 1-5-1-6-2).

For example, the MPD generation unit 411 of the file generation device 600 may generate the control file (MPD) not including the information indicating the adaptation set of the video component to be merged. The MPD acquisition unit 461 of the reproduction device 650 may acquire the MPD in which the “information indicating the adaptation set of the video component to be merged” is omitted. The file acquisition unit 361 may identify and acquire the video component to be merged without using the information of the MPD.

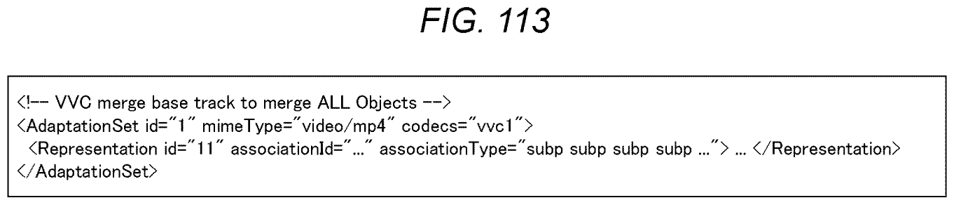

That is, it is not necessary to describe the adaptation set of Atlas, Occupancy, Geometry, Attribute of the V-PCC to be merged in the MPD file including the merge base track. A description example of the MPD in this case is illustrated in FIG. 113. Then, the client may be implemented to obtain the MPD from an entry of another media of MPEG_media and search for an MPD file including the merge base track that matches the associationId.

By doing so, in the content in the 3D space configured of the plurality of pieces of V-PCC content, the client that cannot decode the plurality of video components can easily determine whether the scene can be reconstructed only by the information of the scene description and the MPD. The MPD needs to be parsed, but the MP4 does not need to be parsed, so that the processing is easy. Moreover, in addition to merging video components of all V-PCC, it is possible to indicate merging of video components of specific V-PCC, and it is also possible for a client having a plurality of decoder instances to distribute processing according to the capability of each decoder instance. Moreover, since which V-PCC content is referred to can be known from the reference file name of the xlink, it is possible to easily specify the V-PCC content used in the merge. Furthermore, the description amount of the MPD including the merge base track can be reduced. Moreover, since the description of the adaptation set is not doubly written in the MPD of the merge base track and the MPD of each object, in a case where there is a change in the adaptation set, it is only necessary to change the MPD of each object, and management becomes easy.

### Method 1-5-1-6-3

In a case where Method 1-5-1-6 is applied, as shown in the fourth row from the top of the table in FIG. 43, a supplemental property indicating merging video components of all objects may be added to the adaptation set of the merge base track of the MPD file including the merge base track (Method 1-5-1-6-3).

For example, the MPD generation unit 411 of the file generation device 600 may generate the control file (MPD) including “supplemental property in which merge information indicates that video components of all objects are merged”. The MPD acquisition unit 461 of the reproduction device 650 may acquire the MPD. The file acquisition unit 361 may identify from the merge information whether the video components of all the V-PCC content can be merged on the basis of the “supplemental property in which merge information indicates that video components of all objects are merged” of the MPD.

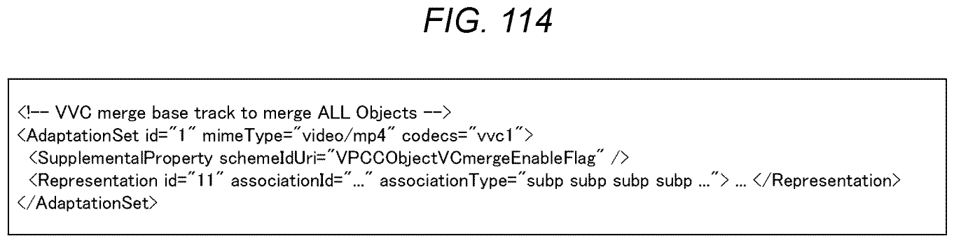

As illustrated in FIG. 114, a supplemental property (SupplementalProperty) indicating merging video components of all V-PCC content may be further added to the adaptation set of the merge base track of the MPD file including the merge base track. This supplemental property defines schemeIdUri=“VPCCObjectVCmergeEnableFlag”, indicating that in the case of being signaled, the video components of all V-PCC content can be merged.

By doing so, since it is known that the video components of all the V-PCC content can be merged only with SupplementalProperty of the MPD including the merge base track, it is possible to easily perform the identification processing without parsing other MPDS. Furthermore, if the semantics of this SupplementalProperty indicates that the video components of a plurality of pieces of V-PCC content can be merged, it can indicate that not all but specific V-PCC content can be merged.

### Method 1-5-2

In step S554 of the MAF initialization processing of FIG. 98, Pipeline of the MAF is initialized. Here, in the existing MAF API, a buffer for the decoded data of the merge base track is generated. From MediaInfo passed to the MAF, it is not known that the file can merge the video components of all objects. To identify that a merge base track is a file that can merge video components of all objects in the MAF, it is necessary to identify that a track referred to from a merge base track is a video component of each object, which may reduce processing efficiency. Furthermore, since the decoded data of the merge base track is divided and written in the buffer of each object on the MAF side, a buffer of unnecessary data which is not used in the PE is secured, and there is a possibility that resources are unnecessarily consumed.

Therefore, it may be signaled that the merge base track can merge all the video components of V-PCC and does not use the buffer in MediaInfo of the MAF API.

For example, in a case where Method 1-5 is applied, as shown in the fifth row from the top of the table of FIG. 43, MediaInfo of the MAF API may notify the MAF that the merge base track can merge all video components and does not utilize a buffer (Method 1-5-2).

For example, the SD generation unit 611 of the file generation device 600 may store, in AlternativeLocation of MediaInfo of the MAF API of the scene description, an interface for the merge information to indicate that all the video components can be merged and an interface for notifying that the buffer is not used. For example, the SD parsing unit 662 of the reproduction device 650 may notify that the merge information indicates that all the video components can be merged, and that the buffer is not used by using the interface stored in AlternativeLocation of MediaInfo of the MAF API.

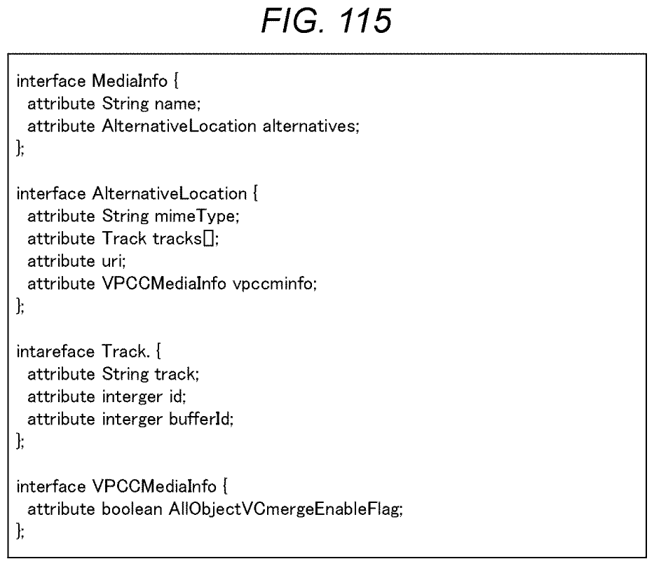

For example, as in the description example illustrated in FIG. 115, an interface of VPCCMediaInfo may be added to AlternativeLocation of MediaInfo of the MAF API. In the VPCCMediaInfo, the extended value may be stored as described above to notify the MAF. Furthermore, the semantics of bufferId may be changed, and in a case where bufferId is a negative value, the buffer may not be generated, and it may be indicated that the buffer is unnecessary at the time of initialization.

In this case, in step S553 of the MAF initialization processing of FIG. 98, the SD parsing unit 662 identifies a merge base track in which VPCCMediaInfo is present in MediaInfo, and further, media of MediaInfo with AllObjectVCmergeEnableFlag=true is capable of merging all V-PCC content.

By doing so, the buffer for the merge base file is not generated, and unnecessary resources are not used. It can be identified that the MAF can merge the video components of all V-PCC content only with the information of MediaInfo without parsing MPD or MP4, and the processing becomes easy.

### Method 1-5-2-1

In a case where Method 1-5-2 is applied, as shown in the sixth row from the top of the table in FIG. 43, the MAF may be notified that no buffer is to be generated due to the absence of BufferInfo associated with bufferId (Method 1-5-2-1).

For example, the SD generation unit 611 of the file generation device 600 may store, in the scene description, bufferId of a value indicating that there is no BufferInfo to be associated. For example, in a case where there is no BufferInfo associated with the semantics of bufferId, the SD parsing unit 662 of the reproduction device 650 may omit generation of the buffer.

The semantics of bufferId in this case is as follows. That is, in a case where there is no BufferInfo associated with bufferId, it indicates that the medium does not require a buffer. That is, it indicates that the media is used in the MAF, but there is no information to be returned to the PE.

### Method 1-5-2-2

In a case where Method 1-5-2 is applied, as shown in the seventh row from the top of the table in FIG. 43, an interface of VPCCMediaInfo may be added in the interface MediaInfo or the interface Track, and an extended value may be stored to notify the MAF (Method 1-5-2-2).

For example, the SD generation unit 611 of the file generation device 600 may store an interface for the merge information to indicate that all the video components can be merged and an interface for indicating that the buffer is not used in the interface MediaInfo or the interface Track of the MAF API. For example, the SD parsing unit 662 of the reproduction device 650 may use an interface stored in the interface MediaInfo or the interface Track of the MAF API to notify that the merge information indicates that all the video components can be merged, and that the buffer is not used.

That is, VPCCMediaInfo may be signaled to the interface MediaInfo or the interface Track.

### Method 1-5-2-3

In a case where the Method 1-5-2 is applied, as shown in the eighth row from the top of the table in FIG. 43, a new interface Track no buffer without bufferId may be added, Track no buffer may be added to AlternativeLocation, and it may be indicated that a buffer is unnecessary at the time of initialization (Method 1-5-2-3).

For example, the SD generation unit 611 of the file generation device 600 may store an interface for indicating that bufferId is not included in the MAF API. For example, the SD parsing unit 662 of the reproduction device 650 may notify that a buffer is unnecessary at the time of initialization by using an interface that does not have bufferId.

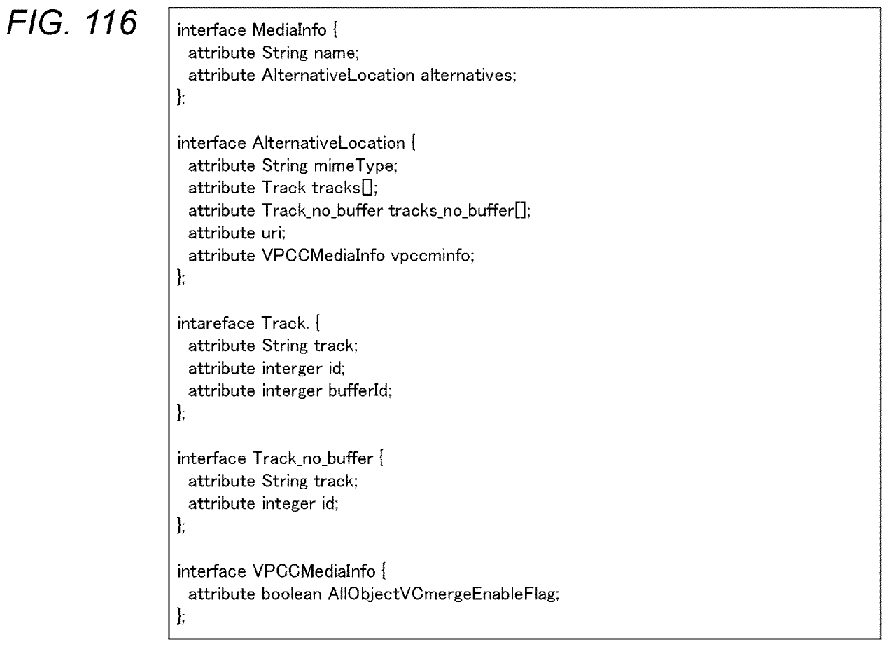

FIG. 116 illustrates an example of MediaInfo corresponding to Method 1-5-1-1. For example, as illustrated in FIG. 116, a new interface Track no buffer without bufferId may be added, Track no buffer may be added to AlternativeLocation, and it may be indicated that a buffer is unnecessary at the time of initialization. Track no buffer indicates track information not associated with BufferInfo (not using buffer). Track_no_buffer.track and Track_no_buffer.id have the same semantics as Track.track and Track.id.

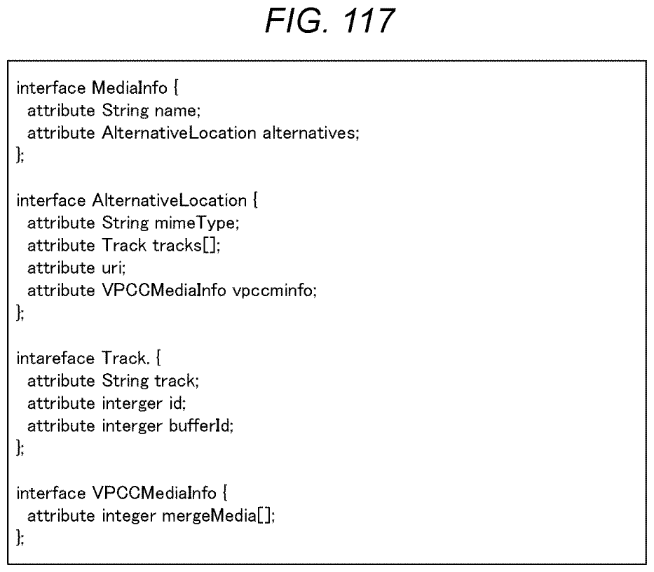

FIG. 117 illustrates an example of MediaInfo corresponding to Method 1-5-1-2. For example, as illustrated in FIG. 117, as a method indicating that a buffer is unnecessary at the time of initialization, either a method of changing the semantics of bufferId or a method of adding a new interface Track no buffer without bufferId can be applied. In this case, the semantics of mergeMedia indicate an array of media that includes video components that this media merges. The media is indicated by Track.id included in MediaInfo. Note that VPCCMediaInfo may be signaled to the interface MediaInfo or the interface Track.

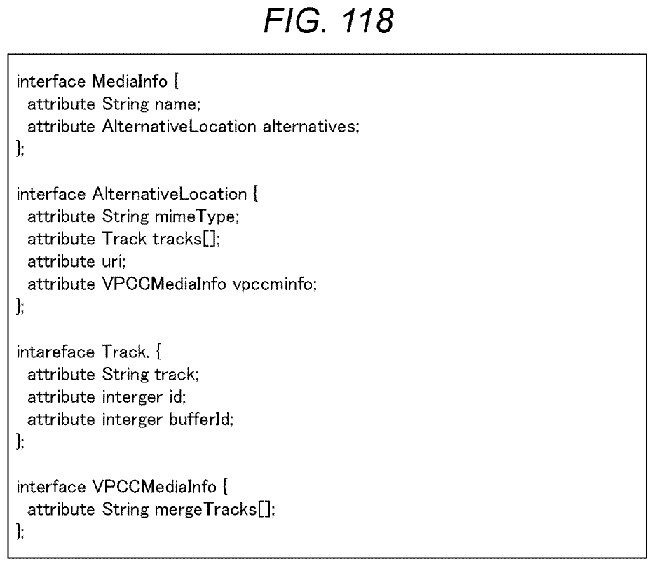

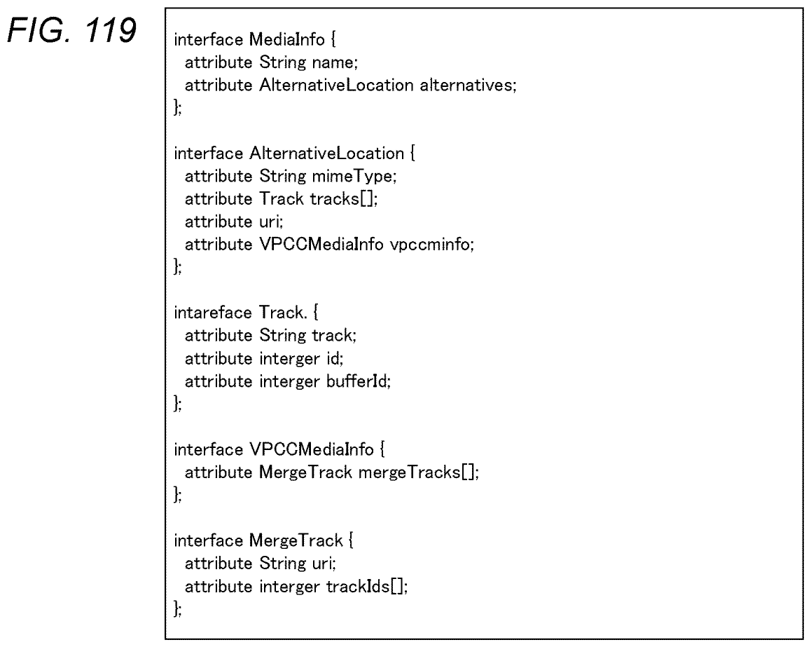

FIG. 118 illustrates an example of MediaInfo corresponding to Method 1-5-1-3. FIG. 119 illustrates an example of MediaInfo corresponding to Method 1-5-1-4. For example, as illustrated in FIGS. 118 and 119, the method indicating that a buffer is unnecessary at the time of initialization can be applied to either a method of changing the semantics of bufferId or a method of adding a new interface Track no buffer without bufferId. Note that the semantics of each parameter are as follows. mergeTracks indicates an array of the uri of all video components that this media merges. Furthermore, the uri indicates a uri of a file including all video components to be merged. trackIds indicates an array of identifiers of the video components. In a case where the uri is mp4, track_id is set, and in a case where the uri is MPD, AdapttionSet@id is set. Both examples may signal VPCCMediaInfo to the interface MediaInfo or the interface Track.

### Method 1-5-3

The architecture model of MPEG-I Scene Description is roughly divided into two functions of a presentation engine (PE) that mainly performs rendering and a media access function (MAF) that acquires and decodes media. Basically, since the PE and the MAF are implemented on one application, the PE/MAF has reproduction capability information of a common client in each. However, for example, different PEs and MAFs may have different allocated resources in different modules. In that case, the PE has no way of knowing the reproduction capability information of the MAF. Therefore, the PE needs to transmit all the media information and buffer information of the scene description to the MAF and generate all the buffers, and there is a case where there is information and resources that are not used in the buffers, and there is a possibility that the client needs to waste processing and secure resources.

Therefore, an MAF API for checking the reproduction capability of the media access function in the presentation engine may be added. For example, in a case where Method 1-5 is applied, as shown in the ninth row from the top of the table in FIG. 43, the PE may check the reproduction capability of the MAF with the MAF API (Method 1-5-3).

For example, the SD generation unit 611 of the file generation device 600 may store an interface for confirming whether the video components of all the objects can be merged in the interface Pipeline of the MAF API. For example, the SD parsing unit 662 of the reproduction device 650 may check whether the video components of all the objects can be merged using the interface Pipeline of the MAF API.

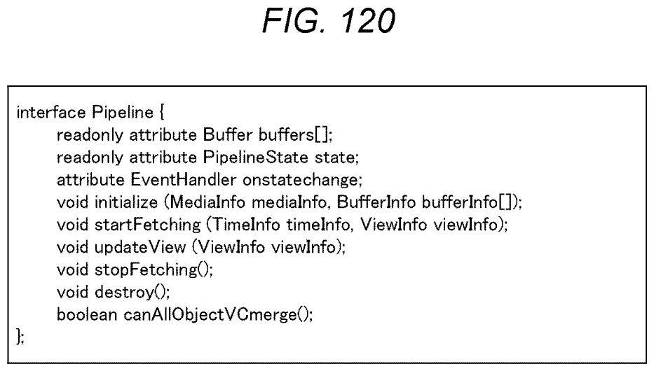

As in the example illustrated in FIG. 120, an API (canAllObjectVCmerge( )) for checking whether the MAF has a function of merging video components of all objects may be defined in the interface Pipeline. This canAllObjectVCmerge( ) returns true in a case where the MAF has the capability to merge video components of all objects. In a case where there is no such a function, false is returned.

By doing so, the PE can pass only necessary media information or generate only necessary buffers after confirming the reproduction capability of the MAF, and can appropriately use resources.

### Method 1-5-3-1

Moreover, discrimination may be made by a function for each codec such as merge using VVC codec or merge using HEVC codec. For example, in a case where Method 1-5-3 is applied, an API for identifying a function for each codec may be defined as shown in the bottom row of the table of FIG. 43 (Method 1-5-3-1).

For example, the SD generation unit 611 of the file generation device 600 may store an interface for checking the function for each codec in the interface Pipeline of the MAF API. For example, the SD parsing unit 662 of the reproduction device 650 may check the function for each codec using the interface Pipeline of the MAF API.

For example, different APIs may be defined for VVC and HEVC. The corresponding video codec information and the number of decoder instances may be acquired.

### 4. SUPPLEMENTARY NOTE

### Specification

In the above, the case where various standards are applied has been described as an example, but the specification of the present technology is not limited as long as there is no contradiction. Therefore, any standard may be applied. For example, the 2D codec may conform to standards other than VVC and HEVC. Furthermore, the 3D codec may conform to a standard other than V-PCC, V-DMC, and MIV. Furthermore, a file format such as a content file or a distribution file may be other than ISOBMFF (MP4). Furthermore, the control file for controlling distribution may be other than the MPD. Similarly, the scene description may be described in a manner other than glTF, or may be described in a manner other than the MPEG-I scene description.

### Method

Each example (each method) of the present technology described above may be appropriately combined with other examples (other methods) and applied as long as there is no contradiction. Furthermore, each example of the present technology described above may be applied in combination with another technology other than the above-described technology.

Furthermore, in the present specification, the description made for the upper method is also applied to the lower method belonging to the method as long as there is no contradiction. For example, in a case where it is described that “Method 1 may be applied”, the methods from Method 1-1 to Method 1-5 can be applied, and furthermore, can be applied to subordinate methods.

### <Computer>

The above-described series of processing can be executed by hardware or software. In a case where a series of processing is executed by software, a program included in the software is installed on a computer. Here, the computer includes a computer incorporated in dedicated hardware, a general-purpose personal computer capable of executing various functions by installing various programs, and the like, for example.

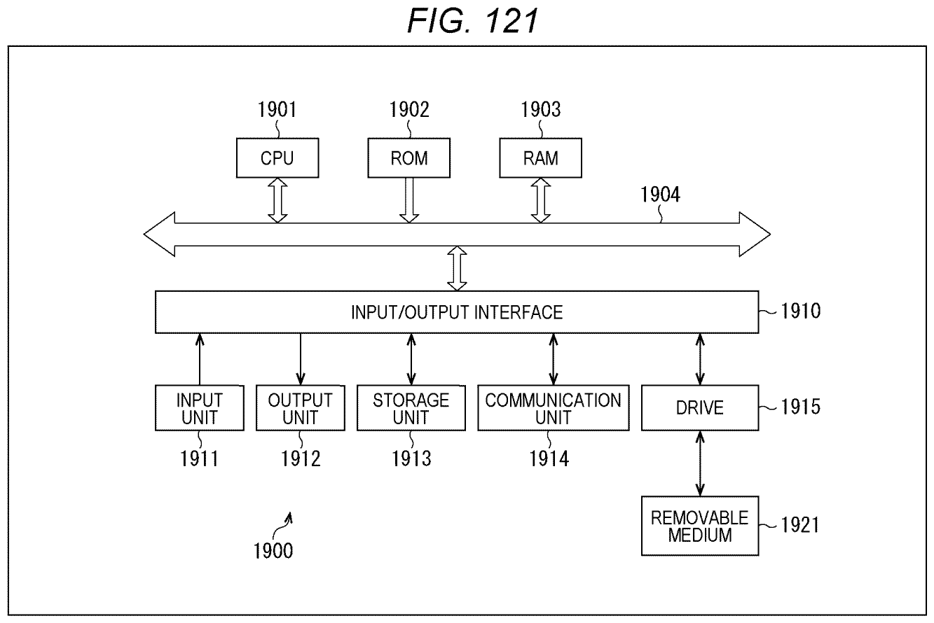

FIG. 121 is a block diagram illustrating a configuration example of hardware of a computer that executes the above-described series of processing by a program.

In a computer 1900 illustrated in FIG. 121, a central processing unit (CPU) 1901, a read only memory (ROM) 1902, and a random access memory (RAM) 1903 are interconnected through a bus 1904.

Furthermore, an input/output interface 1910 is also connected to the bus 1904. An input unit 1911, an output unit 1912, a storage unit 1913, a communication unit 1914, and a drive 1915 are connected to the input/output interface 1910.

The input unit 1911 includes, for example, a keyboard, a mouse, a microphone, a touch panel, an input terminal, and the like. The output unit 1912 includes, for example, a display, a speaker, an output terminal, and the like. The storage unit 1913 includes, for example, a hard disk, a RAM disk, a non-volatile memory and the like. The communication unit 1914 includes, for example, a network interface. The drive 1915 drives a removable medium 1921 such as a magnetic disk, an optical disk, a magneto-optical disk, or a semiconductor memory.

In the computer configured as described above, for example, the CPU 1901 loads a program stored in the storage unit 1913 into the RAM 1903 via the input/output interface 1910 and the bus 1904 and executes the program, whereby the above-described series of processing is performed. Furthermore, the RAM 1903 also appropriately stores data necessary for the CPU 1901 to perform various types of processing, and the like.

A program executed by the computer can be applied by being recorded on the removable medium 1921 as a package medium, and the like, for example. In this case, the program can be installed in the storage unit 1913 through the input/output interface 1910 by attaching the removable medium 1921 to the drive 1915.

Furthermore, the program can also be provided through a wired or wireless transmission medium such as a local area network, the Internet, or digital satellite broadcasting. In this case, the program can be received by the communication unit 1914 and installed in the storage unit 1913.

In addition, this program can be installed in the ROM 1902 or the storage unit 1913 in advance.

### Object to which the Present Technology is Applicable

The present technology can be applied to any encoding/decoding method.

Furthermore, the present technology can be applied to any configuration. For example, the present technology can be applied to various electronic devices.

Furthermore, for example, the present technology can also be implemented as a partial configuration of a device, such as a processor (for example, a video processor) as a system large scale integration (LSI) and the like, a module (for example, a video module) using a plurality of the processors and the like, a unit (for example, a video unit) using a plurality of the modules and the like, or a set (for example, a video set) obtained by further adding other functions to the unit.

Furthermore, for example, the present technology can also be applied to a network system including a plurality of devices. For example, the present technology may be implemented as cloud computing shared and processed in cooperation by a plurality of devices through a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (devices, modules (parts) and the like), and it does not matter whether or not all the components are in the same housing. Therefore, a plurality of devices stored in different housings and connected via a network and one device in which a plurality of modules is stored in one housing are both systems.

### Field and Application to which Present Technology is Applicable

The system, device, processing unit and the like to which the present technology is applied can be used in any field such as traffic, medical care, crime prevention, agriculture, livestock industry, mining, beauty care, factory, household appliance, weather, and natural surveillance, for example. Furthermore, application thereof is also arbitrary.

For example, the present technology can be applied to systems and devices used for providing content for appreciation and the like. Furthermore, for example, the present technology can also be applied to systems and devices used for traffic, such as traffic condition management and automated driving control. Moreover, for example, the present technology can also be applied to systems and devices used for security. Furthermore, for example, the present technology can be applied to systems and devices used for automatic control of a machine and the like. Moreover, for example, the present technology can also be applied to systems and devices provided for use in agriculture and livestock industry. Furthermore, the present technology can also be applied to systems and devices that monitor, for example, the status of nature such as a volcano, a forest, and the ocean, wildlife and the like. Moreover, for example, the present technology can also be applied to systems and devices used for sports.

### Others

Note that, in the present specification, a “flag” is information for identifying a plurality of states, and includes not only information used for identifying two states of true (1) and false (0) but also information capable of identifying three or more states. Hence, a value that may be taken by the “flag” may be, for example, a binary of I/O or a ternary or more. That is, the number of bits forming this “flag” is any number, and may be one bit or a plurality of bits. Furthermore, identification information (including the flag) is assumed to include not only identification information thereof in a bitstream but also difference information of the identification information with respect to certain reference information in the bitstream, and thus, in the present specification, the “flag” and “identification information” include not only the information thereof but also the difference information with respect to the reference information.

Furthermore, various types of information (such as metadata) regarding coded data (bitstream) may be transmitted or recorded in any form as long as this is associated with the coded data. Herein, the term “associate” is intended to mean to make, when processing one data, the other data available (linkable), for example. That is, the data associated with each other may be collected as one data or may be made individual data. For example, information associated with the coded data (image) may be transmitted on a transmission path different from that of the coded data (image). Furthermore, for example, the information associated with the coded data (image) may be recorded in a recording medium different from that of the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “merge”, “include”, “store”, “put in”, “introduce”, and “insert” mean, for example, to put a plurality of objects together into one, such as to put coded data and metadata together into one data, and mean one method of “associating” described above.

Furthermore, the embodiments of the present technology are not limited to the above-described embodiments, and various modifications are possible without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, when the configuration and operation as the entire system are substantially the same, a part of the configuration of a certain device (or processing unit) may be included in the configuration of another device (or another processing unit).

Furthermore, for example, the above-described programs may be executed in an arbitrary device. In this case, the device is only required to have a necessary function (functional block and the like) and obtain necessary information.

Furthermore, for example, each step in one flowchart may be executed by one device, or may be executed by being shared by a plurality of devices.

Moreover, in a case where a plurality of pieces of processing is included in one step, the plurality of pieces of processing may be executed by one device, or may be shared and executed by a plurality of devices. In other words, a plurality of pieces of processing included in one step can be executed as a plurality of steps. Conversely, the processing described as the plurality of the steps can also be collectively executed as one Step.

Furthermore, for example, in a program executed by the computer, processing of steps describing the program may be executed in a time-series order in the order described in the present specification, or may be executed in parallel or individually at a required timing such as when a call is made. That is, as long as there is no contradiction, the processing of each step may be executed in an order different from the above-described order. Moreover, the processing in the steps describing the program may be executed in parallel with processing of another program, or may be executed in combination with processing of the other program.

Furthermore, for example, a plurality of technologies related to the present technology can be implemented independently as a single entity as long as there is no contradiction. It goes without saying that any plurality of present technologies can be implemented in combination. For example, a part of all of the present technologies described in any of the embodiments can be implemented in combination with a part or all of the present technologies described in other embodiments. Furthermore, a part or all of any of the above-described present technologies can be implemented together with another technology that is not described above.

Note that the present technology can also have the following configurations.
(1) An information processing device including:
a 3D data acquisition unit that acquires each bitstream of a plurality of video components of 3D data and merge information for merging a plurality of the bitstreams;
a merge processing unit that merges the plurality of bitstreams on the basis of the merge information;
a decoding unit that decodes a merged bitstream and generates decoded data;
a division unit that divides the decoded data into the plurality of video components on the basis of the merge information; and
a reconstruction unit that reconstructs the 3D data using the plurality of video components obtained by division.
(2) The information processing device according to (1), in which
the 3D data acquisition unit is configured to acquire the merge information on the basis of information stored in a file that stores the merge information.
(3) The information processing device according to (2), in which
the 3D data acquisition unit is configured to identify the merge information to be used for merging the plurality of bitstreams from a plurality of pieces of the merge information.
(4) The information processing device according to (2) or (3), in which
the 3D data acquisition unit is configured to acquire the merge information designated as a reference destination in reference information added to atlas information for reconstructing the 3D data.
(5) The information processing device according to any one of (2) to (4), in which
information indicating that a time point is not a reproduction start point is added to the merge information, and
the decoding unit is configured to prohibit reproduction based on the merge information on the basis of the information.
(6) The information processing device according to any one of (2) to (5), in which
a track storing the merge information is set to a restricted video track, and
the decoding unit is configured to prohibit reproduction based on the merge information on the basis of the restriction.
(7) The information processing device according to any one of (1) to (6), further including:
a control file acquisition unit that acquires a control file for controlling distribution of the 3D data, in which
the 3D data acquisition unit is configured to acquire the merge information on the basis of information stored in the control file.
(8) The information processing device according to (7), in which
the 3D data acquisition unit is configured to identify the merge information to be used for merging the plurality of bitstreams from a plurality of pieces of the merge information.
(9) The information processing device according to (7) or (8), in which
the 3D data acquisition unit is configured to acquire the merge information designated as a reference destination in reference information added to an adaptation set of atlas information for reconstructing the 3D data in the control file.
(10) The information processing device according to any one of (7) to (9), in which
information indicating that a time point is not a reproduction start point is added to an adaptation set of the merge information in the control file, and
the decoding unit is configured to prohibit reproduction based on the merge information on the basis of the information.
(11) The information processing device according to any one of (7) to (10), in which
a track storing the merge information is set to a restricted video track, and
the decoding unit is configured to prohibit reproduction based on the merge information on the basis of the restriction.
(12) The information processing device according to any one of (7) to (11), in which
the 3D data acquisition unit is configured to acquire a distribution file and acquire each bitstream of the plurality of video components stored in the distribution file and the merge information.
(13) The information processing device according to any one of (7) to (12), in which
information designating an adaptation set of the bitstream to be merged is added to the adaptation set of the merge information in the control file, and
the merge processing unit is configured to merge the bitstream of a representation in the adaptation set designated by the information.
(14) The information processing device according to any one of (1) to (13), further including:
an SD acquisition unit that acquires a scene description describing a scene of 3D content; and
an SD parsing unit that parses the acquired scene description and controls reproduction of the 3D data, in which
MPEG_media of the scene description includes a description indicating that the plurality of bitstreams can be merged and decoded, and
the 3D data acquisition unit is configured to acquire the bitstream and the merge information on the basis of the description.
(15) The information processing device according to (14), in which
the description is flag information indicating whether all the bitstreams can be merged and decoded as one bitstream.
(16) The information processing device according to (15), in which
the flag information is defined as an extended object of MPEG_media.media.alternatives of the scene description.
(17) The information processing device according to (15) or (16), in which
the flag information is defined as an extended object of MPEG_media.media of the scene description.
(18) The information processing device according to any one of (15) to (17), in which
the flag information is defined as an extended object of MPEG_media.media.alternatives.tracks of the scene description.
(19) The information processing device according to any one of (14) to (18), in which
the description is information indicating a track in which the merge information is stored.
(20) The information processing device according to (19), in which
information indicating a track in which the merge information is stored is defined as an extended object of MPEG_media.media.alternatives of the scene description.
(21) The information processing device according to (19) or (20), in which
information indicating a track in which the merge information is stored is defined as a track of a track array of MPEG_media.media.alternatives.tracks of the scene description.
(22) The information processing device according to any one of (1) to (21), further including:
an SD acquisition unit that acquires a scene description describing a scene of 3D content; and
an SD parsing unit that parses the acquired scene description and controls reproduction of the 3D data, in which
the 3D data acquisition unit is configured to acquire, for each of a plurality of objects constituting the scene described in the scene description, a plurality of the bitstreams and merge information for merging the bitstreams of a plurality of the objects,
the merge processing unit is configured to merge the bitstreams of a plurality of the objects on the basis of the merge information,
the decoding unit is configured to decode a merged bitstream and generate decoded data,
the division unit is configured to divide the decoded data into a plurality of the video components of a plurality of the objects on the basis of the merge information, and
the reconstruction unit is configured to reconstruct the 3D data using a plurality of the video components obtained by division for each of a plurality of the objects.
(23) The information processing device according to (22), in which
the SD parsing unit is configured to identify media of the merge information for merging a plurality of the objects in MPEG_media of the scene description on the basis of a description indicating that the video components of a plurality of the objects can be merged, the description being stored in the scene description, and
the merge processing unit is configured to merge the bitstreams of a plurality of the objects on the basis of the identified merge information.
(24) The information processing device according to (23), in which
the description is flag information indicating whether media indicated by a uri can collectively decode all the video components.
(25) The information processing device according to (24), in which
the flag information is defined as an extended object of MPEG_media.media.alternatives of the scene description.
(26) The information processing device according to (24) or (25), in which
the flag information is defined as an extended object of MPEG_media.media of the scene description.
(27) The information processing device according to any one of (24) to (26), in which
the flag information is defined as an extended object of MPEG_media.media.alternatives.tracks of the scene description.
(28) The information processing device according to any one of (23) to (27), in which
the description is information indicating an index of the video component to be merged.
(29) The information processing device according to (28), in which
the information indicating an index of the video component to be merged is defined as an extended object of MPEG_media.media.alternatives of the scene description.
(30) The information processing device according to (28) or (29), in which
the information indicating an index of the video component to be merged is defined as an extended object of MPEG_media.media of the scene description.
(31) The information processing device according to any one of (28) to (30), in which
the information indicating an index of the video component to be merged is defined as an extended object of MPEG_media.media.alternatives.tracks of the scene description.
(32) The information processing device according to any one of (23) to (31), in which
the description is information indicating a url of the video component to be merged.
(33) The information processing device according to (32), in which
the information indicating a url of the video component to be merged is defined as an extended object of MPEG_media.media.alternatives of the scene description.
(34) The information processing device according to (32) or (33), in which
the information indicating a url of the video component to be merged is defined as an extended object of MPEG_media.media of the scene description.
(35) The information processing device according to any one of (32) to (34), in which
the information indicating a url of the video component to be merged is defined as an extended object of MPEG_media.media.alternatives.tracks of the scene description.
(36) The information processing device according to any one of (23) to (35), in which
the description is information indicating a url and a track of a file including the video component to be merged or a control file for controlling distribution of the video component.
(37) The information processing device according to (36), in which
information indicating a url and a track of the file or the control file is defined as an extended object of MPEG_media.media.alternatives of the scene description.
(38) The information processing device according to (36) or (37), in which
information indicating a url and a track of the file or the control file is defined as an extended object of MPEG_media.media of the scene description.
(39) The information processing device according to any one of (36) to (38), in which
information indicating a url and a track of the file or the control file is defined as an extended object of MPEG_media.media.alternatives.tracks of the scene description.
(40) The information processing device according to any one of (23) to (39), in which
the description is information indicating an entry of MPEG_media in which the video components of a plurality of the objects can be merged.
(41) The information processing device according to (40), in which
information indicating an entry of the MPEG_media is defined as an extended object of Scene.extension of the scene description.
(42) The information processing device according to any one of (23) to (41), in which
the description is information indicating a control file that controls distribution of the video components of all the objects to be merged and the merge information.
(43) The information processing device according to (42), in which
the control file is configured to externally refer to an adaptation set of the video component to be merged.
(44) The information processing device according to (42) or (43), in which
the control file is configured to omit information indicating an adaptation set of the video component to be merged.
(45) The information processing device according to any one of (42) to (44), in which
the control file includes a supplemental property for the merge information to indicate that the video components of all the objects are merged.
(46) The information processing device according to any one of (22) to (45), in which
the SD parsing unit is configured to notify that the merge information indicates that all the video components can be merged, and that no buffer is used by using an interface stored in AlternativeLocation of MediaInfo of the MAF API.
(47) The information processing device according to (46), in which
the SD parsing unit is configured not to generate the buffer in a case where there is no BufferInfo associated with semantics of bufferId.
(48) The information processing device according to (46) or (47), in which
the SD parsing unit is configured to notify that the merge information indicates that all the video components can be merged, and that the buffer is not used by using an interface stored in an interface MediaInfo or an interface Track of the MAF API.
(49) The information processing device according to any one of (46) to (48), in which
the SD parsing unit is configured to notify that the buffer is unnecessary at the time of initialization by using an interface that does not have bufferId.
(50) The information processing device according to any one of (46) to (49), in which
the SD parsing unit is configured to check whether the video components of all the objects can be merged using an interface Pipeline of the MAF API.
(51) The information processing device according to (50), in which
the SD parsing unit is configured to check a function for each codec using an interface pipeline of the MAF API.
(52) The information processing device according to any one of (1) to (51), in which
the 3D data is video-based point cloud compression (V-PCC) data, and includes a video component of geometry, attribute, and occupancy as the video component.
(53) The information processing device according to any one of (1) to (52), in which
the 3D data is video-based dynamic mesh coding (V-DMC) data, and includes a video component of geometry and attribute as the video component.
(54) The information processing device according to any one of (1) to (53), in which
the 3D data is MPEG immersive video (MIV) data, and includes a video component of geometry, attribute, and occupancy as the video component.
(55) The information processing device according to any one of (1) to (54), in which
an encoding method of the video component is an encoding method conforming to versatile video coding (VVC).
(56) The information processing device according to any one of (1) to (55), in which
an encoding method of the video component is an encoding method conforming to high efficiency video coding (HEVC).
(57) An information processing method including: acquiring each bitstream of a plurality of video components of 3D data and merge information for merging a plurality of the bitstreams;
merging a plurality of the bitstreams on the basis of the merge information;
decoding a merged bitstream to generate decoded data;
dividing the decoded data into a plurality of the video components on the basis of the merge information; and
reconstructing the 3D data using a plurality of the video components obtained by division.
(61) An information processing device including:
an encoding unit that encodes 3D data including a plurality of video components; and
a content file generation unit that generates a content file, stores each bitstream of a plurality of the video components in the content file, generates merge information for merging a plurality of the bitstreams, and stores the merge information in the content file.
(62) The information processing device according to (61), in which
the content file generation unit is configured to add, in the content file, reference information designating the merge information as a reference destination to atlas information for reconstructing the 3D data.
(63) The information processing device according to (61) or (62), in which
the content file generation unit is configured to add, in the content file, information indicating that a time point is not a reproduction start point to the merge information.
(64) The information processing device according to any one of (61) to (63), in which
the content file generation unit is configured to set a track that stores the merge information in the content file as a restricted video track.
(65) The information processing device according to any one of (61) to (64), further including:
a control file generation unit that generates a control file for controlling distribution of the 3D data.
(66) The information processing device according to (65), in which
the control file generation unit is configured to add, in the control file, reference information designating the merge information as a reference destination to an adaptation set of atlas information for reconstructing the 3D data.
(67) The information processing device according to (65) or (66), in which
the control file generation unit is configured to add information indicating that a time point is not a reproduction start point to an adaptation set of the merge information of the control file.
(68) The information processing device according to any one of (65) to (67), in which
the content file generation unit is configured to set a track that stores the merge information as a restricted video track.
(69) The information processing device according to any one of (65) to (68), in which
the content file generation unit is configured to generate a distribution file that stores a plurality of the video components to be merged and the merge information.
(70) The information processing device according to any one of (65) to (69), in which
the control file generation unit is configured to add information designating an adaptation set of the bitstream to be merged to an adaptation set of the merge information of the control file.
(71) The information processing device according to any one of (61) to (70), further including:

an SD generation unit that generates a scene description describing a scene of 3D content and stores a description indicating that a plurality of the bitstreams can be merged and decoded in MPEG_media of the scene description.
(72) The information processing device according to (71), in which
the description is flag information indicating whether all the bitstreams can be merged and decoded as one bitstream.
(73) The information processing device according to (72), in which
the SD generation unit is configured to define the flag information as an extended object of MPEG_media.media.alternatives of the scene description.
(74) The information processing device according to (72) or (73), in which
the SD generation unit is configured to define the flag information as an extended object of MPEG_media.media of the scene description.
(75) The information processing device according to any one of (72) to (74), in which
the SD generation unit is configured to define the flag information as an extended object of MPEG_media.media.alternatives.tracks of the scene description.
(76) The information processing device according to any one of (71) to (75), in which
the description is information indicating a track in which the merge information is stored.
(77) The information processing device according to (76), in which
the SD generation unit is configured to define information indicating a track in which the merge information is stored as an extended object of MPEG_media.media.alternatives of the scene description.
(78) The information processing device according to (76) or (77), in which
the SD generation unit is configured to define information indicating a track in which the merge information is stored as a track of a track array of MPEG_media.media.alternatives.tracks of the scene description.
(79) The information processing device according to any one of (61) to (78), further including:
an SD generation unit that generates a scene description describing a scene of 3D content, in which
the content file generation unit is configured to generate merge information indicating that a plurality of the bitstreams of a plurality of objects constituting the scene described in the scene description are merged, and store the merge information in the content file.
(80) The information processing device according to (79), in which
the SD generation unit is configured to store a description indicating that the video components of a plurality of the objects can be merged in the scene description.
(81) The information processing device according to (80), in which
the description is flag information indicating whether media indicated by a uri can collectively decode all the video components.
(82) The information processing device according to (81), in which
the SD generation unit is configured to define the flag information as an extended object of MPEG_media.media.alternatives of the scene description.
(83) The information processing device according to (81) or (82), in which
the SD generation unit is configured to define the flag information as an extended object of MPEG_media.media of the scene description.
(84) The information processing device according to any one of (81) to (83), in which
the SD generation unit is configured to define the flag information as an extended object of MPEG_media.media.alternatives.tracks of the scene description.
(85) The information processing device according to any one of (80) to (84), in which
the description is information indicating an index of the video component to be merged.
(86) The information processing device according to (85), in which
the SD generation unit is configured to define the information indicating an index of the video component to be merged as an extended object of MPEG_media.media.alternatives of the scene description.
(87) The information processing device according to (85) or (86), in which
the SD generation unit is configured to define the information indicating an index of the video component to be merged as an extended object of MPEG_media.media of the scene description.
(88) The information processing device according to any one of (85) to (87), in which
the SD generation unit is configured to define the information indicating an index of the video component to be merged as an extended object of MPEG_media.media.alternatives.tracks of the scene description.
(89) The information processing device according to any one of (80) to (88), in which
the description is information indicating a url of the video component to be merged.
(90) The information processing device according to (89), in which
the SD generation unit is configured to define the information indicating a url of the video component to be merged as an extended object of MPEG_media.media.alternatives of the scene description.
(91) The information processing device according to (89) or (90), in which
the SD generation unit is configured to define the information indicating a url of the video component to be merged as an extended object of MPEG_media.media of the scene description.
(92) The information processing device according to any one of (89) to (91), in which
the SD generation unit is configured to define the information indicating a url of the video component to be merged as an extended object of MPEG_media.media.alternatives.tracks of the scene description.
(93) The information processing device according to any one of (80) to (92), in which
the description is information indicating a url and a track of a file including the video component to be merged or a control file for controlling distribution of the video component.
(94) The information processing device according to (93), in which
the SD generation unit is configured to define information indicating a url and a track of the file or the control file as an extended object of MPEG_media.media.alternatives of the scene description.
(95) The information processing device according to (93) or (94), in which
the SD generation unit is configured to define information indicating a url and a track of the file or the control file as an extended object of MPEG_media.media of the scene description.
(96) The information processing device according to any one of (93) to (95), in which
the SD generation unit is configured to define information indicating a url and a track of the file or the control file as an extended object of MPEG_media.media.alternatives.tracks of the scene description.
(97) The information processing device according to any one of (80) to (96), in which
the description is information indicating an entry of MPEG_media in which the video components of a plurality of the objects can be merged.
(98) The information processing device according to (97), in which
the SD generation unit defines information indicating the entry of MPEG_media as an extended object of Scene.extension of the scene description.
(99) The information processing device according to any one of (80) to (98), further including:
a control file generation unit that generates a control file that controls distribution of the video components of all the objects to be merged and the merge information, in which
the SD generation unit is configured to store information indicating the control file in the scene description as the description.
(100) The information processing device according to (99), in which
the control file generation unit is configured to generate the control file that externally refers to an adaptation set of the video component to be merged.
(101) The information processing device according to (99) or (100), in which
the control file generation unit is configured to generate the control file not including information indicating an adaptation set of the video component to be merged.
(102) The information processing device according to any one of (99) to (101), in which
the control file generation unit is configured to generate the control file including a supplemental property for the merge information to indicate that the video components of all the objects are merged.
(103) The information processing device according to any one of (79) to (102), in which
the SD generation unit is configured to store, in AlternativeLocation of MediaInfo of an MAF API of the scene description, an interface for the merge information to indicate that all the video components can be merged, and an interface for notifying that a buffer is not used.
(104) The information processing device according to (103), in which
the SD generation unit is configured to store, in the scene description, bufferId of a value indicating that there is no BufferInfo to be associated.
(105) The information processing device according to (103) or (104), in which
the SD generation unit is configured to store, in an interface MediaInfo or an interface Track of the MAF API, an interface for the merge information to indicate that all the video components can be merged, and an interface for indicating that the buffer is not used.
(106) The information processing device according to any one of (103) to (105), in which
the SD generation unit is configured to store an interface for indicating that the MAF API does not have bufferId.
(107) The information processing device according to any one of (103) to (106), in which
the SD generation unit is configured to store, in an interface Pipeline of the MAF API, an interface for checking whether the video components of all the objects can be merged.
(108) The information processing device according to any one of (103) to (107), in which
the SD generation unit is configured to store an interface for checking a function for each codec in an interface Pipeline of the MAF API.
(109) The information processing device according to any one of (61) to (108), in which
the 3D data is video-based point cloud compression (V-PCC) data, and includes a video component of geometry, attribute, and occupancy as the video component.
(110) The information processing device according to any one of (61) to (109), in which
the 3D data is video-based dynamic mesh coding (V-DMC) data, and includes a video component of geometry and attribute as the video component.
(111) The information processing device according to any one of (61) to (110), in which
the 3D data is MPEG immersive video (MIV) data, and includes a video component of geometry, attribute, and occupancy as the video component.
(112) The information processing device according to any one of (61) to (111), in which
the encoding unit is configured to encode the video component in an encoding method conforming to versatile video coding (VVC).
(113) The information processing device according to any one of (61) to (112), in which
the encoding unit is configured to encode the video component in an encoding method conforming to high efficiency video coding (HEVC).
(114) An information processing method including: encoding 3D data having a plurality of video components; and
generating a content file, storing each bitstream of a plurality of the video components in the content file, generating merge information indicating that a plurality of the bitstreams is merged, and storing the merge information in the content file.
(121) An information processing device including: a 3D data acquisition unit that acquires each bitstream of a plurality of video components of 3D data and merge information for merging a plurality of the bitstreams;
a merge processing unit that merges a plurality of the bitstreams on the basis of the merge information;
a file generation unit that generates a distribution file and stores a merged bitstream; and
a supply unit that supplies the distribution file and an atlas file that stores atlas information for reconstructing the 3D data.
(122) The information processing device according to (121), in which
the file generation unit is configured to store information for division into video components in the distribution file.
(123) The information processing device according to (122), in which
the file generation unit is configured to store information indicating a rectangular region on a picture in a sample group of the distribution file as information for division into the video components.
(124) acquiring An information processing method including:
acquiring each bitstream of a plurality of video components of 3D data and merge information for merging a plurality of the bitstreams;
merging a plurality of the bitstreams on the basis of the merge information;
generating a distribution file and storing a merged bitstream; and
supplying the distribution file and an atlas file storing atlas information for reconstructing the 3D data.
(131) An information processing device including:
a file acquisition unit that acquires a distribution file that stores a bitstream in which each bitstream of a plurality of video components of 3D data is merged, and an atlas file that stores atlas information for reconstructing the 3D data;
a decoding unit that decodes a merged bitstream and generates decoded data;
a division unit that divides the decoded data into a plurality of the video components; and
a reconstruction unit that reconstructs the 3D data using a plurality of the video components obtained by division and the atlas information.
(132) The information processing device according to (131), in which
information for division into video components is stored in the distribution file, and
the division unit is configured to divide the decoded data into a plurality of the video components on the basis of information for division into the video components.
(133) The information processing device according to (132), in which
information for division into the video components is information indicating a rectangular region on a picture stored in a sample group of the distribution file.
(134) An information processing method including:
acquiring a distribution file that stores a bitstream in which each bitstream of a plurality of video components of 3D data is merged, and an atlas file that stores atlas information for reconstructing the 3D data;
decoding a merged bitstream to generate decoded data;
dividing the decoded data into a plurality of the video components; and
reconstruct the 3D data using a plurality of the video components obtained by division and the atlas information.

### REFERENCE SIGNS LIST

300 File generation device
311 Preprocessing unit
312 Encoding unit
313 Content file generation unit
314 Recording unit
315 Upload unit
350 Reproduction device
361 File acquisition unit
362 Merge processing unit
363 Decoding unit
364 Separation unit
365 Reconstruction unit
366 Display processing unit
400 File generation device
411 MPD generation unit
450 Reproduction device
461 MPD acquisition unit
500 Edge server
511 File acquisition unit
512 Merge processing unit
513 File generation unit
514 Recording unit
515 Supply unit
600 File generation device
611 SD generation unit
650 Reproduction device
661 SD acquisition unit
662 SD parsing unit
663 Reproduction processing unit
1900 Computer

1. An information processing device comprising:
a 3D data acquisition unit that acquires each bitstream of a plurality of video components of 3D data and merge information indicating that a plurality of the bitstreams is merged;
a merge processing unit that merges the plurality of bitstreams on a basis of the merge information;
a decoding unit that decodes a merged bitstream and generates decoded data;
a division unit that divides the decoded data into the plurality of video components on a basis of the merge information; and
a reconstruction unit that reconstructs the 3D data using the plurality of video components obtained by division.

2. The information processing device according to claim 1, wherein
the 3D data acquisition unit is configured to acquire the merge information on a basis of information stored in a file that stores the merge information.

3. The information processing device according to claim 2, wherein
the 3D data acquisition unit is configured to identify the merge information to be used for merging the plurality of bitstreams from a plurality of pieces of the merge information.

4. The information processing device according to claim 2, wherein
the 3D data acquisition unit is configured to acquire the merge information designated as a reference destination in reference information added to atlas information for reconstructing the 3D data.

5. The information processing device according to claim 2, wherein
information indicating that a time point is not a reproduction start point is added to the merge information, and
the decoding unit is configured to prohibit reproduction based on the merge information on a basis of the information.

6. The information processing device according to claim 2, wherein
a track storing the merge information is set to a restricted video track, and
the decoding unit is configured to prohibit reproduction based on the merge information on a basis of the restriction.

7. The information processing device according to claim 1, further comprising:
a control file acquisition unit that acquires a control file for controlling distribution of the 3D data, wherein
the 3D data acquisition unit is configured to acquire the merge information on a basis of information stored in the control file.

8. The information processing device according to claim 7, wherein
the 3D data acquisition unit is configured to identify the merge information to be used for merging the plurality of bitstreams from a plurality of pieces of the merge information.

9. The information processing device according to claim 7, wherein
the 3D data acquisition unit is configured to acquire the merge information designated as a reference destination in reference information added to an adaptation set of atlas information for reconstructing the 3D data in the control file.

10. The information processing device according to claim 7, wherein
information indicating that a time point is not a reproduction start point is added to an adaptation set of the merge information in the control file, and
the decoding unit is configured to prohibit reproduction based on the merge information on a basis of the information.

11. The information processing device according to claim 7, wherein
a track storing the merge information is set to a restricted video track, and
the decoding unit is configured to prohibit reproduction based on the merge information on a basis of the restriction.

12. The information processing device according to claim 7, wherein
the 3D data acquisition unit is configured to acquire a distribution file and acquire each bitstream of the plurality of video components stored in the distribution file and the merge information.

13. The information processing device according to claim 7, wherein
information designating an adaptation set of the bitstream to be merged is added to the adaptation set of the merge information in the control file, and
the merge processing unit is configured to merge the bitstream of a representation in the adaptation set designated by the information.

14. The information processing device according to claim 1, further comprising:
an SD acquisition unit that acquires a scene description describing a scene of 3D content; and
an SD parsing unit that parses the acquired scene description and controls reproduction of the 3D data, wherein
MPEG_media of the scene description includes a description indicating that the plurality of bitstreams can be merged and decoded, and
the 3D data acquisition unit is configured to acquire the bitstream and the merge information on a basis of the description.

15. The information processing device according to claim 1, wherein
the 3D data is video-based point cloud compression (V-PCC) data, and includes a video component of geometry, attribute, and occupancy as the video component.

16. The information processing device according to claim 1, wherein
the 3D data is video-based dynamic mesh coding (V-DMC) data, and includes a video component of geometry and attribute as the video component.

17. The information processing device according to claim 1, wherein
the 3D data is MPEG immersive video (MIV) data, and includes a video component of geometry, attribute, and occupancy as the video component.

18. The information processing device according to claim 1, wherein
an encoding method of the video component is an encoding method conforming to versatile video coding (VVC).

19. The information processing device according to claim 1, wherein
an encoding method of the video component is an encoding method conforming to high efficiency video coding (HEVC).

20. An information processing method comprising:
acquiring each bitstream of a plurality of video components of 3D data and merge information for merging a plurality of the bitstreams;
merging the plurality of bitstreams on a basis of the merge information;
decoding a merged bitstream to generate decoded data;
dividing the decoded data into the plurality of video components on a basis of the merge information; and
reconstructing the 3D data using the plurality of video components obtained by division.
